(19) United States
(12) Patent Application Publication
(10) Pub. No.: US 2025/0041640 A1
(43) Pub. Date: Feb. 6, 2025

(54) METHOD OF INSTALLING AND COMMISSIONING THE OPERATION OF AN AUTOMATED HOME SPRINKLER-BASED WILDFIRE DEFENSE SYSTEM DURING THE POST-CONSTRUCTION PHASE OF A COMPLETED HOME BUILDING PROJECT

(71) Applicant: Mighty Fire Breaker LLC, Lima, OH (US)

(72) Inventor: Stephen Conboy, Carlsbad, CA (US)

(73) Assignee: Mighty Fire Breaker LLC, Lima, OH (US)

(21) Appl. No.: 18/788,292

(22) Filed: Jul. 30, 2024

Related U.S. Application Data
(63) Continuation of application No. 18/420,717, filed on Jan. 23, 2024.
Application No. 18/420,717 is a continuation-in-part of application No. 17/167,084, filed on Feb. 4, 2021, now Pat. No. 11,865,390.
Application No. 17/167,084 is a continuation-in-part of application No. 17/497,948, filed on Oct. 10, 2021, now Pat. No. 11,730,987.
Application No. 17/497,948 is a continuation-in-part of application No. 18/329,979, filed on Jun. 6, 2023.

(51) Int. Cl. A62C 3/02

(52) U.S. Cl. CPC A62C 3/0214; A62C 3/0292

(57) ABSTRACT

A wildfire defense system trailer and method of installing an automated sprinkler-based wildfire defense system on a home construction site before the starting of the construction phase of a home building project in a wildfire urban interface (WUI) region. The first commissioned automated sprinkler-based wildfire defense system will continue in operation all during the home building construction phase, and will only be decommissioned from operation, and removed from the premises (including the job-site wildfire defense system trailer being removed from the property) when construction of the wood home building project is totally completed, and the wood home building is ready for occupation. At the same time when the first system is decommissioned, a second permanently-installed automated sprinkler-based wildfire defense system is installed within the new home construction, independent from the first system, and ready for commissioning to provide a new proactive measure of defense against a wildfire storm occurring after home building construction has been completed, thereby protecting all wood and combustible surfaces on the home and surrounding property, and preventing fire ignition and flame spread until the wildfire storm passes through the WUI region. By virtue of the present invention, it is now possible to significantly reduce the risk of wood home building construction projects occurring within a wildfire urban interface (WUI) region, and better support the underwriting of home construction and ownership insurance policies within such regions.

### RELATED CASES

The present patent application is a Continuation of copending U.S. patent application Ser. No. 18/420,717 filed Jan. 23, 2024, which is a Continuation-in-Part of co-pending: U.S. patent application Ser. No. 18/329,979 filed Jun. 6, 2023; U.S. patent application Ser. No. 17/167,084 filed Feb. 4, 2021; and U.S. patent application Ser. No. 17/497,948 filed Oct. 10, 2021; wherein each said US Patent Application is commonly owned by Mighty Fire Breaker, LLC and incorporated herein by reference as if fully set forth herein.

### BACKGROUND OF INVENTION

### Field of Invention

The present invention is directed towards improvements in science and technology applied in the defense of human and animal life and property, against the ravaging and destructive forces of wildfire.

### Brief Description of the State of Knowledge in the Art

Over the past century, millions of people have developed and settled towns, counties and neighborhoods in regions that today are called the Wildfire Urban Interface (WUI), which are at high risk to wildfires, and this is impacting home owners and property insurance industry. For man to live and survive a sustainable future in the urban-wildfire interface, human society must quickly adapt to survive the destructive effects of wildfires.

Conventional methods of wildfire fighting defense include:
Making firebreaks with bulldozers and shovels, which has not viable in most urbanized communities;
Making firebreaks with backfires has proven ineffective in many cases, and often dangerous as wildfires themselves;
Dropping PhosChek® AMP-based liquid chemical from 5000 feet heights in urban areas, which is dangerous and not viable or effective in wildfire defense;
Thinning forests of dead trees and debris in urban regions, especially near power poles, buildings, and structures.

Current methods of wildfire defense and fighting are becoming unsustainable because the financial losses due to wildfire are exceeding what the insurance industry is willing to insure, as the damage caused by wildfire to the environment is typically catastrophic and destruction.

For several decades now, wildfire defense methods have proposed proactively spraying homes, buildings and properties with chemical fire retardants—to defend against hot wildfire embers flying in the direction of prevailing winds, in search of combustible fuel.

In 2006, US Patent Application Publication No. 2006/0113403A1 (Aamodt of Firebreak Spray Systems LLC) disclosed a fire-retardant distribution system designed for use with any type of structure such as residences, out buildings, barns, commercial buildings, and others. This prior art system is designed to prevent structures from catching fire when a wildfire approaches, and relies upon a spray system that when activated coats the exterior of the structures, decks, and surrounding landscape very rapidly with a liquid, decolorized fire retardant that remains on the surface until washed off. The system is self-contained and relies upon tanks pressurized with inert gas to deliver the fire retardant to spray valves positioned on and around the structures and surrounding areas. In an alternate embodiment, compressed gas-powered pumps deliver fire retardant to desired areas to flank a wildfire and control its direction and behavior. In general, such firebreak spray systems are expense to install and use liquid fire retardants that are less than optimal from performance criteria, as well as from an environmental sustainability perspective.

Wildfire defense methods have also proposed the use of hydrogels as disclosed in U.S. Pat. Nos. 3,229,769 and 5,849,210, for the purpose of cooling the source of the fire by retaining water close to the flame. In general, such hydrogels are produced from a water-absorbing polymer and water. The hydrogel binds the water and so stops the water from flowing away from the source of the fire. Because hydrogels can maintain a large amount of water near the fire, hydrogels have a good immediate extinguishing effect. In contrast, the long-term effect of hydrogels is poor. Hydrogels can dry and thereby rapidly lose their effect. The remaining salt-like dried hydrogels have a very low fire-retarding effect.

U.S. Pat. No. 8,273,813 (assigned to BASF) also proposes combining water-absorbing polymers with fire-retarding salts to form fire-retarding compositions having a good immediate extinguishing effect and a good long-term effect, but are not ideal for use in automated firebreak spraying systems discussed above.

For over a decade, Hartindo's anti-fire (AF) chemical solution AF31 has been used in proactive fire defense applications including wildfire defense. While AF31 solution employs tripotassium citrate dissolved in water with minor amounts of a natural gum added to provide cling, the natural gum tends to clog spray nozzles requiring additional cleaning and maintenance, and adversely impacts many species of plant life including flowing plants, tender perennials and vegetables.

Despite some advances being made in the field of wildfire suppression, wildfires have become all too common in recent years, wreaking havoc on communities and the environment. As a result, more effective wildfire management technologies are needed now more than ever, especially in areas where human development intersects with wildland vegetation.—called the wildland-urban interface (WUI)—where human development and wildland vegetation meet or overlap, and representing the boundary between built environments, such as cities, towns, and rural areas, and nearby natural habitats. As a result, the WUI can be a source of both natural resources and potential hazards, such as increased wildfire risk.

The WUI refers to areas where residential development is near trees or dense vegetation, which pose a higher risk of wildfires. Experts primarily assess vegetation cover and housing proximity to determine the WUI threshold.

FIGS. 1, and 1A through 1I show examples of wood-framed and mass-timber homes built and being constructed within the WUI region. Because the wildland-urban interface presents a significant challenge for firefighters due to the proximity of populated areas, increasing the risk of property damage and civilian injurie, home and property insurance underwriters are starting to refuse underwriting homes under construction (and already) constructed in WUI region, unless builders and homeowners can show significant evidence of measures taken to reduce or mitigate risk due to wildfires during the construction phase and post-construction phase of a wood building project in the WUI region.

Applicant believes that communities in the WUI region can be safe guarded from the constant wildfire threat by better understanding the Wildland-Urban Interface (WUI) and implementing new and improved strategies, methods and practices that will reduce fire risks in these areas. For example, mapping and assessing WUI areas are vital for understanding wildfire risks and developing strategies to minimize them. High-resolution maps, created using remote sensing data, enable a detailed analysis of vegetation density, cover, and housing proximity to dense vegetation. Accurate mapping and assessment empower communities and policymakers to comprehend and effectively address the unique challenges of WUI areas.

Several strategies can be employed to reduce fire risks in WUI areas, including creating Community Wildfire Protection Plans (CWPPs), fostering fire-adapted communities, utilizing fire suppression techniques, and implementing building and landscaping guidelines. These approaches enhance community resilience against wildfires and minimize potential losses. By implementing these strategies, communities can enhance their resilience against wildfires and create safer living environments in the wildland-urban interface.

When building homes in Wildland Urban Interface (WUI) Areas, builders face numerous decisions, from material choices to landscaping, that can impact a home's resilience against wildfires. WUI concerns should not be geographically isolated for home builders, as these areas continue to grow by approximately 2 million acres per year, placing an emphasis on building ignition-resistant homes to prevent the spread and damage of wildfires should they occur. There are practical steps builders can take to make homes in WUI zones resilient against wildfires and several key areas that should be addressed during the planning and construction phases.

For ignition-resistant construction, first step is site planning including identifying if the building site is located on a steep hill, a densely vegetated area, or an area with an abundance of existing fuels. Considering fire paths and outside risks to the structure should be just as important as the typical site planning considerations, such as views, access, and available sunlight.

Beyond planning, ignition resistant construction is contingent on material choices for windows, doors, siding, decking, and roofing. Class A is the highest-level fire-resistance rating an exterior material can achieve as tested under the UL 790 standards. Examples of Class A-rated materials include clay tile, stucco, metal roofing, and certain asphalt shingle roofs.

The fire-resistive class of the material is a great starting point to understanding the level of exposure a material has. If there is no rating, then it's going to be considered a flammable material, and the more holes, cracks, and areas for embers to catch in a material, the more likely it is to be affected by the spread of fire. Stone and brick siding typically have great fire resistance while vinyl siding and natural wood products are either direct fuel sources or will not hold up under fire. While stone and brick siding can run more expensive, lower-cost Class A exterior alternatives, such as stucco, manufactured stone, wood-look metal siding, composite siding, and fiber cement board, are also available on the market.

Combustible exterior building components, including roof coverings, siding, and decks, can ignite and contribute to the damage and spread of wildfires. Careful consideration should be given to building materials that are used in WUI areas as well as construction measures to prevent the penetration of heat and embers at vents, mechanical or electrical openings, and windows. For windows, tempered glass has proved to be resistant to breakage from radiant heat, and double-pane windows are preferred to single-pane windows for performance against fires. Builders can minimize risk by covering the exposures with materials such as concrete, metal mesh, or stucco.

With over 3 million homes at risk and an unsustainable prior art model of deploying mitigation teams during active wildfires, insurance giants like State Farm, Allstate (and others) have withdrawn from California's wildfire insurance landscape. The reliance on temporary measures such as sprinkler systems, hotspot monitoring, vegetation removal and spraying foam has proven inadequate against the scale of the threat. Also, the number of properties that can get this type of just-in-time protection has proven to be unsustainable based on the number of properties at risk in the WUI region.

Clearly, there is still a great need for new and improved systems, networks and methods of wildfire defense of wood-framed and mass-timber homes and building structures being constructed in the wildfire urban interface (WUI) region will reduce or eliminate wildfire risks of damage and destruction that will provide greater comfort to property insurance underwriters to insure such home jobsite construction projects during the. Construction phase, and constructed homes during the post-construction phase, anywhere within the WUI regions, while avoiding the shortcomings and drawbacks of prior art methods, apparatus, compositions and other fire protection technologies.

### OBJECTS AND SUMMARY OF THE PRESENT INVENTION

Accordingly, a primary object of the present is to provide a new and improved method of and system for defending home building projects from wildfire during and after construction on property within a wildfire urban interface (WUI) region, while overcoming the shortcomings and drawbacks of prior art methods and apparatus.

Another object of the present invention is to provide a new and improved method of defending wood home construction projects, their job-sites, and completed homes and surrounding properties from wildfire storms.

Another object of the present invention is to provide a new and improved method of home construction wildfire defense protection involving a novel method of constructing, commissioning, and decommissioning two different and independent sprinkler-based home wildfire defense systems, at different phases of the home building project.

Another object of the present invention is to provide such a method of home construction wildfire defense protection, wherein at beginning of the construction phase of the home building project, a first automated sprinkler-based wildfire defense system is installed and commissioned for operation on the construction job-site using the wildfire defense system trailer of the present invention to provide a liquid fire inhibitor supply, sprinkler pumping operations, and automated controls and monitoring during the entire construction phase, thereby providing a proactive measure of defense against hot flying embers entering the constructed home and its surrounding property during a wildfire storm occurring during construction.

Another object of the present invention is to provide such a method of home construction wildfire defense protection, wherein the first commissioned automated sprinkler-based wildfire defense system will continue in operation all during the home building construction phase, and will only be decommissioned from operation, and removed from the premises (including the job-site wildfire defense system trailer being towed away to a new location and old sprinklers and piping removed from the property), when construction of the wood home building project is totally completed and the wood home building is ready for occupation.

Another object of the present invention is to provide such a method of home construction wildfire defense protection, wherein once the wood home building project is completed and ready for occupation, the first automated sprinkler-based wildfire defense system is decommissioned and removed from the premises (including the wildfire defense trailer being towed away to a new location and old sprinklers and piping removed from the premises).

Another object of the present invention is to provide such a method of home construction wildfire defense protection, wherein at the same time when the first system is decommissioned, a second permanently-installed automated sprinkler-based wildfire defense system will be completely installed within the new home construction, independent from the first system, and ready for commissioning to provide a new proactive measure of defense against hot flying embers entering the constructed home and its surrounding property during a wildfire storm occurring after construction has been completed, thereby protecting all wood and combustible surfaces on the home and surrounding property, and preventing fire ignition and flame spread until the wildfire storm passes through the WUI region.

Another object of the present invention is to provide a new and improved trailer-mounted system and kit components for installing automated sprinkler-based wildfire defense system about home construction site before the starting of the construction phase of the home building project in the wildfire urban interface (WUI) region, wherein this first type of automated sprinkler-based wildfire defense system is to provide a proactive measure of defense against hot flying embers entering the construction job-site property during a wildfire storm, protecting all wood and combustible surfaces on the home construction job-site and prevent fire ignition and flame spread until the wildfire storm passes through the WUI region.

Another object of the present invention is to provide a new and improved trailer-mounted system the installation and deployment of a wireless remotely-activatable sprinkler-based wildfire defense fire inhibitor spraying system on a home construction job-site, where sprinkler heads are mounted for liquid fire inhibitor all over the combustible surfaces of the construction job-site, surrounding perimeter areas, as well wood framed and/or mass-timber buildings being constructed thereon during the construction phase of the project.

Another object of the present invention is to provide a wireless system network for managing the supply, delivery and spray-application of environmentally-clean fire-inhibiting biochemical liquid on private and public property, including wood-building home job-sites, to reduce the risks of damage and/or destruction caused by wild fires, and support the sustainable underwriting of home, building and property insurance policies operating within the wildfire urban interface (WUI) regions around the globe

Another object of the present invention is to provide a new and improved job-site wildfire defense system trailer for rapid deployment on the wood home and building construction job-sites for the purpose of managing and delivering environmentally-clean liquid fire inhibiting chemical (by spraying operations) to the exterior surfaces of wood and other combustible surfaces present at home construction and other building job-sites, long before the arrival of hot flying embers from a wildfire and/or wildfire storm so as to reduce and/or mitigate damage and/or destruction of property by wildfire.

Another object of the present invention is to provide a new and improved job-site wildfire defense system trailer comprising: a trailer framework provided with wheels, an adjustable stand mechanism adapted for coupling to a hitch mounted on the rear frame of a truck or tractor provided with an engine and drive train for pulling the trailer to its home construction job-site destination(s), a cabin enclosure mounted on the trailer having a rear hinged door/loading ramp for loading and unloading equipment and supplies stored inside the cabin, a side door, and a sheltered interior volume for storing diverse kinds of equipment, and supplies of liquid wildfire inhibitor that is to be used for performing three different functions, namely: (i) spraying environmentally-clean fire inhibiting liquid over wood building materials to provide Class-A fire protection to wood buildings as they are constructed on the on the home and building construction job-site; (ii) providing environmentally-clean fire extinguishing liquid in event of fire outbreaks on the home and building construction job-site; and (iii) spraying environmentally-clean fire inhibiting liquid over the job-site home construction area and wood building(s) being constructed thereon—prior to the occurrence of a wildfire outbreak—automatically detected by AI-triggered smoke and ember sensors deployed across the WUI Region.

Another object of the present invention is to provide a new and improved job-site wildfire defense system trailer comprising a number of subsystems, selected from the group consisting of: (i) a portable backpack fire inhibitor spray-atomizing system, each filled with a quantity of environmentally-clean liquid fire inhibitor supplied from a supply tank; (ii) a portable air-less liquid fire inhibitor spraying system with a spray nozzle for spraying environmentally-clean liquid fire inhibitor; (iii) a palate of gallon pails, each pail containing environmentally-clean liquid fire inhibitor for use in spraying on wood material on a home construction job-site and providing Class A fire protection to wood material present therein; (iv) trailer-mounted automated sprinkler-based job-site wildfire defense spraying system for use during the construction phase of a home building project, triggered by an automated AI-based smoke and/or wildfire ember detection system/network deployed within a WUI region; (v) portable trailer-mounted fire extinguishing system for use in extinguishing job-site construction fires using a supply tank containing environmentally-clean liquid fire inhibitor; (vi) kit and components for installing an automated sprinkler-based wildfire defense system integrated in and on the constructed home and surrounding property, and deployed and commissioned only after the construction phase of the home building project has been completed, wherein the automated sprinkler-based wildfire defense system includes a trailer-supported sprinkler-based liquid wildfire inhibitor sprinkler/spraying system (e.g. which may include a flag pole supported sprinkler spray head for deep and far range delivery of liquid fire inhibitor droplets, a liquid wildfire inhibitor pumping system, a liquid wildfire inhibitor storage tank, a battery backup power supply system, a remote/local controller for the automated pumping system; and a water reservoir storage tank containing a quantity of water for use for flushing piping and testing sprinkler spray head sprinkling operations, during post-construction proactive wildfire defense operations.

Another object of the present invention is to provide a novel method of installing and commissioning the operation of a first sprinkler-based wildfire defense system deployed during the construction phase of a home building project, and then installing and commissioning the operation of a second and independent wildfire defense fire inhibitor spraying system deployed during the post construction phase of the home building project, when the first sprinkler-based wildfire defense system is decommissioned and removes from the job-site when the home building is completed and ready for occupancy.

Another object of the present invention is to provide new and improved wildfire defense spraying system (WFDS) including chemical liquid storage tanks loaded with food-grade liquid chemicals and based on the weights and measures that support ASTM fire testing accreditations, EPA Safer Choice Labeling Certification, UL GreenGuard Gold Certification, and passes California Aquatic Testing and EPA and meets California's Proposition 65.

Another object of the present invention is to provide a new and improved system and method of mitigating the damaging effects of wild fires by spraying environmentally-clean fire inhibiting biochemical liquid on property prior to arrival of wildfire to form thin, optically-clear potassium salt crystalline coatings on combustible property, that inhibits fire ignition and flame spread without depending on water, so long as such potassium salt crystalline coatings remain present on the combustible property surfaces.

By virtue of the method of the present invention, it is now possible to significantly reduce the risk of wood home building construction projects occurring within a wildfire urban interface (WUI) region, and better support the underwriting of home construction and ownership insurance policies within such regions.

These and other benefits and advantages to be gained by using the features of the present invention will become more apparent hereinafter and in the appended Claims to Invention.

### BRIEF DESCRIPTION OF THE DRAWINGS

The following Objects of the Present Invention will become more fully understood when read in conjunction of the Detailed Description of the Illustrative Embodiments, and the appended Drawings, wherein:

FIG. 1 is schematic representation of an exemplary prior art Community Homesite Map for use in recognizing the need to mitigate wildfire risks during home building construction projects within the expanding Wildfire Urban Interface (WUI) region, and thereby support the underwriting of sustainable home and property insurance policies;

FIG. 1A is a graphic representation of a first perspective view of a prior art wood-frame lodge constructed and operational within the wildfire urban interface (WUI) region;

FIG. 1B is a graphic representation of a second perspective view of a prior art wood-frame lodge constructed and operational within the wildfire urban interface (WUI) region;

FIG. 1C is a graphic representation of a third perspective view of a prior art wood-frame lodge constructed and operational within the wildfire urban interface (WUI) region;

FIG. 1D is a graphic representation of a first perspective view of a prior art wood-frame home (cabin) constructed and operational within the wildfire urban interface (WUI) region;

FIG. 1E is a graphic representation of a second perspective view of a prior art wood-frame home (cabin) constructed and operational within the wildfire urban interface (WUI) region;

FIG. 1F is a graphic representation of a third perspective view of a prior art wood-frame home (cabin) constructed and operational within the wildfire urban interface (WUI) region;

FIG. 1G is a graphic representation of a first perspective view of a prior art timber-frame home (cabin) constructed and operational within the wildfire urban interface (WUI) region;

FIG. 1H is a graphic representation of a first perspective view of a prior art mass-timber home (cabin) constructed and operational within the wildfire urban interface (WUI) region;

FIG. 2 is schematic representation of the wireless system network of the present invention, including the mobile jobsite wildfire defense system trailer illustrated in FIGS. 3A and 3B, designed for managing the spray-application of the environmentally-clean liquid fire inhibitor on wood buildings under construction at job-sites as well as the surrounding property, and after construction of the wood home building is completed, so as to reduce the risks of property damage and/or destruction and harm to life caused by wildfires and make the underwriting of property insurance more viable and sustainable;

FIG. 2A shows an exemplary mobile computing device deployed on the system network of the present invention, supporting wildfire alerts and notification systems as well as the mobile fire inhibitor spraying management and control applications of the present invention, deployed as a component of the system network;

FIG. 3A is a perspective view of the Mobile Home and Building Construction Wildfire Defense System Trailer of the present invention, comprising a trailer framework provided with wheels, an adjustable stand, a cabin enclosure mounted on the trailer having a rear hinged door/loading ramp, a side door, and an interior volume for storing the components identified the layout chart shown in FIG. 5;

FIG. 3B is a rear view of the Mobile Home and Building Construction Wildfire Defense System Trailer of the present invention shown in FIG. 3A, wherein the Home Construction Wildfire Defense System Trailer contains and supports supplies of Citrotech MFB-31 for performing three 3 different functions, namely (i) spraying fire inhibiting liquid over wood building materials to provide Class-A fire protection to wood buildings as they are constructed, (ii) providing fire extinguishing liquid in event of fire outbreaks on the home construction job-site, and (iii) spraying fire inhibiting liquid over the job-site home construction area and wood building(s) being constructed thereon—prior to the occurrence of a wildfire outbreak—automatically detected by AI-triggered smoke and ember sensors deployed across the WUI Region;

FIG. 4 is a schematic block diagram of the mobile wildfire defense system trailer for deployment and use on a home construction job-site 160, wherein five (5) primary subsystems are contained within the envelope of the mobile wildfire fire defense system trailer as shown in FIG. 5, namely (i) a portable backpack fire inhibitor spray-atomizing system, (ii) a portable air-less liquid fire inhibitor spraying system, (iii) 5 gallon pails of environmentally-clean liquid fire inhibitor for class A fire protection of wood material on job-site project, (iv) trailer-mounted automated sprinkler-based job-site wildfire defense spraying system for use during the construction phase of a home building project, triggered by an automated AI-based smoke and/or wildfire ember detection system network deployed within the WUI region, (v) portable trailer-mounted fire extinguishing system for use in extinguishing job-site construction fires, (vi) kit and components for installing an automated sprinkler-based wildfire defense system integrated in and on the constructed home, after the construction phase of the home building project is completed, and (vii) a water storage reservoir tank containing a quantity of water for use in system testing and certification purposes;

FIG. 5 is a schematic representation of an exemplary layout equipment inside the mobile wildfire home construction defense system trailer, for at least the following items, namely (i) a portable backpack fire inhibitor spray-atomizing system, (ii) a portable air-less liquid fire inhibitor spraying system, (iii) 5 gallon pails of environmentally-clean liquid fire inhibitor for class A fire protection of wood material on job-site project, (iv) trailer-mounted automated sprinkler-based job-site wildfire defense spraying system for use during the construction phase of a home building project, triggered by an automated AI-based smoke and/or wildfire ember detection system network deployed within the WUI region, (v) portable trailer-mounted fire extinguishing system for use in extinguishing job-site construction fires, (vi) kit and components for installing an automated sprinkler-based wildfire defense system integrated in and on the constructed home, after the construction phase of the home building project is completed, and (vii) a water storage reservoir tank containing a quantity of water for use in system testing and certification purposes;

FIG. 6 is a perspective view of a portable backpack fire inhibitor spray-atomizing system for use on job-site wood-frame building construction sites during the construction phase of a home building project in the wildfire urban interface (WUI) region;

FIG. 7 is a perspective view of a portable air-less spraying system for spraying environmentally-clean liquid fire inhibitor on exposed wood surfaces on wood frame building during the construction phase of a home building project in the wildfire urban interface (WUI) region;

FIG. 8 is a perspective view of a pallet of 5 gallon pails containing environmentally-clean liquid wildfire inhibitor for Class A fire protection of wood material on job-site project in the wildfire urban interface (WUI) region, wherein the liquid fire inhibitor (e.g. Citrotech™ MFB-31), factory-blended and certified, is used to spray the exterior of all wood framed and/or mass-timber material surfaces of the wood-framed and/or mass-timber buildings, wherein in the case of wood-framed building projects, an air-less liquid sprayer is the preferred method of spray applying the liquid fire inhibitor to the wood surfaces of wood-framed building projects, to provide Class-A fire protection to the exterior wood surfaces that might become exposed to wildfire or other sources of fire during the home building project, and wherein in the case of mass-timber wood building projects, most mass-timber construction panels will have been prefabricated in a factory environment. In such cases, the mass-timber panels will be sprayed with liquid fire inhibitor within the factory environment, to provide Class-A fire protection to the mass-timber panels, and these mass-timber panels can also be sprayed again with liquid wildfire inhibitor at the home wood-building construction site for added wildfire protection;

FIG. 8A is a schematic representation illustrating the primary components of a first environmentally-clean aqueous-based fire inhibiting liquid biochemical composition of the present invention consisting of major amounts of tripotassium citrate (TPC) and minor amounts of triethyl citrate (TEC) formulated with water functioning as a solvent, carrier, and dispersant;

FIG. 8B is a schematic representation illustrating the primary components of a first fire inhibiting biochemical composition kit of the present invention, consisting of major amounts of dry tripotassium citrate monohydrate (TPC) and minor amounts of triethyl citrate (TEC), as components in a package prepared and ready for mixing with a predetermined quantity of water functioning as a solvent, carrier and dispersant, to make up a predetermined quantity of environmentally-clean liquid fire inhibiting biochemical composition for proactively treating and protecting wood products;

FIG. 9 a process of forming a tripotassium citrate (TPC) crystalline structures on combustible surfaces, such as ground cover, native fuel, lumber, living plant tissue, tree bark, and other combustible tissue and like materials that are sprayed with atomized sprays, or otherwise coated, with the chemical material comprising the aqueous-based fire inhibiting solutions of the present invention;

FIG. 10 is a perspective view of a workman spraying environmentally-clean wildfire inhibitor on the wood surfaces of a wood building being constructed on a job-site during the construction phase of the wood home building project, to provide Class A fire protection to the spray-treated wood surfaces;

FIG. 10A is a schematic representation illustrating the atoms and atom numbering in the crystal structure of the compound, tripotassium citrate (K3C6H5O7) formed on treated surfaces in accordance with the principles of the present invention;

FIG. 10B is a schematic representation of the atomic crystal structure of a small piece of the crystalline structure of tripotassium citrate (K3C6H5O7) salt structure formed on a substrate to be protected against fire by way of application of the fire inhibiting chemical solution of the present invention, graphically illustrated the stage C illustration of FIG. 10A when water molecules mixed therein have evaporated to the ambient environment during air-drying;

FIG. 11 is a schematic representation of a trailer-mounted system and kit of components for installing automated sprinkler-based wildfire defense system about home construction site before the starting of the construction phase of the home building project in the wildfire urban interface (WUI) region, wherein the system includes (i) a storage tank mounted on the trailer for storing a quantity of liquid fire inhibitor to be sprayed by sprinkler heads over the job-site and wood building under construction when the sprinkler system is installed and deployed in on the job-site, (ii) an electrically-driven hydraulic pump system mounted on the trailer, (iii) a spray pump system controller mounted on the trailer, (iv) a battery power supply mounted on the trailer for driving electric hydraulic pump system under the spray pump system, (v) solar panel array mounted to the trailer roof top panel, and (vi) a set of sprinkler heads mounted on the job-site, connected to the trailer-supported pumping system and the storage tank, and supported about the ground at different heights (including as high as a flag pole sprinkler) as required to spray liquid fire inhibitor over the top and sides of a wood building under construction and job-site premises and property;

FIG. 11A is a perspective view of the storage tank used for storing environmentally-clean liquid wildfire inhibitor chemicals in the sprinkler-based wildfire defense property spraying system of the present invention, when constructed from the kit of system components shown in FIG. 11;

FIG. 11B is a perspective view of the electric-motor driven fluid pump system that is used in the sprinkler-based wildfire defense property spraying system of the present invention, when constructed from the kit of system components shown in FIG. 11;

FIG. 11C1 is a perspective view of the 4G GSM remote power control switch module used, in conjunction with a smartphone and 4G GSM digital cellular communication network, to control 120V/30 A electrical power supplied to the electric pump system in the sprinkler-based wildfire defense property spraying system of the present invention, when constructed from the kit of system components shown in FIG. 3;

FIG. 11C2 is a perspective view of the 4G GSM remote power control switch module of FIG. 3B1 shown with its weatherproof housing cover removed from the housing to reveal its internal circuit board, 4G GSM antenna, and electrical power relay bar to which wires are connected;

FIG. 11D1 is a perspective view of the 4G GSM GPS sensor that is permanently factory-mounted to the fire inhibitor storage tank that is used in the sprinkler-based wildfire defense property spraying system of the present invention, when constructed from the kit of system components shown in FIG. 11;

FIG. 11D2 is a perspective view of the 4G GSM GPS sensor of FIG. 11D1 shown with its battery power and SIM card module removed for access and activation;

FIG. 11E is a perspective view of one 360-degree (30′ range) sprinkler spray head device used in the sprinkler-based wildfire defense property spraying system of the present invention, when constructed from the kit of system components shown in FIG. 11;

FIG. 11F is a perspective view of one 360-degree (30′ range) sprinkler spray head device used in the sprinkler-based wildfire defense property spraying system of the present invention, when constructed from the kit of system components shown in FIG. 11;

FIG. 11G is a perspective view of one 360-degree (30′ range) sprinkler spray head device used in the sprinkler-based wildfire defense property spraying system of the present invention, when constructed from the kit of system components shown in FIG. 11;

FIG. 11H is a perspective view of the roll of PVC tubing for use in connecting the sprinkler heads, the electric pump system, the storage tank and 2-way valve assembly, and creating the fluid pumping circuit supporting the sprinkler-based wildfire defense property spraying system of the present invention, when constructed from the kit of system components shown in FIG. 11;

FIG. 11I1 is a perspective view of a 4G GSM wireless remote wildfire ember and smoke detector module that can be optionally used in the sprinkler-based wildfire defense property spraying system of the present invention, when constructed from the kit of system components shown in FIG. 11, for the purpose of automatically activating and remotely triggering the spraying of specified property, with liquid fire inhibitor stored in the storage tank, prior to the actual arrival of the remotely-detected wildfire in the vicinity of the protected property region;

FIG. 11I2 is a perspective view of the 4G wireless remote automatic wildfire ember and smoke detector module for use in the sprinkler-based wildfire defense property spraying system of the present invention, when constructed from the kit of system components shown in FIG. 11;

FIGS. 11J1 and 11J2 are perspective views of the lithium-battery electrical power storage system optionally used in providing an un-interrupted electrical power supply (UPS) from a 120/220V electrical power service to the electric pump system and other electrical power consuming components used in the sprinkler-based wildfire defense property spraying system of the present invention, when constructed from the kit of system components shown in FIG. 11;

FIG. 11K is a perspective view of a two-way flow valve assembly used to control (i) the flow of water from a water source into the electric pump when arranged in its first flow position during sprinkler sprayhead testing operations, and (ii) the flow of Citrotech® liquid fire inhibitor from the storage tank into the electric pump when arranged in its second flow position when the system is configured for fire inhibitor spraying operations;

FIG. 11L is a perspective view of the (optional) electrically-powered temperature-controlled immersible heating system for immersion in the chemical liquid stored in the storage tank of the wildfire defense spraying system of the present invention, when the system is constructed from the kit of system components shown in FIG. 11, to heat the liquid fire inhibitor in the storage tank as required to prevent freezing and malfunction of the system;

FIG. 11M is a perspective view of the (optional) electrically-powered temperature-controlled heating blanket adapted for wrapping about the storage tank used in the sprinkler-based wildfire defense property spraying system of the present invention, when constructed from the kit of system components shown in FIG. 11, to heat the liquid fire inhibitor in the storage tank as required to prevent freezing and malfunction of the system;

FIG. 11N is a perspective view of the electrically-powered temperature-controller designed for use with the heating blanket shown in FIG. 11M, supplying electrical power to the heating elements within the blanket, and monitoring the temperature of the liquid fire inhibitor in the storage tank, as required to prevent freezing thereof and system malfunction;

FIG. 11O is a schematic representation illustrating the primary components of a first environmentally-clean aqueous-based fire inhibiting liquid biochemical composition of the present invention consisting of major amounts of tripotassium citrate (TPC) and minor amounts of triethyl citrate (TEC) formulated with water functioning as a solvent, carrier, and dispersant;

FIG. 12 is a schematic representation of a trailer-driven sprinkler-based wildfire defense spray system installed on a wood home construction job-site for protection against wildfire during the home-building construction project;

FIG. 13 is a schematic system block diagram of a trailer-driven sprinkler-based wildfire defense spray system installed on a wood home construction job-site for protection against wildfire during the home-building construction project, comprising: (i) a wildfire ember detection module for mounting on the top of a building or high tree to automatically detect the presence of a wildfire well before its arrival many miles away, and sensing a SMS-spray-triggering signal to the wireless remotely-activatable sprinkler-based wildfire defense fire inhibitor spraying system of the present invention, (ii) Storage Tank (e.g. 50 or 100 Gallons) capacity for storage of liquid fire inhibitor formulation loaded at the factory for mixing with an amount of water that is added to the storage tank at the time of installation and setup, (iii) 4G GSM GPS Sensor for mounting to the Storage Tank for monitoring the GPS location thereof, (iv) Electric Pump connected to the Storage Tank and a supply of pressurized water at installation location via a Valve assembly with first and second positions, (v) a Lithium-Battery Backup Power Supply System with photovoltaic (PV) recharging panel and 120 V line input from a local source of electrical power, for supplying electrical power to the electric pump, (vi) sprinkler spray heads, PVC piping for forming the necessary fluid pumping circuits from the electric pump to the sprinkler spray heads during spraying operations, and (vii) a 4G GSMGPRS Transceiver and the Remote Power Control Switch for remotely controlling electrical power to the Electric Pump via the 4G GSM remote control power switch;

FIG. 14 is a trailer-mounted gas or electric pump driven home job-site construction fire extinguishing system, for use in extinguishing job-site wood-frame building construction fires during the construction phase of a home building project in the wildfire urban interface (WUI) region;

FIG. 15A is a perspective view of the trailer-mounted pump driven home job-site construction fire extinguishing system, for use in rapidly extinguishing home construction job-site fire outbreaks by spraying potassium salt enriched water streams produced from a hand-held spray nozzle;

FIG. 15B is perspective view of the hand-held spray nozzle used in the system shown in FIGS. 14 and 15A;

FIG. 16 is a schematic illustration showing the kit and components for building and installing an automated sprinkler-based wildfire home defense system on the fully constructed home after the construction phase of the home building project has been completed in the wildfire urban interface (WUI) region;

FIG. 17 is a schematic block diagram of the automated sprinkler-based wildfire home defense system of the present invention constructed using the system components shows in FIG. 16;

FIG. 18A is a schematic illustration of the wildfire defense system and method used on a first exemplary wood frame home construction job-site during the construction phase of a home building project, in accordance with the principles of the present invention;

FIG. 18B is a schematic illustration of the wildfire defense system and method used on a second exemplary wood frame home construction job-site during the construction phase of a home building project, in accordance with the principles of the present invention;

FIG. 18C is a schematic illustration of the wildfire defense system and method used on a first exemplary mass-timber home construction job-site during the construction phase of a home building project, in accordance with the principles of the present invention;

FIG. 18D is a schematic illustration of the wildfire defense system and method used on a second exemplary mass-timber home construction job-site during the construction phase of a home building project, in accordance with the principles of the present invention;

FIG. 19 is a schematic representation of an above-ground sprinkler-based wildfire defense system installation mounted around and about a building under construction at job-site property to be defended against wildfire;

FIG. 20 is a schematic system block diagram of the above-ground sprinkler-based firebreak spray system installation shown in FIG. 19 mounted about a building under construction at job-site property to be defended against wildfire;

FIG. 21 is a schematic representation of an above-ground sprinkler-based firebreak spray system installation mounted about a building under construction at job-site on property to be defended against wildfire;

FIG. 22 is a schematic representation of mobile smartphone being used to remotely activate the spraying of fire inhibitor before the arrival of a wildfire on the home construction job-site, using SMS supported by a 4G GSM digital cellular communication link between the smartphone and the 4G GSM remote power control switch employed in the home construction job-site wildfire defense system trailer of the present invention;

FIG. 23 is a perspective view of a sprinkler piping being installed in the ground along a part of the property parcel where a clean chemistry wildfire break is to be formed on the home construction job-site in the direction of prevailing winds;

FIG. 23A is a perspective view of a ground mounted sprinkler riser, shown in FIG. 23, installed along a part of the property parcel where a clean chemistry wildfire break is to be formed on the home construction job-site in the direction of prevailing winds;

FIG. 24 is a schematic illustration showing the use of the backpack atomizing spraying system for spraying environmentally-clean liquid wildfire inhibitor over combustible native fuel surfaces surrounding the home construction job-site, in accordance with the principles of the present invention;

FIGS. 25A, 25B, and 25C, taken together, shows a flow chart describing the steps to be undertaken when practicing the preferred method of installing and operating the home wildfire defense system of present invention during the construction phase of a home building project;

FIG. 26A is a schematic illustration of the wildfire defense system and method used on a first exemplary wood frame home and property during the post-construction phase of a home building project, in accordance with the principles of the present invention;

FIG. 26B is a schematic illustration of the wildfire defense system and method used on a second exemplary wood frame home and property during the post-construction phase of a home building project, in accordance with the principles of the present invention;

FIG. 26C is a schematic illustration of the wildfire defense system and method used on a first exemplary mass-timber home and property during the post-construction phase of a home building project, in accordance with the principles of the present invention;

FIG. 27 is a schematic representation of an above-ground sprinkler-based wildfire defense system installation mounted around and about a completed home building to be defended against wildfire;

FIG. 28 is a schematic system block diagram of the above-ground sprinkler-based firebreak spray system installation shown in FIG. 27 mounted on and about a completed home building to be defended against wildfire;

FIG. 29 is a schematic representation of an above-ground sprinkler-based firebreak spray system installation mounted about a building under construction at job-site on property to be defended against wildfire;

FIG. 30 is a schematic representation of mobile smartphone being used to remotely activate the spraying of fire inhibitor before the arrival of a wildfire on the home construction job-site, using SMS supported by a 4G GSM digital cellular communication link between the smartphone and the 4G GSM remote power control switch employed in the home installed wildfire defense system of the present invention;

FIGS. 31A, 31B, and 31C, taken together, shows a flow chart describing the steps to be undertaken when practicing the preferred method of installing and operating the home wildfire defense system of present invention during the post-construction phase of a completed home building project;

FIG. 34 is a schematic representation of an above-ground sprinkler-based firebreak spraying system installation of the present invention configured before a property to be defended against wildfire by spraying a zone of fire inhibiting chemistry that inhibits fire ignition and flame spread by hot flying wildfire embers created during a wildfire storm;

FIG. 35 is a block schematic representation of a wireless remotely-activatable sprinkler-based wildfire defense fire inhibitor spraying system of the present invention deployed in FIG. 34;

FIG. 36 is a schematic diagram showing the resulting linear spray pattern generated by the sprinkler sprayheads mounted above the ground before the property to be protected and driven by the wildfire defense fire inhibiting spraying system of this illustrative embodiment of the present invention;

FIG. 37 is a schematic representation of mobile smartphone being used to remotely activate the spraying of fire inhibitor before the arrival of a wildfire on the property of the system installation of FIGS. 34 and 35, using SMS supported by a 4G GSM digital cellular communication link between the smartphone and the 4G GSM remote power control switch employed at the spraying system installation;

FIG. 38 is a schematic representation of an under-ground sprinkler-based firebreak spraying system installation of the present invention configured about a property to be defended against wildfire by spraying a zone of fire inhibiting chemistry that inhibits fire ignition and flame spread by hot flying wildfire embers created during a wildfire storm;

FIG. 39 is a cross-sectional block schematic representation of the wireless remotely-activatable sprinkler-based wildfire defense fire inhibitor spraying system of the present invention deployed in FIG. 38;

FIGS. 40A and 40B, taken together, set forth a schematic diagram showing the system of the present invention shown in FIGS. 38 and 39, providing an inground spraying solution around the property, wherein spreadheads, chemical storage tank and electric pump and components are mounted underground, and configured for automatically spraying preconfigured patterns of environmentally-clean fire inhibitor on ground surfaces requiring proactive protection against wildfires,

FIG. 41 is a schematic diagram showing the resulting linear spray pattern generated by the sprinkler sprayheads mounted underground before and/or about the property to be protected, and driven by the wildfire defense fire inhibiting spraying system of this illustrative embodiment of the present invention; and

FIG. 42 is a schematic representation of mobile smartphone being used to remotely activate the spraying of fire inhibitor before the arrival of a wildfire on the property of the system installation of FIGS. 40A, 40B and 41, using SMS supported by a 4G GSM digital cellular communication link between the smartphone and the 4G GSM remote power control switch employed at the spraying system installation.

### DETAILED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

Wireless System Network for Managing the Supply, Delivery and Spray-Application of Environmentally-Clean Fire-Inhibiting Biochemical Liquid on Private and Public Property, Including Wood-Building Home Job-Sites, to Reduce the Risks of Damage and/or Destruction Caused by Wild Fires, and Support the Sustainable Underwriting of Home, Building and Property Insurance Policies Operating within the Wildfire Urban Interface (WUI) Regions Around the Globe

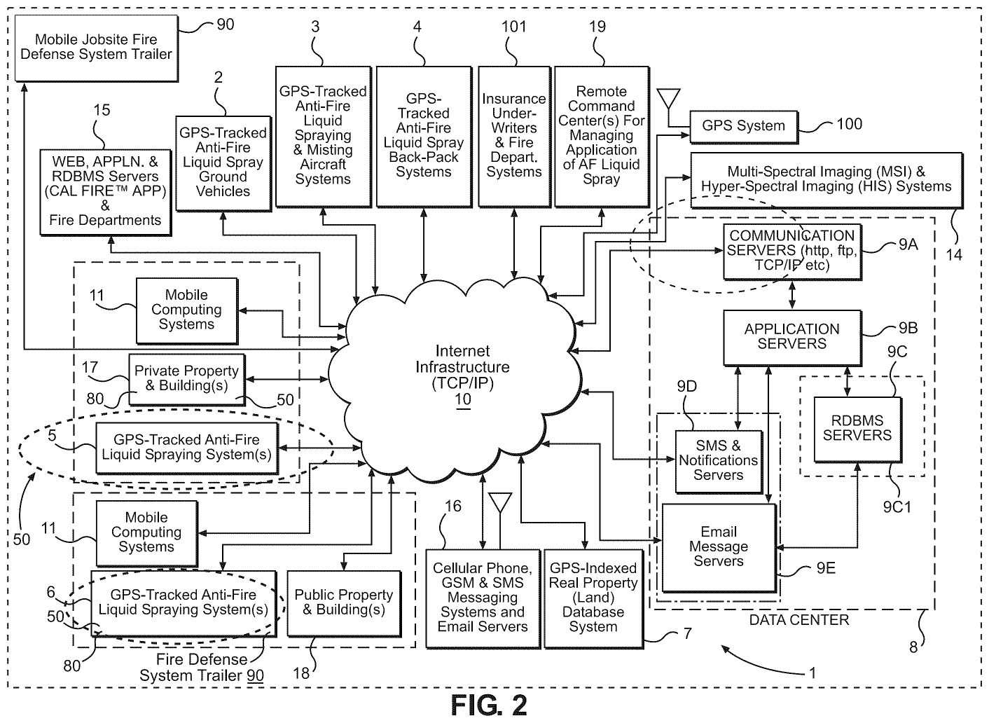

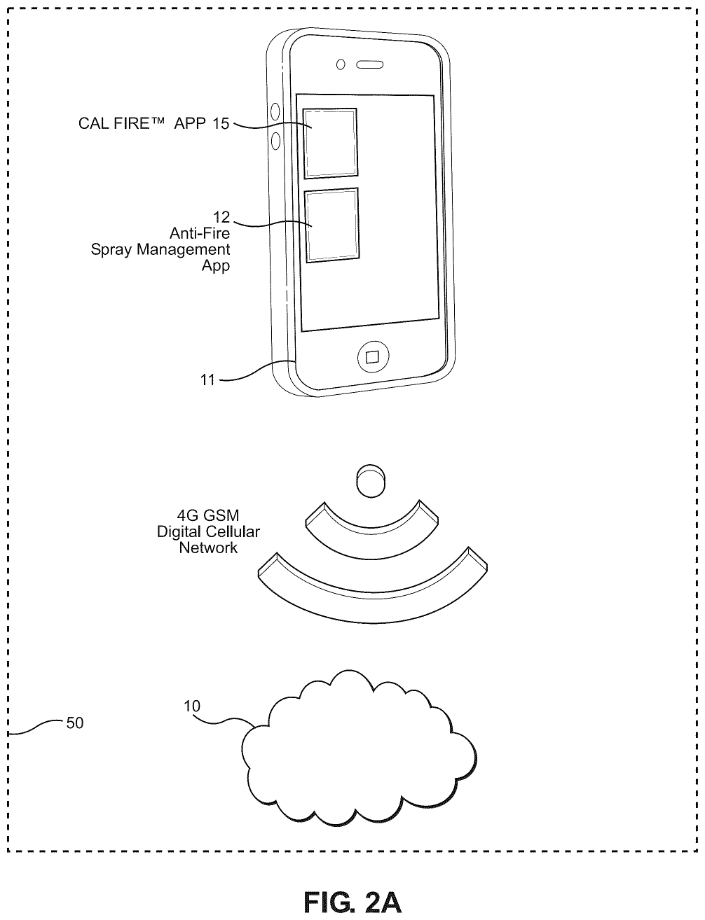

FIG. 2 shows the wireless system network of the present invention 1 designed for managing the supply, delivery, and spray-application of environmentally-clean biochemical liquid fire inhibitor composition of the present invention, on private and public property, including wood-building home construction job-sites 160, to reduce the risks of damage to and/or destruction of wood buildings under construction, caused by wild fires, and support the sustainable underwriting of home, building and property insurance policies within the wildfire urban interface (WUI) regions around the globe. This system network 1 is described in Applicant's U.S. Pat. No. 10,653,904B2, et al incorporated herein by reference.

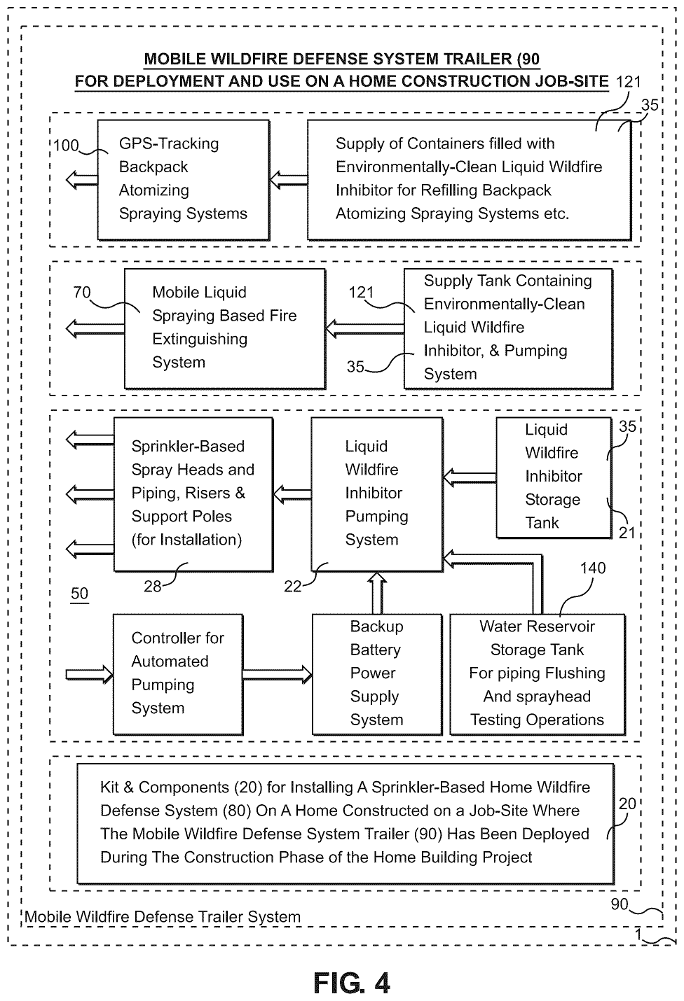

As disclosed therein, the system network comprises a distribution of system components, namely: GPS-tracked fire inhibiting (or anti-fire) liquid spray ground vehicles 2 (e.g. all-terrain vehicles or ATVs), for spray applying liquid chemical fire inhibitor, formulated according to the present invention, to ground surfaces, brush surfaces, and the surfaces of other forms of organic combustible material on property; GPS-tracked anti-fire liquid spray air-based vehicles 3, for applying fire inhibiting chemical liquid spray of the present invention (formulated as illustrated in FIGS. 4A and 4B and specified herein) from the air to ground surfaces, brush, bushes and other forms of organic material; GPS-tracked mobile anti-fire liquid back-pack spraying systems 4 (e.g. including wheel supported, and backpack-carried systems), for applying fire inhibiting chemical liquid spray to combustible ground surfaces, brush, bushes, decks, houses, buildings, and other forms of organic material and property surrounding houses; GPS-tracked/GSM-linked liquid spraying systems 5, for applying fire inhibiting chemical liquid spray to combustible surfaces on private real property, buildings and surrounding areas, and further specified in the present Patent Specification; GPS-tracked/GSM-linked liquid spraying systems 6, for applying fire inhibiting chemical liquid spray to combustible surfaces on public real property and buildings and surrounding properties; a fleet of mobile construction job-site wildfire defense system trailers 90 deployed and used on wood home and building construction job-sites anywhere within the WUI region, for the purpose of managing and delivering environmentally-clean liquid fire inhibiting chemical (by spraying operations) to the exterior surfaces of wood and other combustible surfaces present at home construction and other building job-sites, long before the arrival of hot flying embers from a wildfire and/or wildfire storm so as to reduce and/or mitigate damage and/or destruction of property by wildfire; a GPS-indexed real-property (land) database system 7 for storing the GPS coordinates of the vertices and maps of all land parcels, including private property and building 17 and public property and building 18, situated in every town, county and state in the region over which the system network 1 is used to manage wild fires as they may occur; a cellular phone, GSM, and SMS messaging systems and email servers, collectively 16; and one or more data centers 8 for monitoring and managing GPS-tracking/GSM-linked liquid supply and spray systems, including web servers 9A, application servers 9B and database servers 9C (e.g. RDBMS) operably connected to the TCP/IP infrastructure of the Internet 10, and including a network database 9C1, for monitoring and managing the system and network of GPS-tracking anti-fire liquid spraying systems and various functions supported by the command center 19, including the management of wild fire suppression and the GPS-guided application fire inhibiting chemical liquid over public and private property, as will be described in greater technical detail hereinafter. As shown, each data center 8 also includes an SMS server 9D and an email message server 9E for communicating with registered users on the system network 1 who use a mobile computing device (e.g. an Apple® iPhone or iPad tablet) 11 as shown in FIG. 2A, having mobile applications 12 installed thereon and configured for the purposes described herein. Such communication services will include SMS/text, email and push-notification services known in the mobile communications arts.

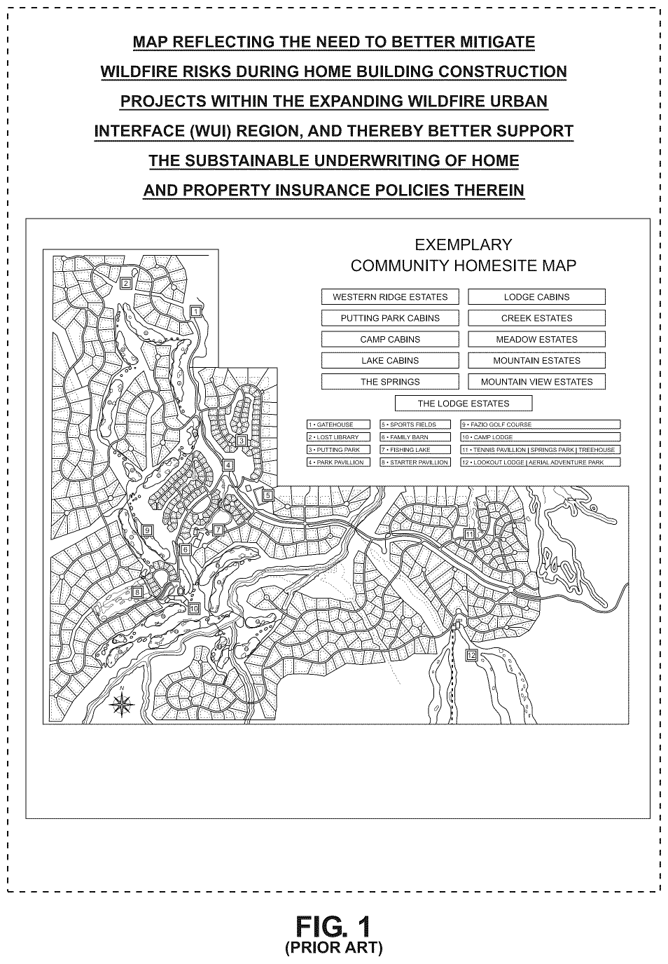

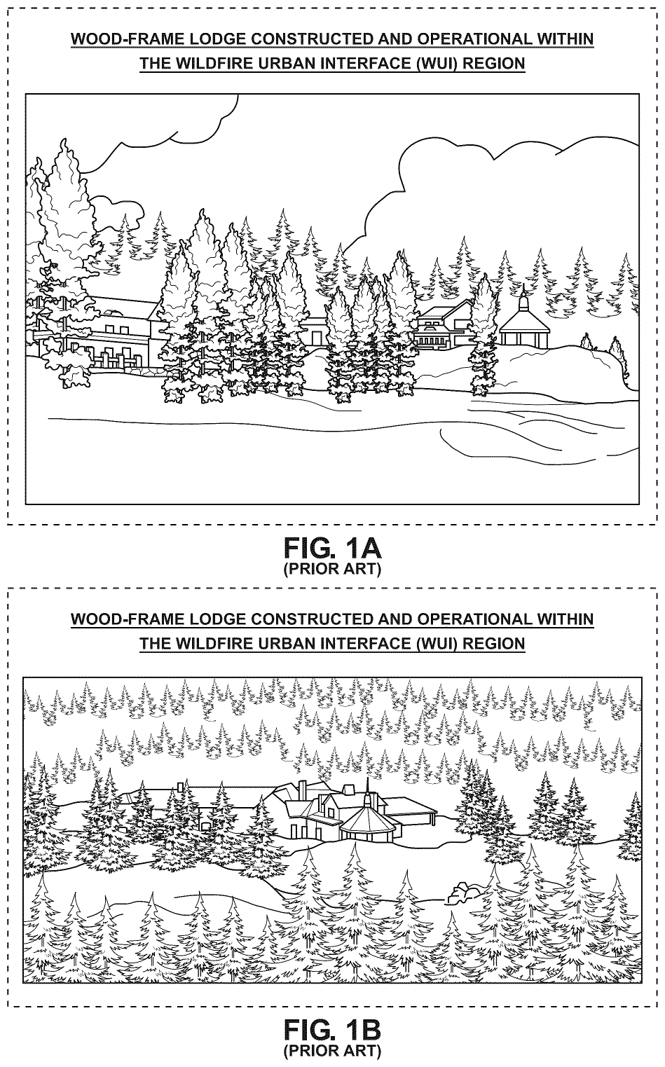

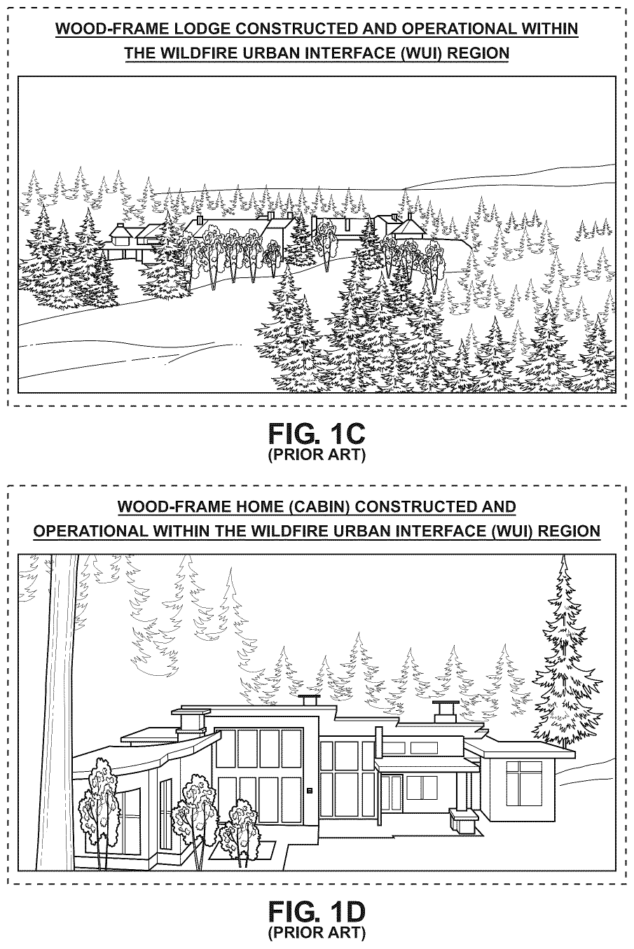

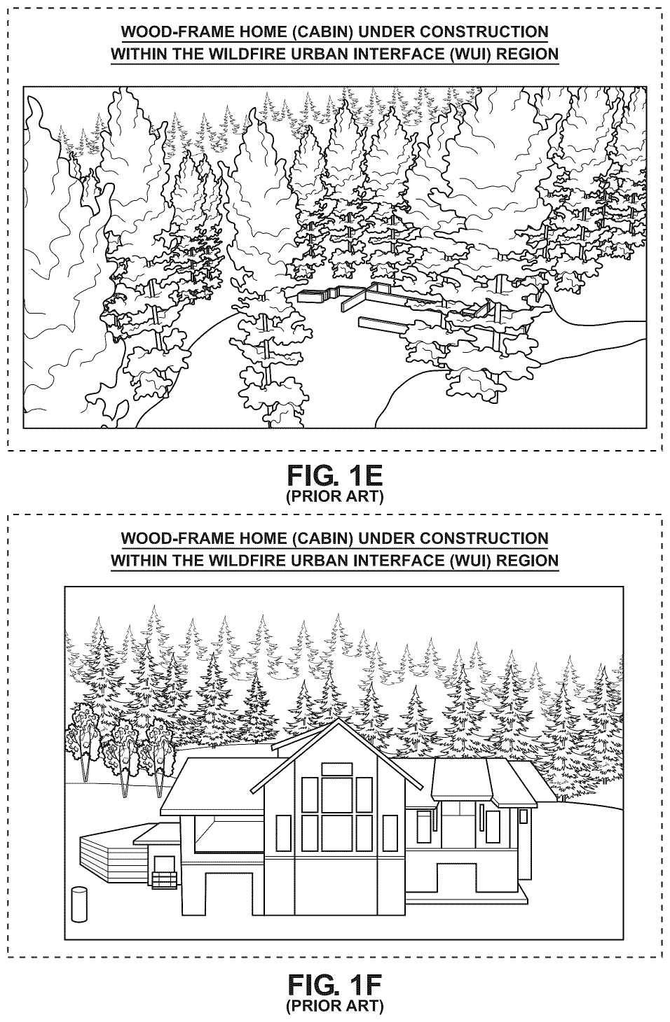

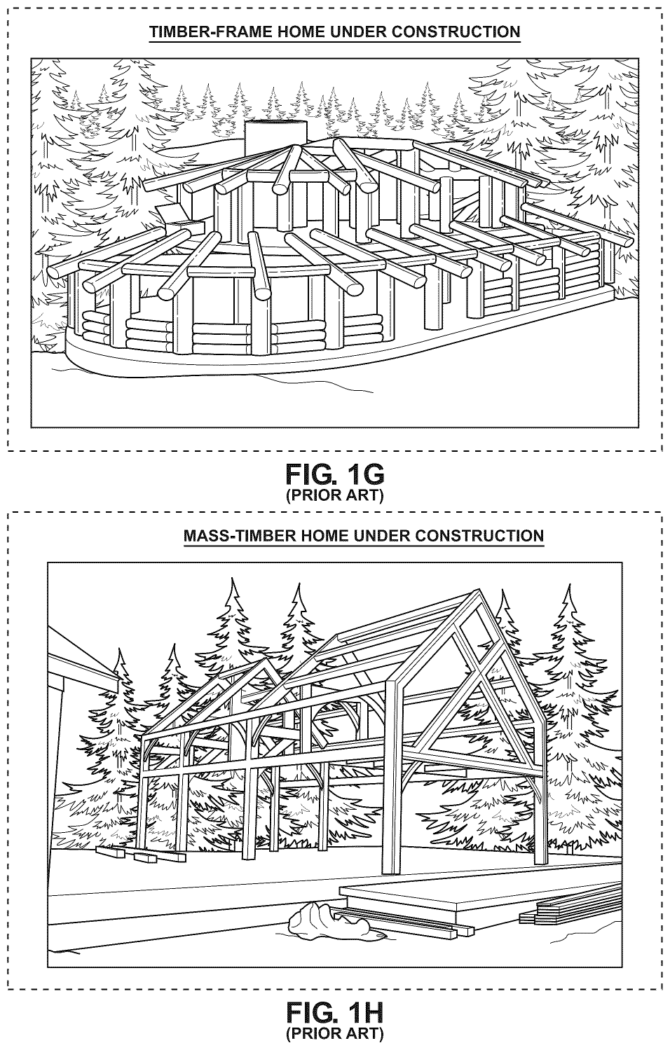

As shown in FIG. 1, the system network architecture shows many different kinds of users supported by mobile computing devices 11 running the mobile application 12 of the present invention, namely: the plurality of mobile computing devices 11 running the mobile application 12, used by fire departments and firemen to access services supported by the system network 1; the plurality of mobile computing systems 11 running mobile application 12, used by insurance underwriters and agents to access services on the system network 1; the plurality of mobile computing systems 11 running mobile application 12, used by building architects and their firms to access the services supported by the system network 1; the plurality of mobile client systems 11 (e.g. mobile computers such as iPad, and other Internet-enabled computing devices with graphics display capabilities, etc.) used by spray-project technicians and administrators, and running a native mobile application 12 supported by server-side modules, supporting client-side and server-side processes on the system network of the present invention; and a GPS-tracked anti-fire liquid spraying systems for spraying buildings and ground cover to provide protection and defense against wild-fires. These subsystems are further specified in detail in U.S. Pat. No. 10,653,904B2.

FIG. 2A shows an exemplary mobile computing device 11 deployed on the system network of the present invention. Such mobile computing systems support conventional wildfire alert and notification systems (e.g. CAL FIRE® wild fire notification system 14), as well as the mobile fire inhibitor spraying management application 12 of the present invention, that is deployed as a component of the system network 1. The features of mobile smartphone device 11 can be found in U.S. Pat. No. 8,631,358 incorporated herein by reference in its entirety.

Notably, new and improved the GPS-tracked/GSM-linked, sprinkler-based wildfire defense (fire inhibiting liquid) spraying systems 5 indicated in the system network of FIG. 1, and kits for constructing such systems, will be further specified in detail hereinafter in the present Patent Specification.

### Specification of the Mobile Home and Building Construction Job-Site Wildfire Defense System Trailer of the Present Invention

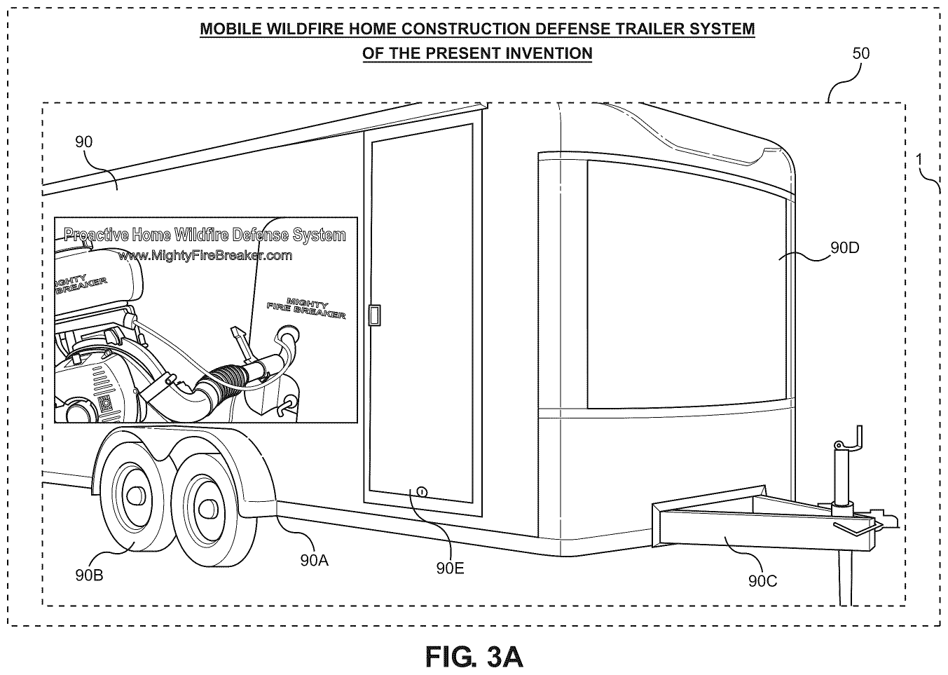

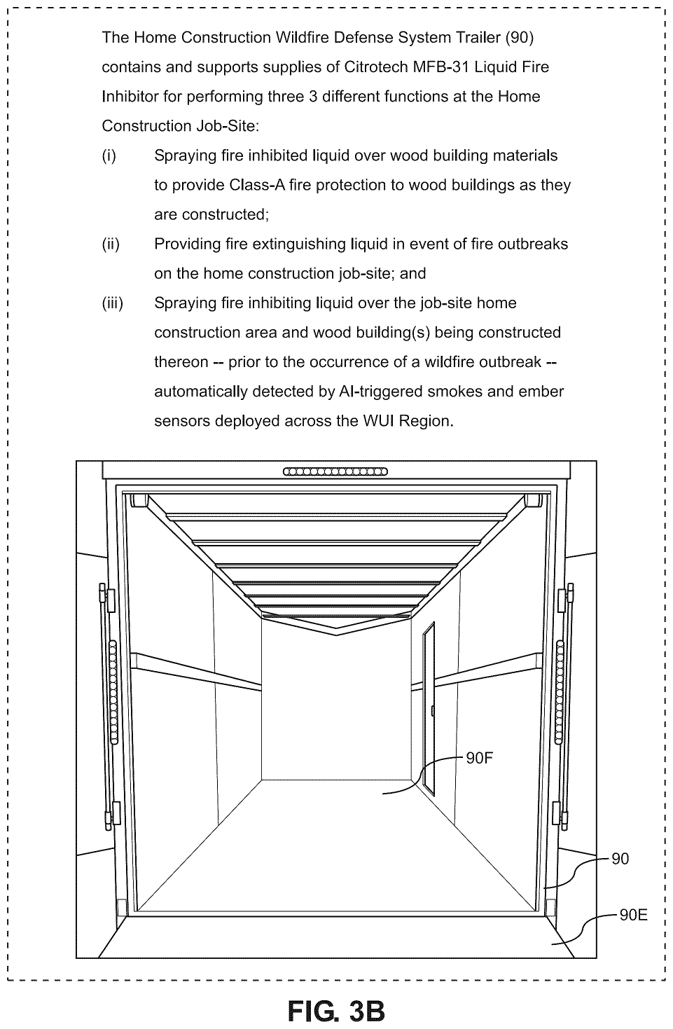

As shown in FIGS. 3A and 3B, for each home and building construction job-site 160 within the WUI region, a mobile home and building construction job-site wildfire defense system trailer 90 will be deployed on the system network 1, and used on the wood home and building construction job-sites for the purpose of managing and delivering environmentally-clean liquid fire inhibiting chemical (by spraying operations) to the exterior surfaces of wood and other combustible surfaces present at home construction and other building job-sites, long before the arrival of hot flying embers from a wildfire and/or wildfire storm so as to reduce and/or mitigate damage and/or destruction of property by wildfire.

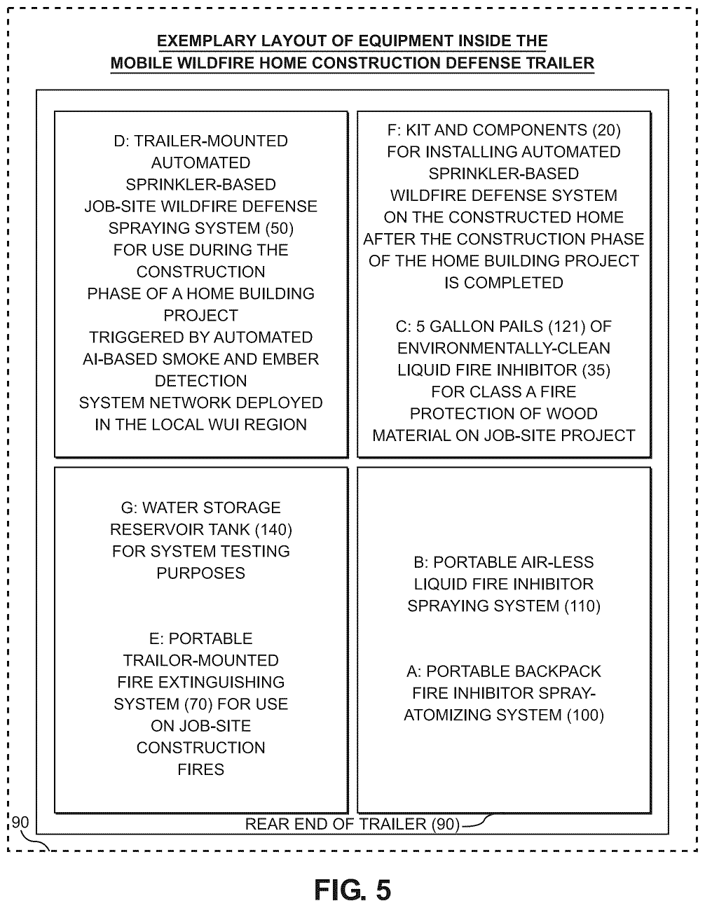

As shown in FIGS. 3A and 3B, the Mobile Wildfire Home Construction Defense System Trailer 90 comprises: a trailer framework 90A provided with wheels 90B, an adjustable stand mechanism 90C adapted for coupling to a hitch mounted on the rear frame of a truck or tractor provided with an engine and drive train for pulling the trailer to its home construction job-site destination(s), a cabin enclosure 90D mounted on the trailer 90 having a rear hinged door/loading ramp 90E for loading and unloading equipment and supplies stored inside the cabin, a side door 90E, and a sheltered interior volume 90F for storing the components identified the layout chart shown in FIG. 5.

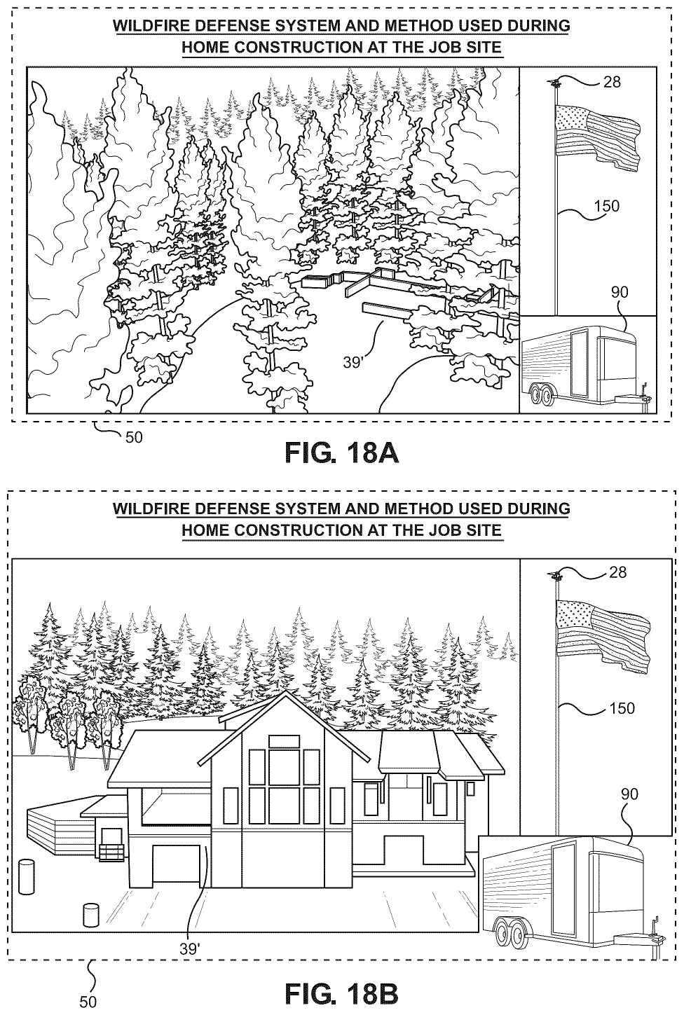

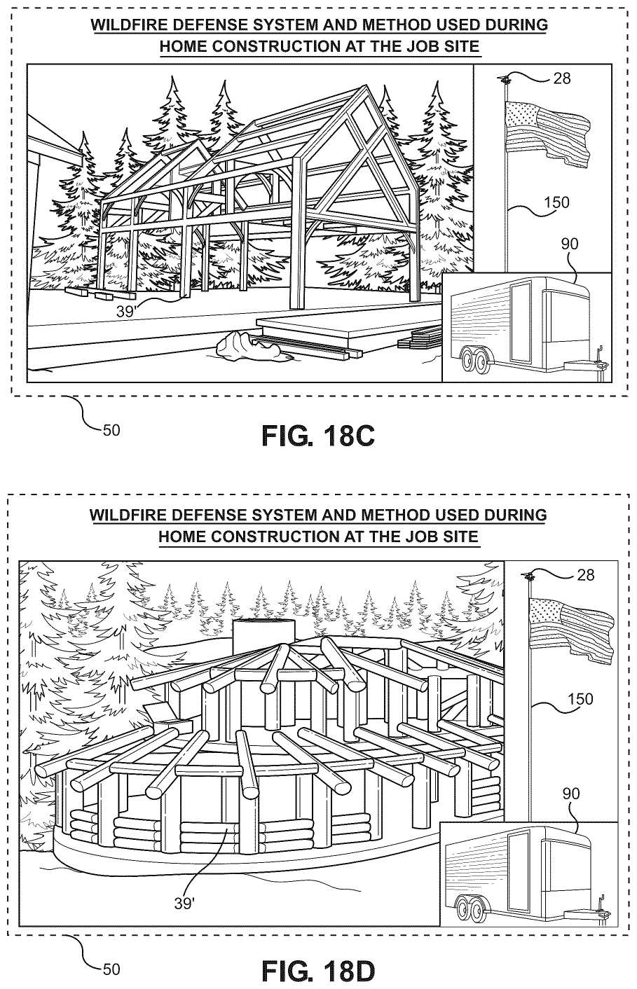

As shown in FIG. 4, the Mobile Home Construction Job-Site Wildfire Defense System Trailer 90 contains and supports diverse kinds of equipment, and supplies of Citrotech MFB-31 liquid wildfire inhibitor 35 that is to be used for performing three 3 different functions, namely: (i) spraying environmentally-clean fire inhibiting liquid 35 over wood building materials to provide Class-A fire protection to wood buildings as they are constructed on the on the home and building construction job-site 160, as shown in FIGS. 18A, 18B, 18C, and 18D; (ii) providing environmentally-clean fire extinguishing liquid 35 in event of fire outbreaks on the home and building construction job-site; and (iii) spraying environmentally-clean fire inhibiting liquid 35 over the job-site home construction area and wood building(s) being constructed thereon—prior to the occurrence of a wildfire outbreak—automatically detected by AI-triggered smoke and ember sensors 27 deployed across the WUI Region.

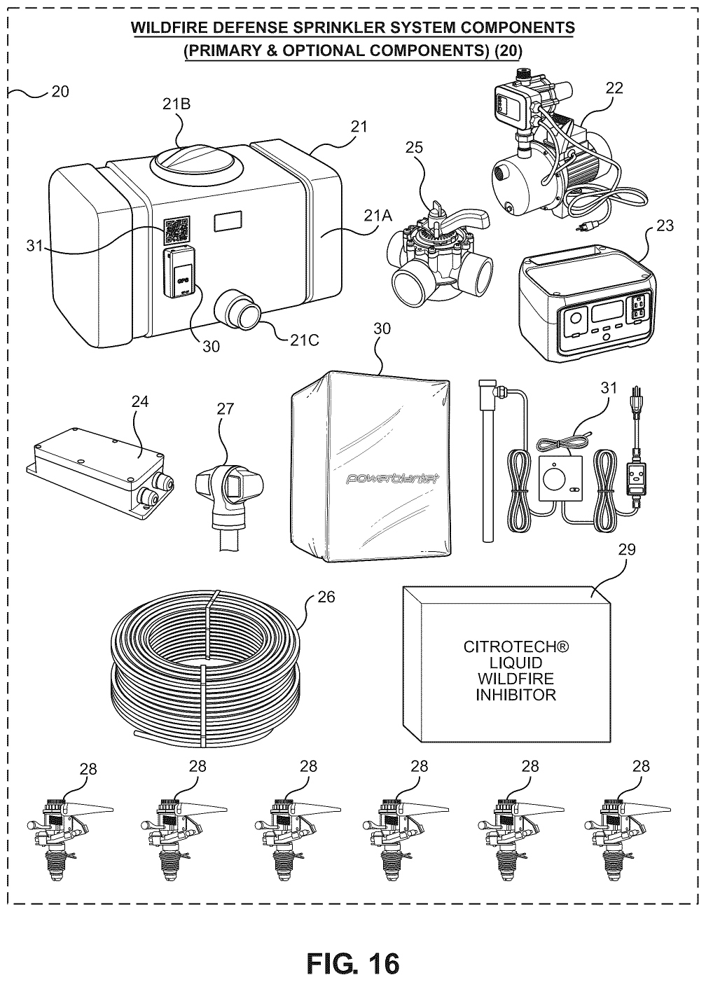

As shown in FIG. 4, the mobile home and building construction job-site wildfire defense system trailer 90 comprises and supports a number of subsystems within its envelope as shown in FIG. 5, namely: (i) a portable backpack fire inhibitor spray-atomizing system 100 described in greater detail in U.S. Pat. No. 11,865,390, incorporated herein by reference, each filled with a quantity of environmentally-clean liquid fire inhibitor (i.e. CITROTECH™ MFB-31 liquid fire inhibitor) 35 supplied from supply tank 100A; (ii) a portable air-less liquid fire inhibitor spraying system 110 with a spray nozzle 110A, electric powered air-less pump/spraying unit 110B, a siphon bar 110C for insertion within a bucket containing liquid fire inhibitor 35 for spraying, and a flexible hose 110D, for spraying environmentally-clean liquid fire inhibitor (e.g. CITROTECH™ MFB-31 fire inhibitor) disclosed in U.S. Pat. No. 11,865,390, incorporated by reference; (iii) a palate of 5 gallon pails 120, each pail 121 containing environmentally-clean liquid fire inhibitor (e.g. CITROTECH™ MFB-31 fire inhibitor) 35 disclosed in U.S. Pat. No. 11,865,390, incorporated by reference, for use in spraying on wood material on a home construction job-site and providing Class A fire protection to wood material present therein; (iv) trailer-mounted automated sprinkler-based job-site wildfire defense spraying system 90 for use during the construction phase of a home building project, triggered by an automated AI-based smoke and/or wildfire ember detection system/network 27 deployed within a WUI region; (v) portable trailer-mounted fire extinguishing system 120 for use in extinguishing job-site construction fires using a supply tank containing environmentally-clean liquid fire inhibitor (e.g. CITROTECH™ MFB-31 fire inhibitor); (vi) kit and components for installing an automated sprinkler-based wildfire defense system 80, as shown in FIG. 16, integrated in and on the constructed home and surrounding property, and deployed and commissioned only after the construction phase of the home building project has been completed, wherein the automated sprinkler-based wildfire defense system 50 includes a trailer-supported sprinkler-based liquid wildfire inhibitor sprinkler/spraying system 90 (e.g. which may include a flag pole supported sprinkler spray head for deep and far range delivery of liquid fire inhibitor droplets, a liquid wildfire inhibitor pumping system 22, a liquid wildfire inhibitor storage tank 21, a battery backup power supply system 23, a remote/local controller for the automated pumping system 24; and a water reservoir storage tank containing a quantity of water for use for flushing piping and testing sprinkler spray head sprinkling operations, during post-construction proactive wildfire defense operations.

As shown in FIG. 5, an exemplary layout of equipment and supplies stored inside the mobile wildfire home construction defense system trailer 90 comprises: (i) one or more portable backpack fire inhibitor spray-atomizing systems 100 described in U.S. Pat. No. 11,865,390; (ii) one or more portable air-less liquid fire inhibitor spraying systems 110 for spraying wood building surfaces with Citrotech® MFB-31 liquid wildfire inhibitor to provide Class A fire protection thereto; (iii) the palate of 5 gallon pails 121 of environmentally-clean liquid fire inhibitor for Class A fire protection of wood material on the home building construction job-site project; (iv) trailer-mounted automated sprinkler-based job-site wildfire defense spraying system 50 for use during the construction phase of a home building project, and triggerable by an automated AI-based smoke and/or wildfire ember detection system network 27 deployed within the WUI region; (v) portable trailer-mounted fire extinguishing system 70 for use in extinguishing job-site construction fires; (vi) kit and components 20, shown in FIG. 16 for constructing, installing and commissioning an automated sprinkler-based wildfire defense system 80 integrated in and on the constructed home, after the construction phase of the home building project is completed; and (vii) a water storage reservoir tank 140 containing a quantity of water for use in system testing and certification purposes.

### Specification of the Portable Backpack Liquid Fire Inhibitor Spray-Atomizing System of the Present Invention

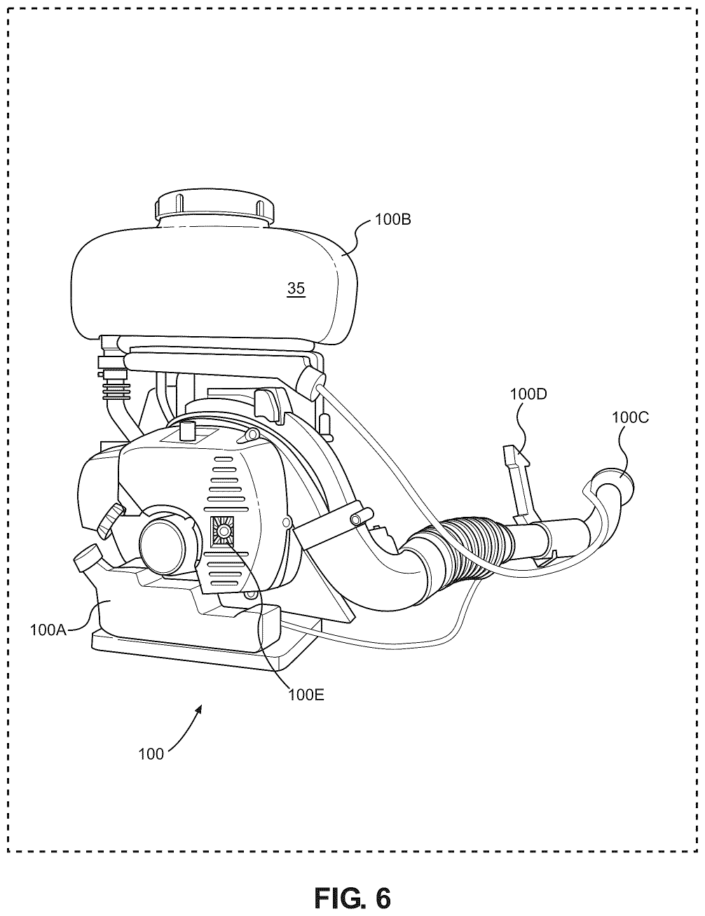

FIG. 6 shows a portable backpack fire inhibitor atomizing-spraying system 100 for use on job-site wood-frame building construction sites during the construction phase of a home building project in the wildfire urban interface (WUI) region. This portable backpack fire inhibitor spray-atomizing system 100 is described in U.S. Pat. No. 11,865,390, incorporated herein by reference.

As shown in FIG. 6, the mobile backpack atomizing-spraying system 100 comprises: a backpack housing for strapping onto the back of a human technician; a gas or electric-powered liquid pumping/spraying engine 100E that is either fueled by an electric battery power supply, or hydrocarbon fuel contained in a fuel tank, each being represented by reference number 100A; a storage tank 100B for storing an predetermined amount of liquid fire inhibitor (e.g. CITROTECH® MFB-31 liquid fire inhibitor 35) and spraying atomized spray streams thereof out from the distal portion of the spray nozzle 100C under the manual control of spray throttle 100D.

The purpose of portable backpack fire inhibitor atomizing-spraying system 100 is to enable workers to easy spray Citrotech® MFB-31 liquid fire inhibitor 35 and like fire inhibiting liquids over combustible ground surfaces on the home building construction job-site and surrounding property, where wildfire storms are likely to present risk of ignition and flame spread. Wherever Citrotech® MFB-31 liquid fire inhibitor 35 is sprayed, ultra-thin potassium salt microcrystalline coatings are formed on combustible ground materials on the home construction job-site 160, to provide effective wildfire defense without risk of killing living plant life and horticultural plantings around the home construction job-site 160 and surrounding property.

### Specification of the Portable Air-Less Spraying System of the Present Invention

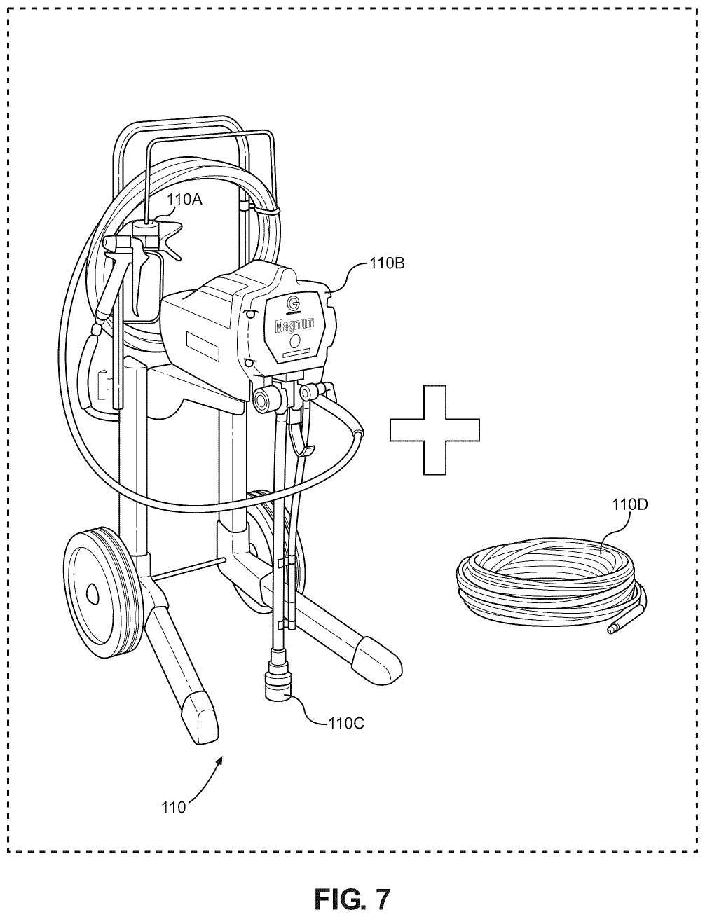

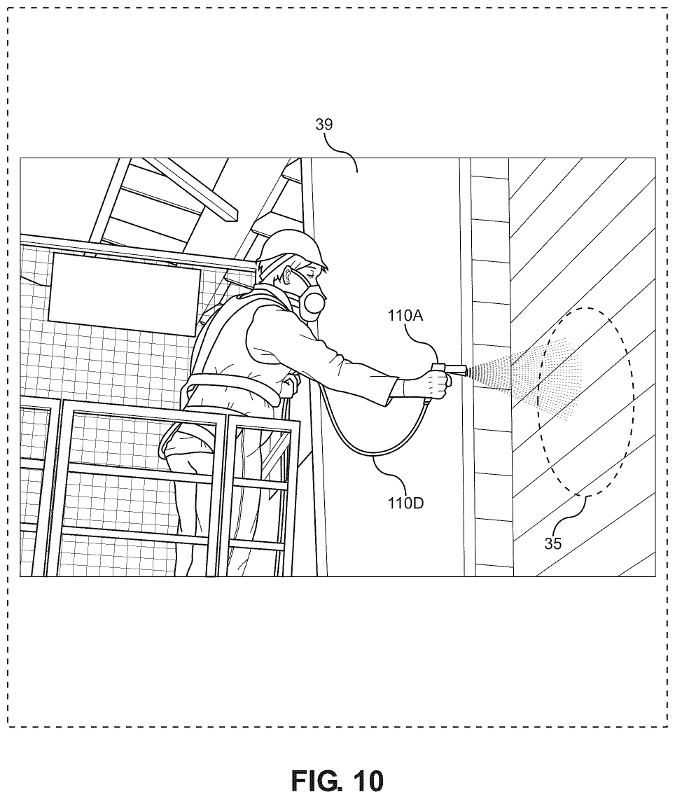

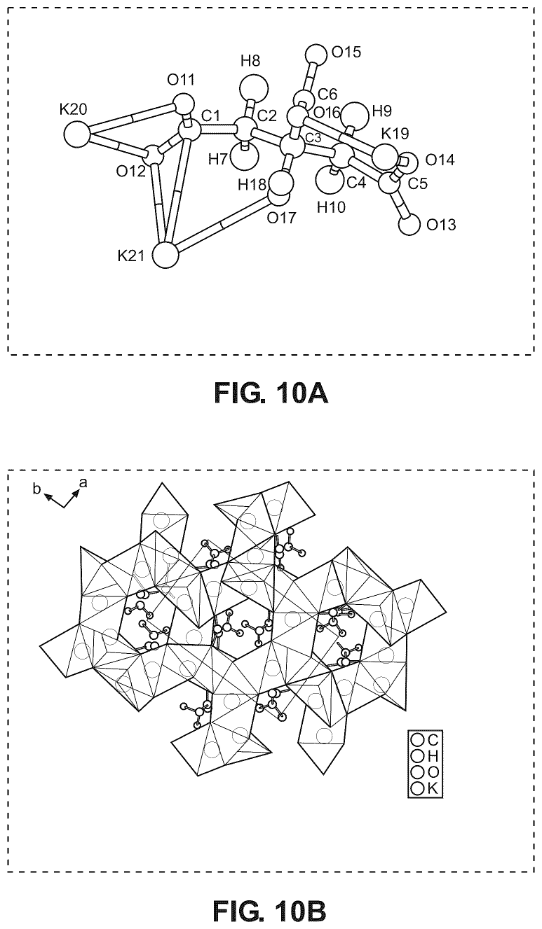

FIG. 7 shows a portable air-less spraying system 110 having an electric motor and pump for air-less spraying of environmentally-clean liquid fire inhibitor 35 on exposed wood surfaces on wood frame building during the construction phase of a home building project, in the wildfire urban interface (WUI) region. The purpose of the portable air-less spraying system 110 is to spray Citrotech® MFB-31 liquid fire inhibitor 35, and form ultra-thin potassium crystalline coatings on combustible wood surfaces present on wood frame building components that are being used to construct the wood building, during the construction phase of a home building project in the wildfire urban interface (WUI) region. Schematic illustrations of such ultra-thin potassium crystalline coatings are shown in FIGS. 10A and 10B, and have many important features in addition to Class-A fire protection, including enabling CO2 and oxygen transport between our environment and living plant tissue on which it has been sprayed and allowed to air dry.

Specification of Environmentally-Clean Aqueous-Based Liquid Fire Inhibiting BioChemical Formulations, and Method of Spraying the Same onto Combustible Surfaces to Provide Class-A Fire Protection to Wood Materials at Wood Building Construction Job-Site Sites

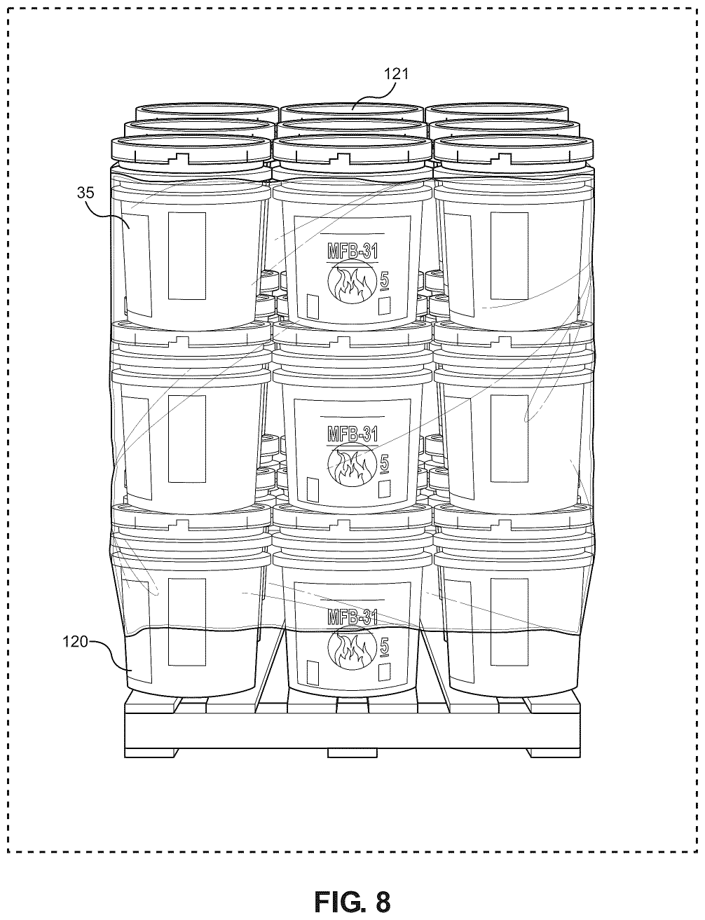

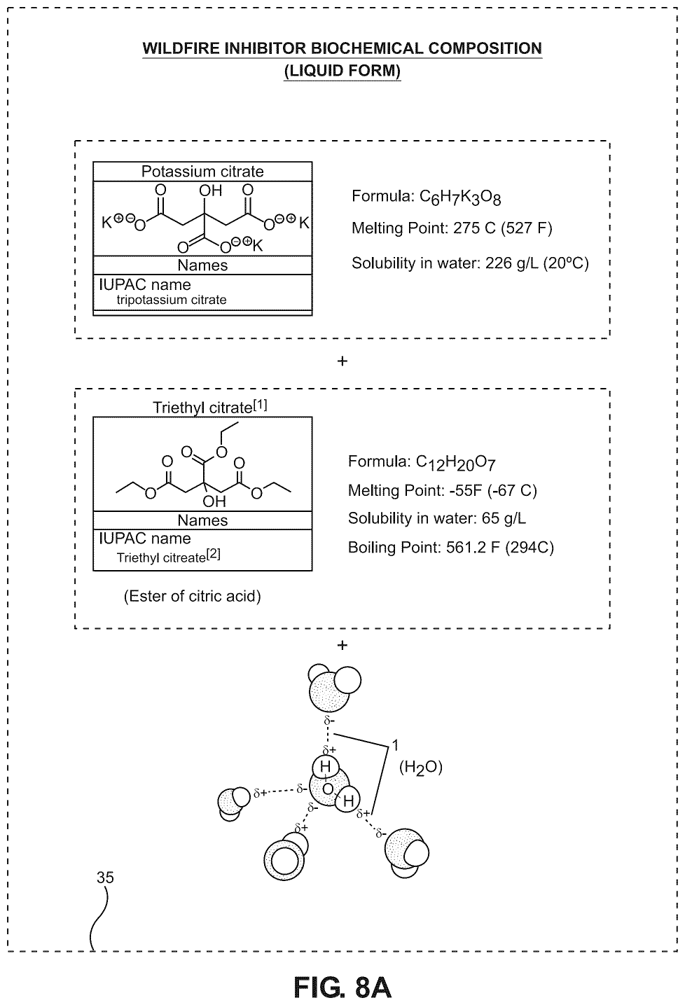

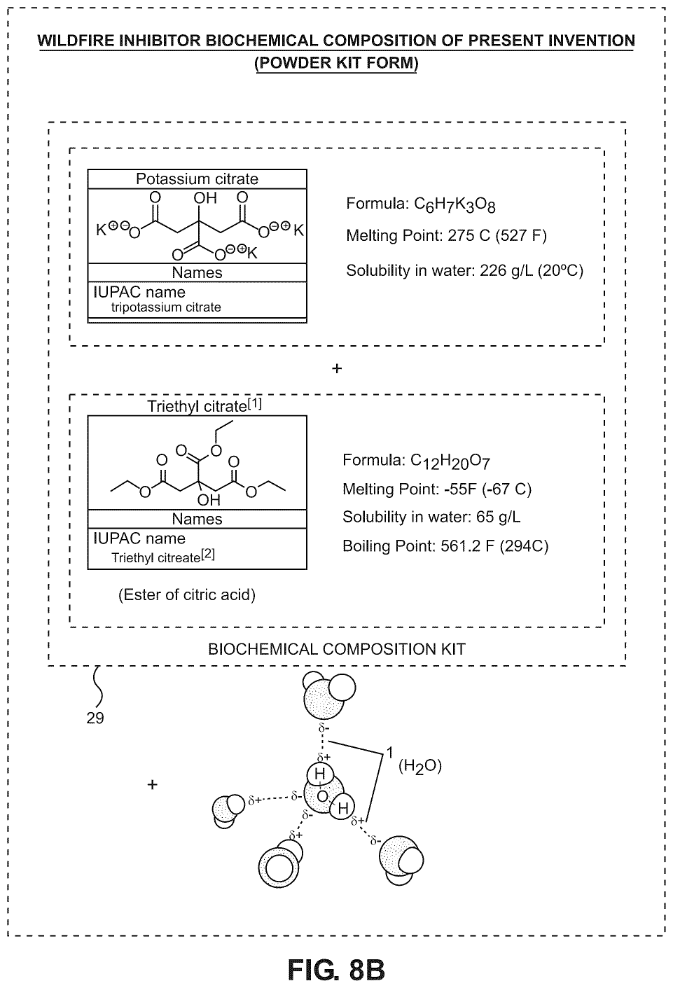

FIG. 8 shows a pallet of 5-gallon pails 121 containing environmentally-clean liquid wildfire inhibitor (i.e. CITROTECH® MFB-31 liquid fire inhibitor) 35 for providing Class A fire protection to wood materials present on a home construction job-site project in the wildfire urban interface (WUI) region. As shown, the liquid fire inhibitor (e.g. Citrotech™ MFB-31) 35 is factory-blended and certified, and specially formulated for spraying the exterior surfaces of all wood framed and/or mass-timber material surfaces of the wood-framed and/or mass-timber buildings, and provide durable Class A fire protection thereto under ASTM E-84 Extended Testing Standards.

In the case of wood-framed building projects, an air-less liquid sprayer 110 as shown in FIG. 7 is the preferred method of spray applying the liquid fire inhibitor to the wood surfaces of wood-framed building projects, to provide Class-A fire protection to the exterior wood surfaces that might become exposed to wildfire or other sources of fire during the home building project.

In the case of mass-timber wood building projects, most mass-timber construction panels will have been prefabricated in a factory environment as described in Applicant's U.S. Pat. Nos. 10,430,757 and 10,332,222, incorporated herein by reference. In such cases, the mass-timber panels will be sprayed with liquid fire inhibitor 35 within the factory environment, to provide Class-A fire protection to the mass-timber panels, and these mass-timber panels can also be sprayed again with liquid wildfire inhibitor at the home wood-building construction site for added wildfire protection.

FIG. 8A illustrates the primary components of a preferred environmentally-clean aqueous-based fire inhibiting liquid biochemical composition (i.e. CITROTECH® MFB-31 liquid fire inhibitor) 35 which consists of major amounts of tripotassium citrate (TPC) and minor amounts of triethyl citrate (TEC) formulated with water functioning as a solvent, carrier, and dispersant.

In general, the fire inhibiting liquid biochemical compositions of the present invention comprise: (a) a dispersing agent in the form of a quantity of water, for dispersing metal ions dissolved in water; (b) a fire inhibiting agent in the form of at least one alkali metal salt of a nonpolymeric saturated carboxylic acid, for providing metal ions dispersed in the water when the at least one alkali metal salt is dissolved in the water; (c) a coalescing agent in the form of an organic compound containing three carboxylic acid groups (or salt/ester derivatives thereof), such as triethyl citrate, an ester of citric acid, for dispersing and coalescing the metal ions when the fire inhibiting liquid composition is applied to a surface to be protected against fire, while water molecules in the water evaporate during drying, and the metal ions cooperate to form potassium salt crystal structure on the surface; and (d) if appropriate, at least one colorant.

Useful alkali metal salts of nonpolymeric saturated carboxylic acids for inclusion in the compositions of the present invention preferably comprise alkali metal salts of oxalic acid; alkali metal salts of gluconic acid; alkali metal salts of citric acid; and alkali metal salts of tartaric acid. Alkali metal salts of citric acid are particularly preferred, as will be further explained hereinafter.

Notably, while the efficacy of the alkali metal salts increases in the order of lithium, sodium, potassium, cesium and rubidium, the salts of sodium and salts of potassium are preferred for cost of manufacturing reasons. Potassium carboxylates are very particularly preferred, but tripotassium citrate monohydrate (TPC) is the preferred alkali metal salt for use in formulating the environmentally-clean fire inhibiting biochemical compositions of the present invention.

While it is understood that other alkali metal salts are available to practice the biochemical compositions of the present invention, it should be noted that the selection of tripotassium citrate as the preferred alkali metal salt, includes the follow considerations: (i) the atomic ratio of carbon to potassium (the metal) in the utilized alkali metal salt (i.e. tripotassium citrate); (ii) that tripotassium citrate is relatively stable at transport and operating temperatures; (iii) tripotassium citrate is expected to be fully dissociated to citrate and potassium when dissolved in water, and that the dissociation constant is not relevant for the potassium ions, while citric acid/citrate has three ionizable carboxylic acid groups, for which pKa values of 3.13, 4.76 and 6.4 at 25° C. are reliably reported the European Chemicals Agency (ECHA) handbook; and (iv) that tripotassium citrate produces low carbon dioxide levels when dissolved in water.

Tripotassium citrate is an alkali metal salt of citric acid (a weak organic acid) that has the molecular formula C₆H₈O₇. While citric acid occurs naturally in citrus fruit, in the world of biochemistry, citric acid is an intermediate in the celebrated “Citric Acid cycle, also known as the Krebs Cycle (and the Tricarboxylic Acid Cycle), which occurs in the metabolism of all aerobic organisms. The role that citric acid plays in the practice of the biochemical compositions of the present invention will be described in greater detail hereinafter.

Preferably, the water-soluble coalescing agent should have a melting point at least 32 F (0 C) or lower in temperature, and be soluble in water. Triethyl citrate (TEC) is a preferred coalescing agent when used in combination with tripotassium citrate (TPC) having excellent compatibility given that both chemical compounds are derived from citric acid.

In some applications, the use of colorants may be advantageous with or without opacifying assistants, to the fire inhibiting biochemical liquid compositions of the present invention. Opacifying assistants make the fire-retarding biochemical composition cloudy and prevent any interaction between the color of the added colorant used and the background color.

The concentration of the dye in the fire-retarding biochemical composition is preferably in the range from 0.005% to 10% by weight, more preferably in the range from 0.01% to 5% by weight and most preferably in the range from 0.015% to 2% by weight.

Of advantage are dyes, food dyes for example, which fade as the fire-retarding composition dries and gradually decompose or are otherwise easily removable, for example by flushing with water.

The fire inhibiting liquid biochemical compositions of the present invention are producible and prepared by mixing the components in specified amounts with water to produce the fire inhibiting composition. The order of mixing is discretionary. It is advantageous to produce aqueous preparations by mixing the components other than water, into water.

### Specification of Preferred Embodiments of the Environmentally-Clean Liquid Fire Inhibiting Biochemical Compositions of Matter for Use at Home Building Construction Job-Site

In the preferred embodiment of the fire inhibiting liquid biochemical composition of the present invention, the components are realized as follows: (a) the fire inhibiting agent is realized in the form of an alkali metal salt of a nonpolymeric saturated carboxylic acid, specifically, tripotassium citrate, for providing metal potassium ions to be dissolved and dispersed in a quantity of water (supplied at the time and site of system installation at the homeowner's property); (b) a coalescing agent realized the form of an organic compound containing three carboxylic acid groups (or salt/ester derivatives thereof), specifically triethyl citrate, an ester of citric acid, for dispersing and coalescing the metal potassium ions when the fire inhibiting liquid composition is applied to a surface to be protected against fire, and while water molecules in the water evaporate during drying, the metal potassium ions cooperate to form potassium citrate salt crystal structure on the treated surface.

### Selecting Tripotassium Citrate (TCP) as a Preferred Fire Inhibiting Agent for Use in the Fire Inhibiting Biochemical Compositions of the Present Invention

In the preferred embodiments of the present invention, tripotassium citrate (TPC) is selected as active fire inhibiting chemical component in fire inhibiting biochemical composition. In dry form, TPC is known as tripotassium citrate monohydrate (C₆H₅K₃O₇·H₂O) which is the common tribasic potassium salt of citric acid, also known as potassium citrate. It is produced by complete neutralization of citric acid with a high purity potassium source, and subsequent crystallization. Tripotassium citrate occurs as transparent crystals or a white, granular powder. It is an odorless substance with a cooling, salty taste. It is slightly deliquescent when exposed to moist air, freely soluble in water and almost insoluble in ethanol (96%).

Tripotassium citrate is a non-toxic, slightly alkaline salt with low reactivity. It is chemically stable if stored at ambient temperatures. In its monohydrate form, TPC is very hygroscopic and must be protected from exposure to humidity. Care should be taken not to expose tripotassium citrate monohydrate to high pressure during transport and storage as this may result in caking. Tripotassium citrate monohydrate is considered “GRAS” (Generally Recognized As Safe) by the United States Food and Drug Administration without restriction as to the quantity of use within good manufacturing practice. CAS Registry Number: [6100-5-6]. E-Number: E332.

Tripotassium citrate monohydrate (TPC) is a non-toxic, slightly alkaline salt with low reactivity. It is a hygroscopic and deliquescent material. It is chemically stable if stored at ambient temperatures. In its monohydrate form, it is very hygroscopic and must be protected from exposure to humidity. Its properties are:
Monohydrate
White granular powder
Cooling, salty taste profile, less bitter compared to other potassium salts
Odorless
Very soluble in water
Potassium content of 36%
Slightly alkaline salt with low reactivity
Hygroscopic
Chemically and microbiologically stable
Fully biodegradable
Allergen and GMO free

Jungbunzlauer (JBL), a leading Swiss manufacturer of biochemicals, manufactures and distributes TPC for food-grade, healthcare, pharmaceutical and over the counter (OTC) applications around the world. As disclosed in JBL's product documents, TPC is an organic mineral salt which is so safe to use around children and adults alike. Food scientists worldwide have added TPC to (i) baby/infant formula powder to improve the taste profile, (ii) pharmaceuticals/OTC products as a potassium source, and (iii) soft drinks as a soluble buffering salt for sodium-free pH control in beverages, improving stability of beverages during processing, heat treatment and storage.

Selecting Triethyl Citrate (TEC) as a Preferred Coalescing Agent with Surface Tension Reducing and Surfactant Properties for Use in the Fire Inhibiting Biochemical Compositions of the Present Invention

In the preferred illustrative embodiments of the present invention, the coalescing agent used in the fire inhibitor biochemical compositions of the present invention is realized as a food-grade additive component, namely, triethyl citrate (TEC) which functions as a coalescing agent with surface tension reducing properties and surfactant properties as well. Triethyl citrate belongs to the family of tricarboxylic acids (TCAs) and derivatives, organic compounds containing three carboxylic acid groups (or salt/ester derivatives thereof).

In the aqueous-based fire inhibiting liquid composition, the coalescing agent functions as temporary dispersing agent for dispersing the metal ions dissolved and disassociated in aqueous solution. As water molecules evaporate from a coating of the biochemical composition, typically spray/atomized applied to a surface to be protected from fire, the coalescing agent allows the formation of thin metal (e.g. potassium citrate) salt crystal structure/films at ambient response temperature conditions of coating application. The coalescent agent promotes rapid potassium salt crystalline structure/coating formation on combustible surfaces to be protected against wildfire, and have a hardness evolution that promotes durability against rain and ambient moisture, while apparently allowing vital oxygen and CO2 gas transport to occur, without causing detrimental effects to the vitality of living plant tissue surfaces sought to be protected against wildfire.

A relatively minor quantity of triethyl citrate (TEC) liquid is blended with a major quantity of TCP powder in specific quantities by weight and dissolved in a major quantity of water to produce a clear, completely-dissolved liquid biochemical formulation consisting of food-grade biochemicals mixed with water and having highly effective fire inhibiting properties, as proven by testing. The resulting aqueous biochemical solution remains stable without the formation of solids at expected operating temperatures (e.g. 34 F to 120 F).

Jungbunzlauer (JBL) also manufactures and distributes its CITROFOL® A1 branded bio-based citrate esters for food-grade, healthcare, pharmaceutical and over the counter (OTC) applications around the world. CITROFOL® A1 triethyl citrate (TEC) esters have an excellent toxicological and eco-toxicological profile, and provide good versatility and compatibility with the tripotassium citrate (TPC) component of the biochemical compositions of the present invention. CITROFOL® A1 branded citrate esters are particularly characterized by highly efficient solvation, low migration, and non-VOC (volatile organic compound) attributes. As an ester of citric acid, triethyl citrate is a colorless, odorless liquid which historically has found use as a food additive (E number E1505) to stabilize foams, especially as a whipping aid for egg whites.

Broadly described, the fire inhibiting biochemical liquid coatings of the present invention consist of an aqueous dispersion medium such as water which carries dissolved metal salt cations that eventually form a thin metal salt crystalline structure layer on the surface substrate to be protected from ignition of fire. The aqueous dispersion medium may be an organic solvent, although the preferred option is water when practicing the present invention. After the application of a coating onto the combustible surface to be protected against fire ignition and flame spread and smoke development, the aqueous dispersion medium evaporates, causing the metal salt (i.e. potassium salt) cations to draw together. When these metal salt particles come into contact, the coalescing agent, triethyl citrate, takes effect, uniformly dispersing the same while reducing liquid surface tension, and giving rise to the formation of a relatively homogeneous metal salt crystalline structure layer over the surface. In practice, this interaction is more complex and is influenced by various factors, in particular, the molecular interaction of the potassium salt cations and the coalescing agent, triethyl citrate, as the water molecules are evaporating during the drying process.

While offering some surface tension reducing effects, the main function of the coalescing agent in the biochemical composition of the present invention is to ensure a relatively uniform and optimal formation of the salt crystalline structure layers on the combustible surfaces to be protected, as well as desired mechanical performance (e.g. offering scrub resistance and crystal coating hardness) and aesthetic values (e.g. gloss and haze effects).

The fact that CITROFOL® A1 triethyl citrate (TEC) esters are bio-based, odorless, biodegradable, and label-free, represents a great advantage over most other coalescing agents, and fully satisfies the toxicological and environmental safety requirements desired when practicing the biochemical compositions of the present invention.

In the preferred embodiments of the present invention, the use of CITROFOL® AI triethyl citrate (TEC) esters with tripotassium citrate monohydrate (TPC) dissolved in water as a dispersion solvent, produce fire inhibiting biochemical formulations that demonstrate excellent adhesion, gloss, and hardness properties. The chemical and colloidal nature of potassium salt ions (which are mineral salt dispersions) present in TPC dissolved in water, is highly compatible with the CITROFOL® A1 triethyl citrate (TEC) ester used as the coalescing agent in the preferred embodiments of the present invention. Also, CITROFOL® A1 triethyl citrate esters are REACH registered and are safe, if not ideal, for use in environmentally sensitive products such as fire and wildfire inhibitors which must not adversely impact human, animal and plant life, ecological systems, or the natural environment.

### Specification of Preferred Formulations for the Fire Inhibiting Biochemical Compositions of Matter According to the Present Invention

### Example #1: Liquid-Based Fire Inhibiting Biochemical Composition (Made at Factory)

The preferred embodiment shown in FIG. 8A illustrates the primary components of a first environmentally-clean aqueous-based fire inhibiting liquid biochemical composition of the present invention, which are mixed at the factory under strict quality control, and consist of tripotassium citrate (TPC) and triethyl citrate (TEC) formulated with water functioning as a solvent, carrier, and dispersant in the biochemical composition.

Example 1: A fire-extinguishing and/or fire-retarding biochemical composition was produced by stirring the components into water. The composition comprising: 0.05 pounds by weight of triethyl citrate as coalescing agent, (20.3 milliliters by volume); 5.2 pounds by weight of tripotassium citrate (64 fluid ounces by volume); and 4.4 pounds by weight of water (64 fluid ounces by volume), to produce a resultant solution of total weight of 9.61 pounds having 128 ounces or 1 gallon of volume. A primary disadvantage of this embodiment of the invention is the cost of the finished goods, weighing in at least 8.4 lbs. per gallon of water used, which contributes significantly to the cost of shipping.

### Example #2: Dry-Powder Fire Inhibiting Biochemical Composition (Made on Site)

In an alternative embodiment, shown in FIG. 8B, the primary components of a fire inhibiting biochemical composition kit consist of dry tripotassium citrate (TPC) and triethyl citrate (TEC) components for mixing with a predetermined quantity of water functioning as a solvent, carrier, and dispersant, to make up a predetermined quantity of environmentally-clean liquid fire inhibiting biochemical composition for proactively protecting wood products.

Example 2: Schematically Illustrated in FIG. 8B: A fire-extinguishing and/or fire-retarding biochemical composition was produced by blending the following components, in amounts proportional to the formulation comprising: 0.05 pounds by weight of triethyl citrate as coalescing agent, (20.3 milliliters by volume); 5.2 pounds by weight of tripotassium citrate (64 fluid ounces by volume); packaging the blended components together in a container or package for mixing with 4.4 pounds by weight of water (64 fluid ounces by volume), to produce a resultant solution of total weight of 9.61 pounds having 128 ounces or 1 gallon of volume.

A primary advantage of this dry powder embodiment of the present invention is achieving significantly reduced shipping costs for the finished goods, because of the significant reduction in weight of finished goods achieved by eliminating the weight of water from the formulation prior to shipping. Specifically, a reduction in weight of 416 lbs. is for the 50-gallon storage tank, and a reduction in weight of 833 lbs. is achieved for a 100-gallon storage tank, because each US gallon of water weighs approximately 8.33 lbs.

In the preferred embodiment, the WFDS kit of the present invention is equipped with fire inhibitor storage tanks having either a 50 or 100 gallon capacity, to support different size property sizes, and will be shipped from the factory containing all Citrotech® fire inhibitor constituents based on weights and measures required to support ASTM fire testing accreditations along with UL GreenGuard Gold, LENS, California Aquatic Testing, EPA Safer Choice Labeling, and meeting Prop 65, but only when the proper quantity of water has been added (indicated by the water fill line) and blended properly based on manufacturer's instructions for filling the storage tank.

### Preferred Weights Percentages of the Components of the Fire Inhibiting Biochemical Formulation of the Present Invention

In the biochemical compositions of the present invention The ratio of the ester of citrate (e.g. triethyl citrate) to the alkali metal salt of a nonpolymeric carboxylic acid (e.g. tripotassium citrate) may be major amount between 1:100: to 1:1000 and is typically in the range from 1:1 to 1:100, preferably in the range from 1:2 to 1:50, more preferably in the range from 1:4 to 1:25 and most preferably in the range from 1:8 to 1:15.

A preferred biochemical composition according to the present invention comprises: a major amount from 1% to 65% by weight, preferably from 20% to 50% by weight and more preferably from 30% to 55% by weight, of at least one alkali metal salt of a nonpolymeric saturated carboxylic acid (e.g. tripotassium citrate monohydrate or TPC); and minor amount from 0.08% to 5% by weight, preferably from 0.5% to 2% by weight and more preferably from 0.1% to 1.0% by weight, of triethyl citrate (an ester of citrate acid); wherein the sum by % weight of the components (a) and (b) should not exceed 100% by weight.

In a preferred embodiment, the fire inhibiting composition further comprises water. The water content is present in a major amount and is typically not less than 30% by weight, preferably not less than 40% by weight, more preferably not less than 50% by weight and most preferably not less than 60% by weight and preferably not more than 60% by weight and more preferably not more than 70% by weight, all based on the fire inhibiting biochemical composition.

The viscosity of the aqueous preparation is preferably at least 5 [mPas] (millipascal-seconds, in SI units, defined as the internal friction of a liquid to the application of pressure or shearing stress determined using a rotary viscometer), and preferably not more than 50 [mPas], or 50 centipois) [cps], for most applications.

### Physical Examination and Fire-Performance Testing of Thin Potassium Salt Crystalline Coatings Formed Using the Biochemical Compositions and Methods and Apparatus of the Present Invention

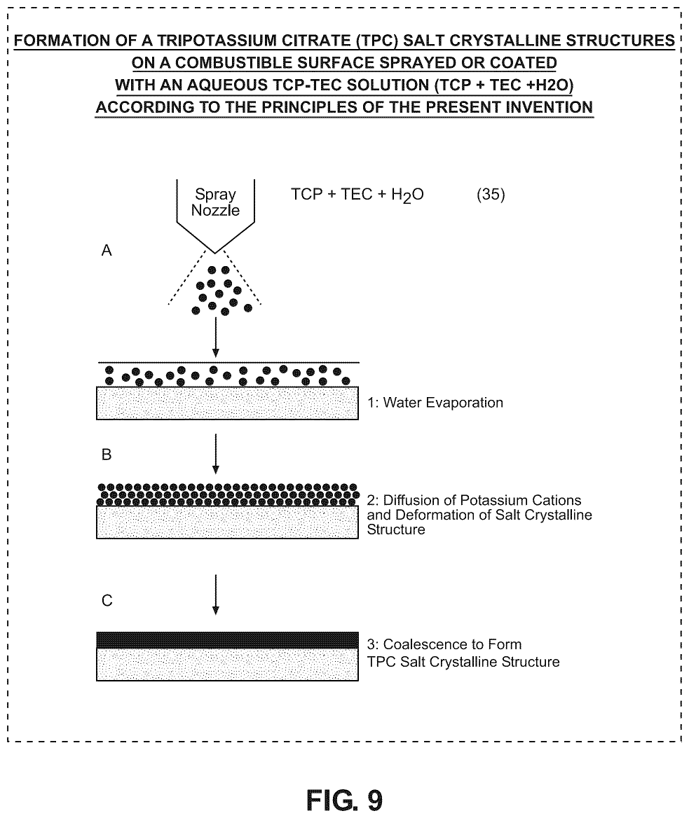

FIG. 9 illustrates the primary steps involved during the formation of tripotassium citrate (potassium) salt crystalline structure coatings on spray treated surfaces to be proactively protected against ignition and flame spread of incident fire.

At Step A, a spray nozzle is used to spray a liquid coating of a biochemical composition of the present invention, and once applied, the water molecules being to evaporate at a rate determined by ambient temperature and wind currents, if any. When the minimum film formation temperature (MFT) is reached for the biochemical composition, the potassium cations can inter diffuse within the triethyl citrate (TEC) coalescent agent and water molecule matrix that is supported on the surface that has been sprayed and to be proactively treated with fire inhibiting properties by virtue of a thin film deposition of tripotassium salt crystalline structure, modeled and illustrated in FIGS. 7B and 7C.

At Step B, potassium cations diffuse and the TPC crystalline structure deforms. During the coalescence of potassium cations, interparticle potassium cation diffusion (PCD) occurs within the TEC coalescing agent to produce a semi-homogenous tripotassium citrate salt crystalline structure.

At Step C, coalescence occurs to form the TPC salt crystalline structure. The mechanical properties of tripotassium citrate crystalline structures are highly dependent on the extent of PCD within the TEC coalescent agent.

Upon complete evaporation of water molecules from the biochemical liquid coating, the resulting fire inhibiting coating that is believed to be formed on the sprayed and dried surface comprises a thin film of tripotassium citrate salt crystalline structures formed on the structure, with substantially no water molecules present.

FIG. 10 shows a workman carrying out the method of FIG. 9 by using the airless sprayer ______ shown in FIG. 7 for spraying environmentally-clean liquid wildfire inhibitor ______ on the wood surfaces of a wood building being constructed on a job-site during the construction phase of the wood home building project, to provide Class A fire protection to the spray-treated wood surfaces.

One method of viewing the resulting potassium salt crystal structures formed upon a surface substrate to be protected against fire, as illustrated in FIG. 5A, would be by using atomic force microscope to form atomic force microscopy (AFM) images of the biochemical coatings applied in accordance with the principles of the present invention. Another method of viewing the resulting potassium salt crystal structures would be to use a scanning electron microscope to form scanning electron microscopy (SEM) images. Expectedly, using either instrument, such images of potassium salt crystal structures formed using a greater wt. % of coalescent agent (e.g. triethyl citrate dissolved in water with tripotassium citrate) will show that the coalescent agent resulted in metal salt crystal structures that are more coalesced and smoother, and demonstrating higher hardness evolution and better water repulsion, than when the potassium salt crystal structures are formed using a lower wt. % coalescent agent in the aqueous-based fire inhibiting liquid composition.

The nature and character of such tripotassium citrate salt crystalline structures are believed to be reflected in models provided in FIGS. 10A and 10B, which were first reported in 2016 in a published research paper by Alagappa Rammahon and James A. Kaduk, titled “Crystal Structure of Anhydrous Tripotassium Citrate From Laboratory X-Ray Diffraction Data and DFT Comparison” cited in ACTA CRYSTL (2016) Vol. E72, Pages 1159-1162, and published by Crystallographic Communications.

To determine and confirm that the fire inhibiting liquid compositions of the present invention produce potassium citrate salt crystalline structures on treated surfaces that have attained certain standards of fire inhibiting protection, it is necessary to test such treated surface specimens according to specific fire protection standards. In the USA, ASTM E84 Flame Spread and Smoke Development Testing can be used to test how well surfaces made of wood, cellulose and other combustible materials perform during E84 testing, and then compared against industry benchmarks. The environmentally-clean fire inhibiting chemical liquid composition disclosed herein is currently being tested according to ASTM E84 testing standards and procedures, and these ASTM tests have shown that fire-protected surfaces made of Douglas Fir (DF) demonstrate Flame Spread Indices and Smoke Development Index to qualify for Class-A fire protected certification, when treated by the fire inhibiting biochemical composition of the present invention disclosed and taught herein.

Specification of the Method of Defending Wood Home Construction Projects, their Job-Sites and Completed Homes and Surrounding Properties from Wildfire Storms According to the Principles of the Present Invention

The method of home construction wildfire defense protection according to the present invention involves a novel method of constructing, commissioning, and decommissioning two different and independent sprinkler-based home wildfire defense systems, at different phases of the home building project.

At beginning of the construction phase of the home building project, a first automated sprinkler-based wildfire defense system 50 is installed and commissioned for operation on the construction job-site using the wildfire defense system trailer of the present invention to provide a liquid fire inhibitor supply, sprinkler pumping operations, and automated controls and monitoring during the entire construction phase, thereby providing a proactive measure of defense against hot flying embers entering the constructed home and its surrounding property during a wildfire storm occurring during construction.

This first commissioned automated sprinkler-based wildfire defense system 50 will continue in operation all during the home building construction phase, and will only be decommissioned from operation, and removed from the premises (including the job-site wildfire defense system trailer being towed away to a new location and old sprinklers and piping removed from the property), when construction of the wood home building project is totally completed and the wood home building is ready for occupation.

Once the wood home building project is completed and ready for occupation, the first automated sprinkler-based wildfire defense system 50 is decommissioned and removed from the premises (including the wildfire defense trailer being towed away to a new location and old sprinklers and piping removed from the premises).

At the same time when the first system is decommissioned, a second permanently-installed automated sprinkler-based wildfire defense system 80 will be completely installed within the new home construction, independent from the first system, and ready for commissioning to provide a new proactive measure of defense against hot flying embers entering the constructed home and its surrounding property during a wildfire storm occurring after construction has been completed, thereby protecting all wood and combustible surfaces on the home and surrounding property, and preventing fire ignition and flame spread until the wildfire storm passes through the WUI region.

By virtue of the method of the present invention, it is now possible to significantly reduce the risk of wood home building construction projects occurring within a wildfire urban interface (WUI) region, and better support the underwriting of home construction and ownership insurance policies within such regions.

Specification of Trailer-Mounted System and Kit Components for Installing Automated Sprinkler-Based Wildfire Defense System about Home Construction Site Before the Starting of the Construction Phase of the Home Building Project in the Wildfire Urban Interface (WUI) Region

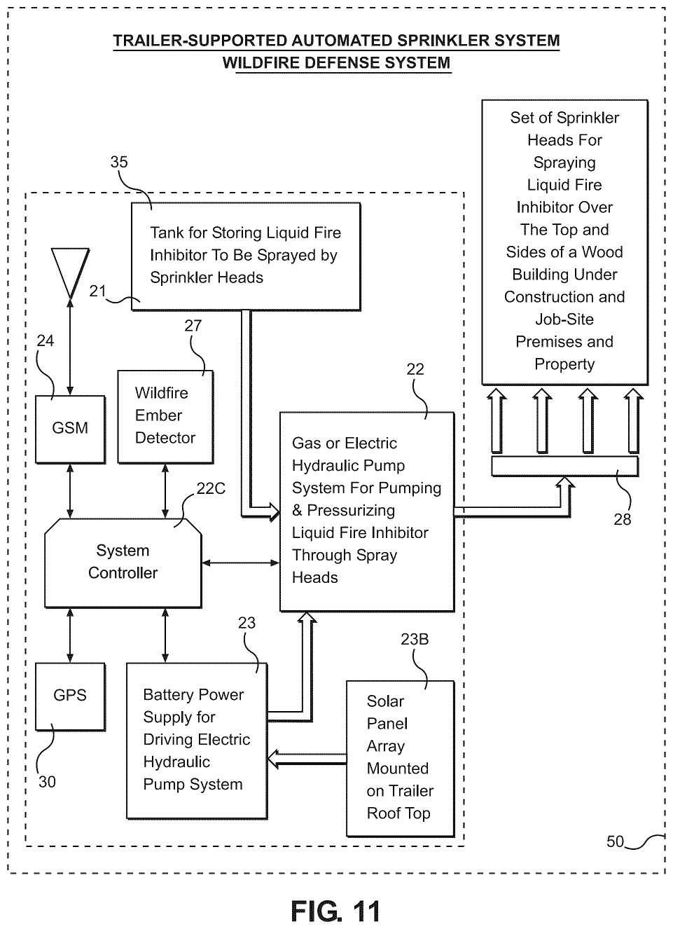

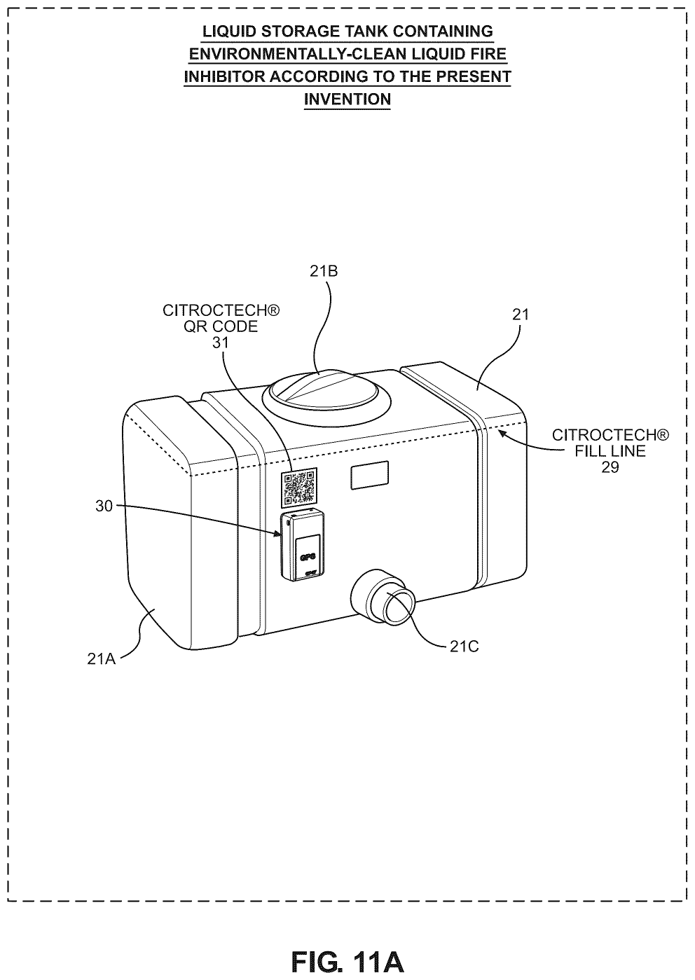

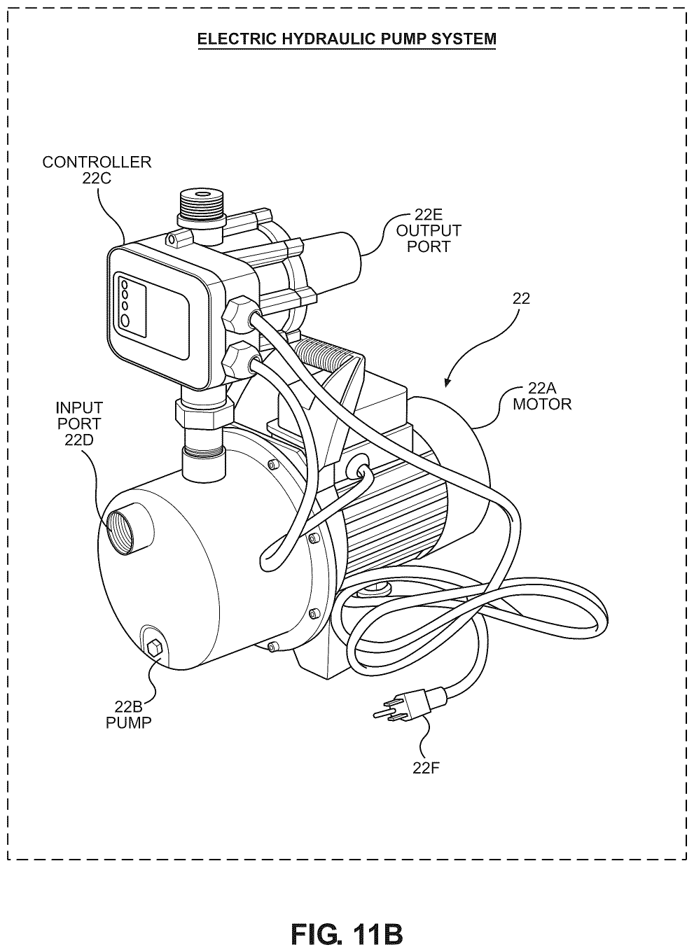

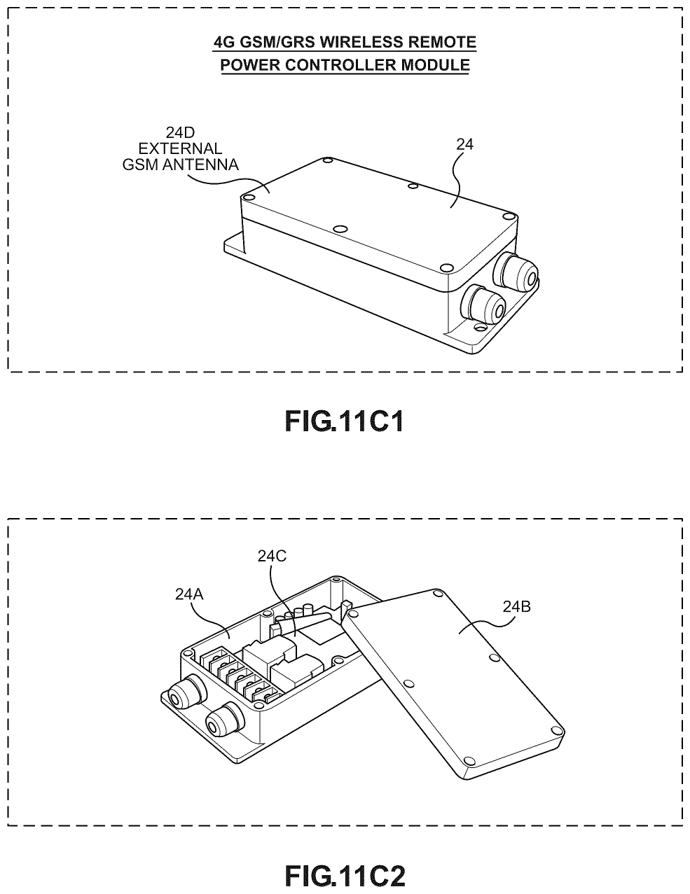

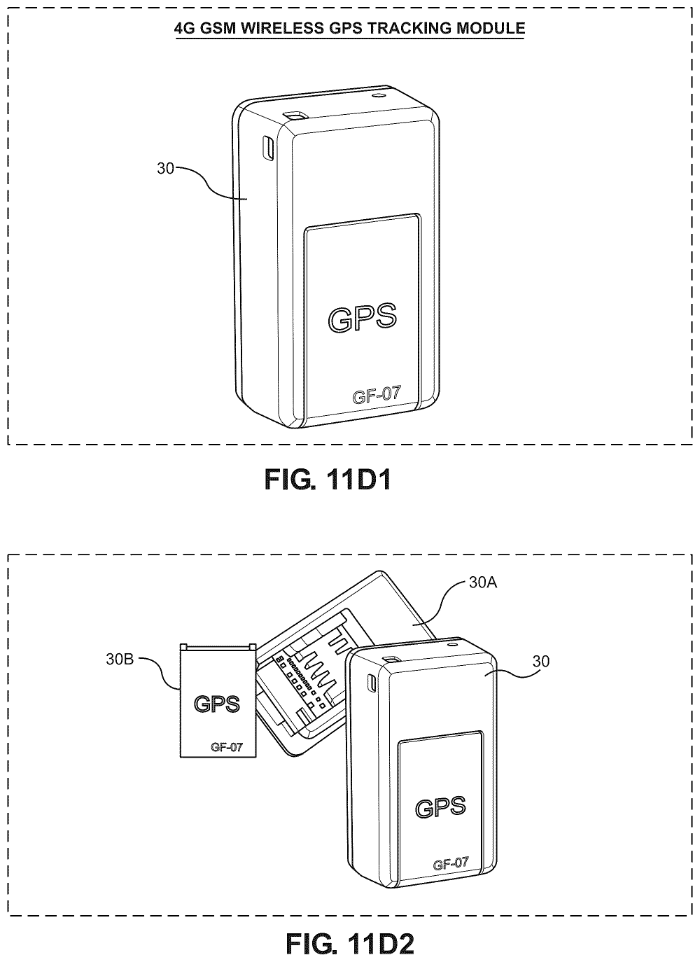

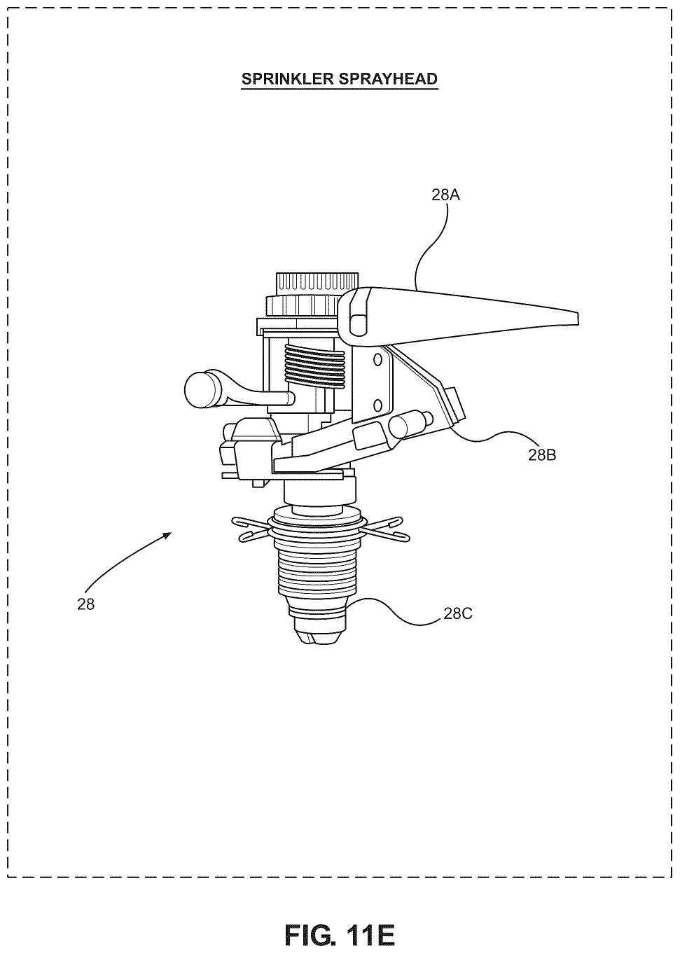

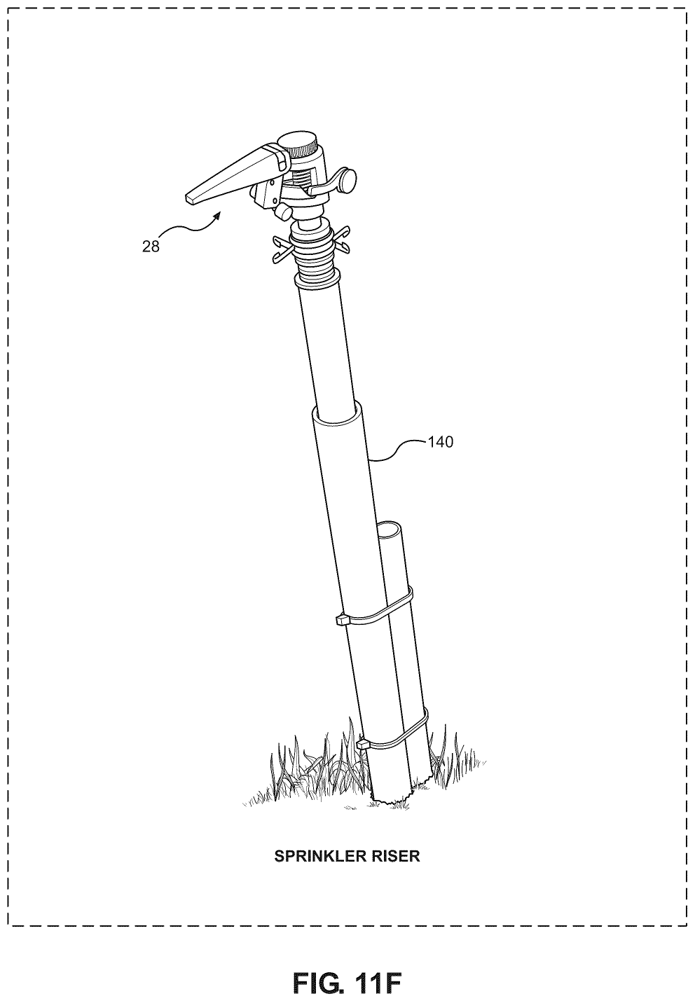

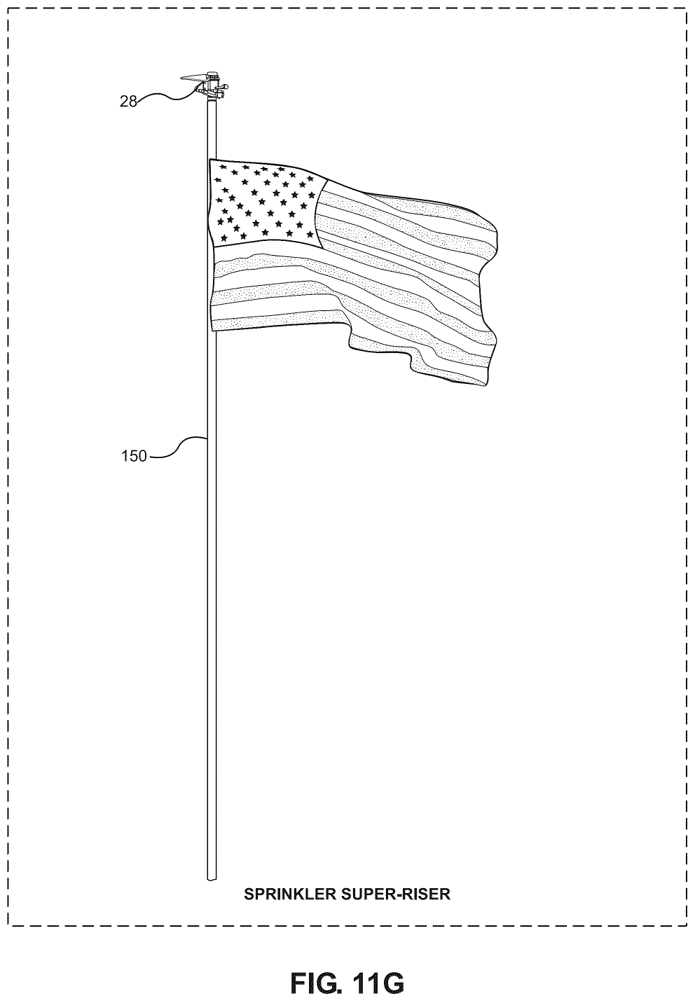

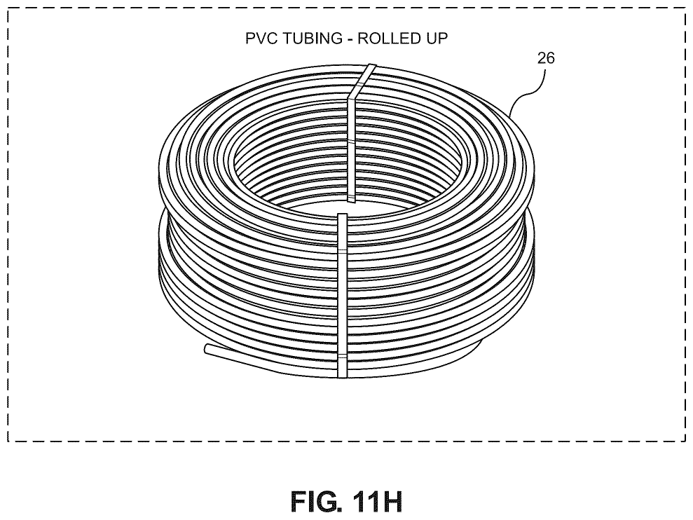

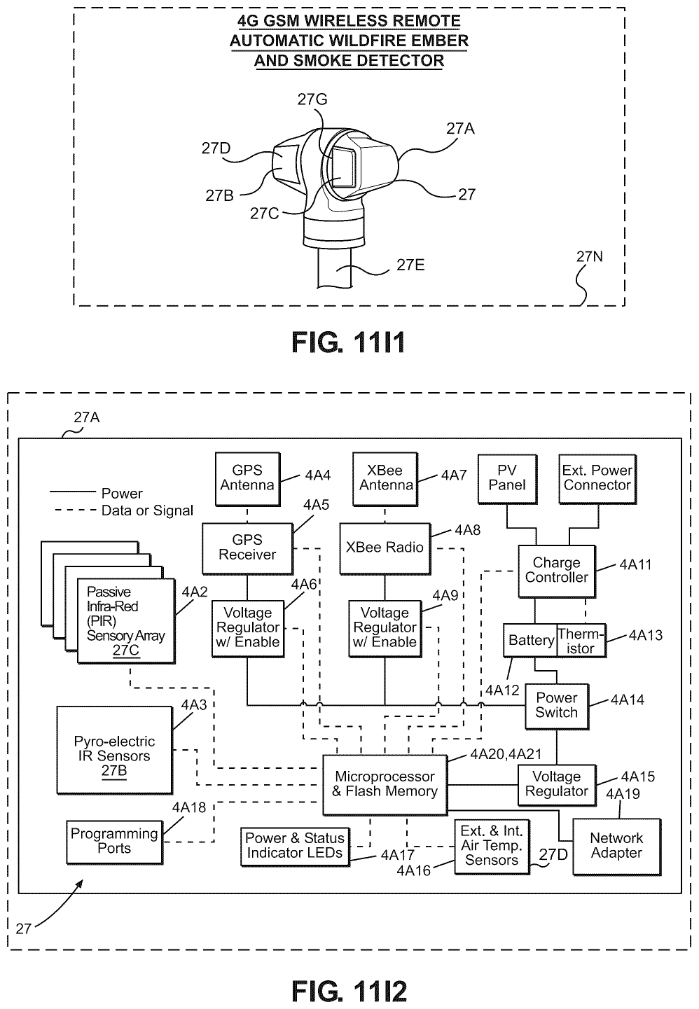

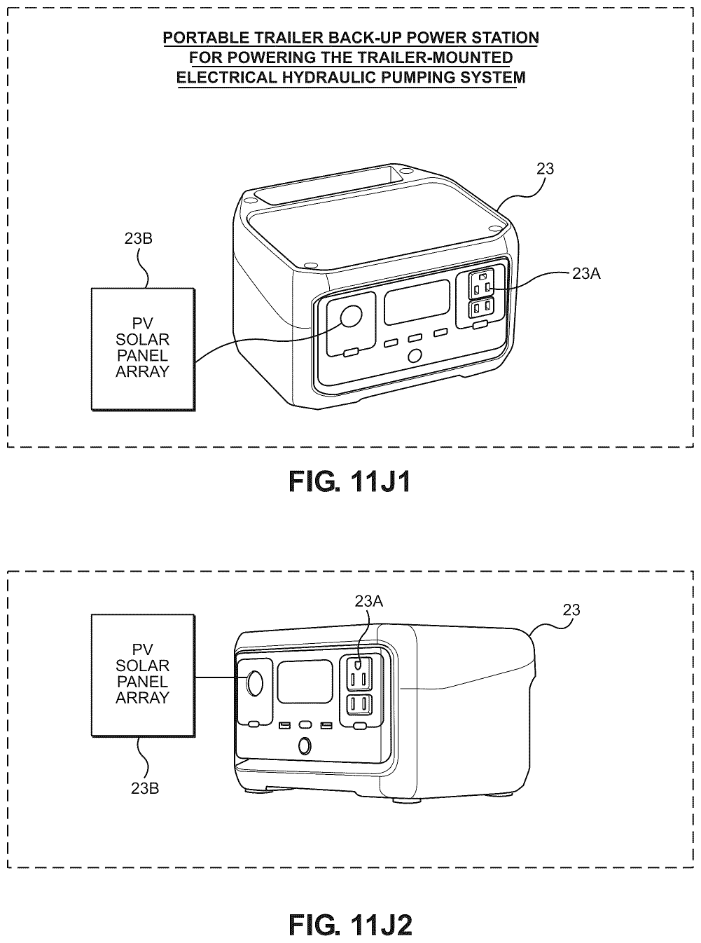

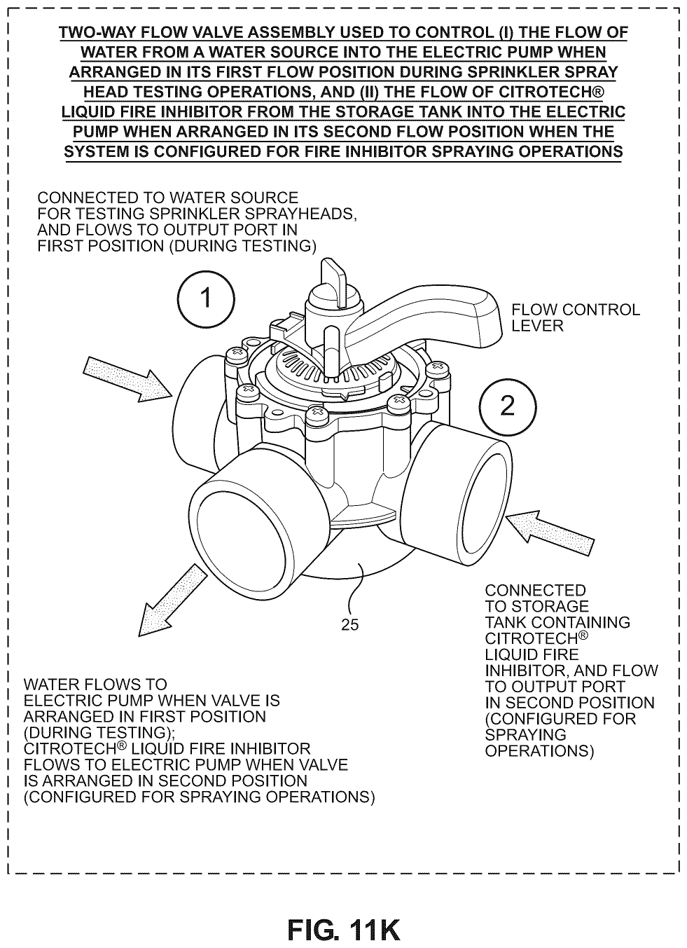

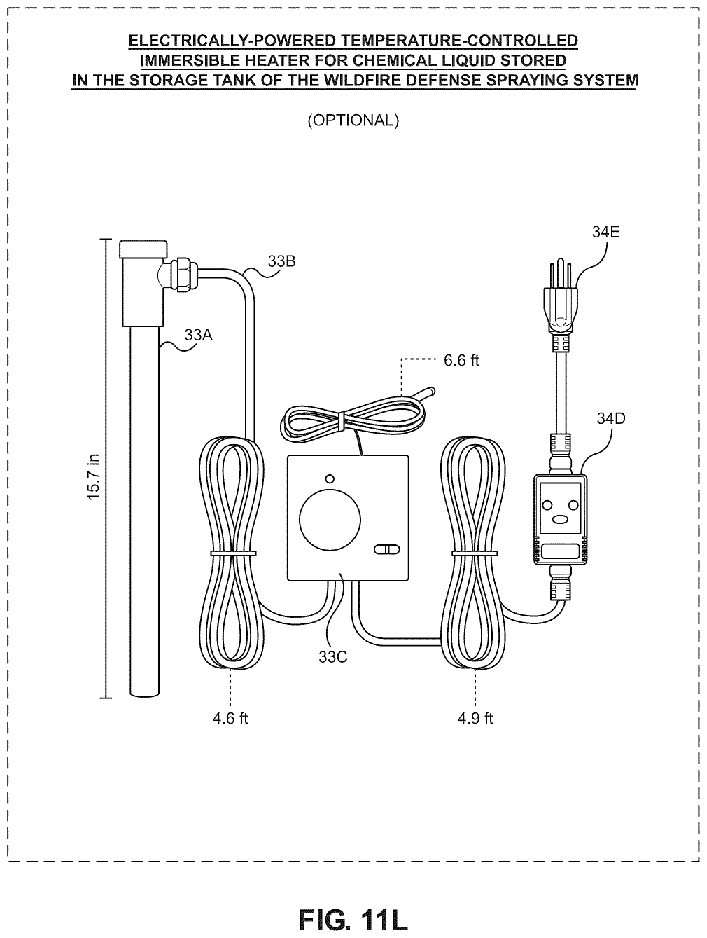

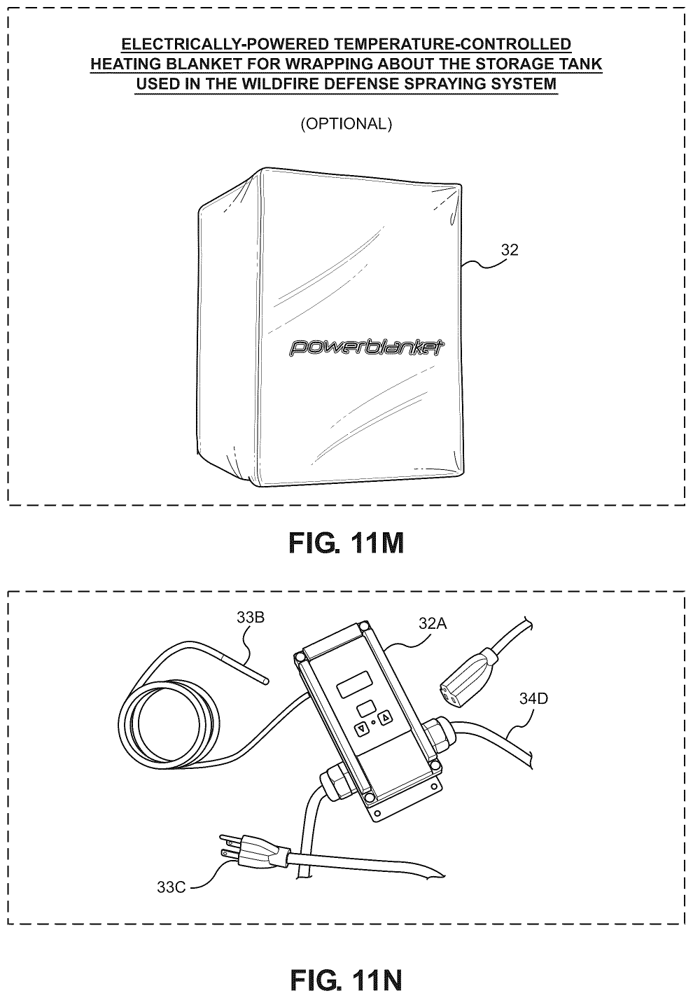

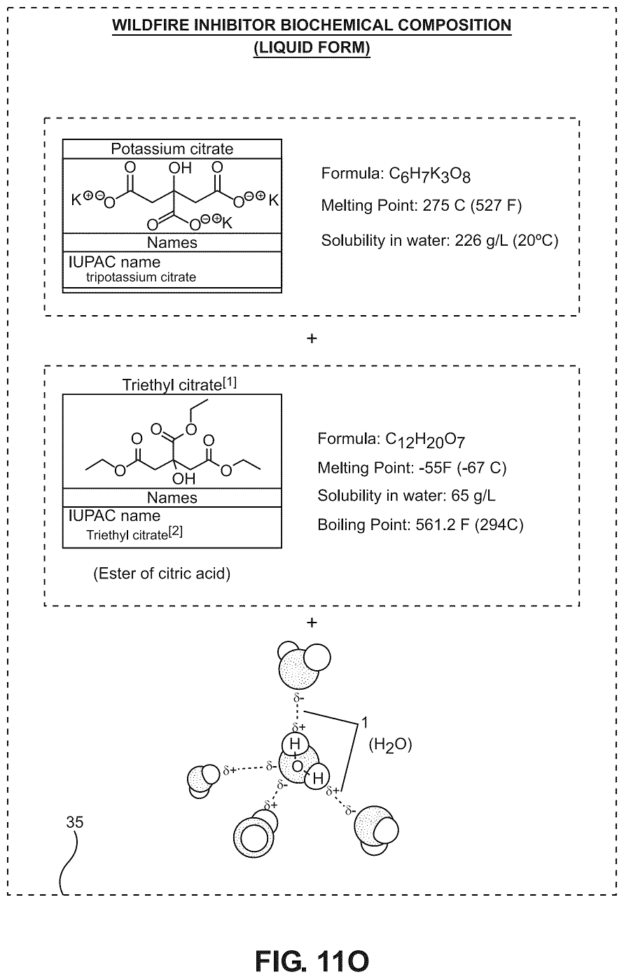

FIG. 11 shows a high-level generalized model for the trailer-mounted system and kit of components 20 especially adapted for use in constructing, installing and commissioning an automated sprinkler-based wildfire defense system 50 installed about a home building construction job-site before starting of the construction phase of a home building project located in a wildfire urban interface (WUI) region. The purpose of this first type of automated sprinkler-based wildfire defense system 50 is to provide a proactive measure of defense against hot flying embers entering the construction job-site property during a wildfire storm, protecting all wood and combustible surfaces on the home construction job-site and prevent fire ignition and flame spread until the wildfire storm passes through the WUI region.

FIG. 11 shows a wireless remotely-activatable sprinkler-based wildfire defense fire inhibitor spraying system 50 supported primarily on the wildfire defense system trailer 90 shown in FIGS. 5A and 5B, and partially on the home construction job-site where sprinkler heads 28 are mounted for spraying CITROTECH® MFB-31 liquid fire inhibitor 35 all over the combustible surfaces of the construction job-site, surrounding perimeter areas, as well wood framed and/or mass-timber buildings being constructed thereon during the construction phase of the project.

As shown, the remotely-activatable sprinkler-based wildfire defense fire inhibitor spraying system 50 comprises a number of system components, namely: (i) a wildfire ember detection module 2 shown in FIGS. 11E1 and 11E2 for mounting on the top of a building, pole or tree to automatically detect the presence of a wildfire (i.e. via automated wildfire ember and/or smoke detection) well before its arrival many miles away, and sensing a SMS-spray-triggering signal 40 to the wireless remotely-activatable sprinkler-based wildfire defense fire inhibitor spraying system of the present invention 20 operate the automated spraying of Citrotech® liquid fire inhibitor 35 all over the property to be protected from fire ignition and/or flame spread by an incident wildfire; (ii) a plastic, fiberglass or metallic storage tank 21 shown in FIG. 11A supported within the wildfire defense trailer 90, and having a 50 or 100 US gallon liquid storage capacity, for storage of liquid fire inhibitor formulation 29 (e.g. CITROTECH® MFB-31 fire inhibitor); (iii) a 4G GSM GPS sensor 30 shown in FIGS. 11D1 and 11D2 for mounting to the storage tank 21 for monitoring the GPS location thereof using 4G GSM digital cellular communications (e.g. AT&T); (iv) an electric-motor (120V/20-30 A) fluid hydraulic pump 22 shown in FIG. 11A, mounted within the wildfire defense system trailer 90, and operably connected to the storage tank 21 and a supply of pressurized water at installation location via a valve assembly 25 having first and second (flow directing) positions; (v) a Lithium-battery backup power supply system (e.g. EcoFlow® River 2 Pro Portable Power Station-768 Wh capacity and 800 W output) 23 shown in FIGS. 11I1 and 11I2, mounted within the wildfire defense system trailer 90, and provided with photovoltaic (PV) recharging panel for recharging the lithium-ion battery 23 while collecting sunlight with the PV solar panel as solar conditions allow, and 120 V line input plug for connection to a local source of electrical power, for supplying electrical power to the electric pump 22; (vi) at least 4 to 6 sprinkler spray heads 28 shown in FIGS. 11E, 11F AND 11G provided with roof/pole mounting brackets of varying heights, for spraying the Citrotech® liquid fire inhibitor 35 in the storage tank, all over the target property 36 at the home construction job-site 160, where needed for proactive wildfire protection; heat-resistant PVC or PET piping 26 shown in FIG. 11H, and mounted outside of the wildfire defense trailer and on job-site property and premises, for forming the necessary fluid pumping circuits passing through the electric pump 22 to operate the sprinkler sprayheads 28 under adequate hydraulic pressure during spraying operations, and thus support sufficient flow rates of Citrotech® fire inhibiting chemical liquid 35, determined in a manner well known in the fluid hydraulic arts; (vii) a 4G GSM/GPRS transceiver and the remote power control switch (e.g. 4G GSM Dual Channel Remote Switch Controller with SMS Command Remote Board with Relay Output and GSM CTL-4G Relay Control Box by Shanghai Wafer Microelectronics Co., Ltd) 24 shown in FIGS. 11C1 and 11C2 for remotely controlling electrical power supplied to the electric-motor hydraulic pump 22 via the 4G GSM remote control power switch 24, automatically triggered when receiving an SMS trigger message/signal 40 from the smartphone 11 operated by a homeowner and/or authorized contractor or other personnel; an optional electrically-powered temperature-controlled thermal blanket 30 for surrounding the storage tank 21, within the wildfire defense trailer 90, and associated controller 32A for maintaining the temperature of the chemical liquid in the storage tank 21 in extreme temperature climates shown in FIG. 11J, or electrically-powered temperature-controlled immersible heater 33A for maintaining the temperature of the chemical liquid in the storage tank 21 below freezing temperatures in extreme climates shown in FIGS. 11K1 and 11K2.

Preferably, the GPRS/GSM transceiver 24 shown in FIGS. 11C1 and 11C2 is suitably adapted for transmitting and receiving digital data packets using GPRS and GSM communication protocols, over the network, to support a suite of digital communication services and protocols specified herein. Also, a suite of communication services and protocols (e.g. email, SMS alert, PUSH protocol, XML, PDMS, and CALL alert) are supported by GSM for sending and receiving messages. Also, preferably, the electronic wildfire ember and smoke detection module 27 shown in FIGS. 3F1 and 3F2, supports 360 degrees of sensing and associated field of views (FOVs), and in wireless communication with the 4G GSM digital cellular communication network 10.

As shown in FIG. 11A, the storage tank 21 mounted within the wildfire defense trailer 90 stores a quantity of liquid fire inhibitor 35 to be sprayed by sprinkler heads 28 wherever deployed over the job-site and about wood building under construction on the job-site. The electrically-driven hydraulic pump system 22 is also mounted on the trailer, along with the spray pump system controller 22C, a battery power supply 23, and solar panel array 23B mounted to the trailer roof top panel. Some of the set of sprinkler heads 28 may be mounted from risers and poles supported from the wildfire defense system trailer 90, as shown, while the other sprinkler heads 28 are mounted on the job-site where needed for coverage, and all sprinkler heads 28 being operably connected to the trailer-supported pumping system 22 and the storage tank 35. As shown in FIGS. 11F and 11G, many of sprinkler heads 28 will be supported above the ground at different heights (including as high as a flag pole sprinkler in FIG. 11G) as required to spray liquid wildfire inhibitor 35 over the top and sides of a wood building under construction and job-site premises and property, to form the thin potassium microcrystalline coatings required for proactive fire protection against wildfire storms.

FIG. 11A shows the storage tank 35 used for storing environmentally-clean liquid wildfire inhibitor chemicals in the sprinkler-based wildfire defense property spraying system of the present invention, when constructed from the kit of system components shown in FIG. 11.

FIG. 11B shows the electric-motor driven fluid pump system 22 that is used in the sprinkler-based wildfire defense property spraying system, when constructed from the kit of system components shown in FIG. 11.

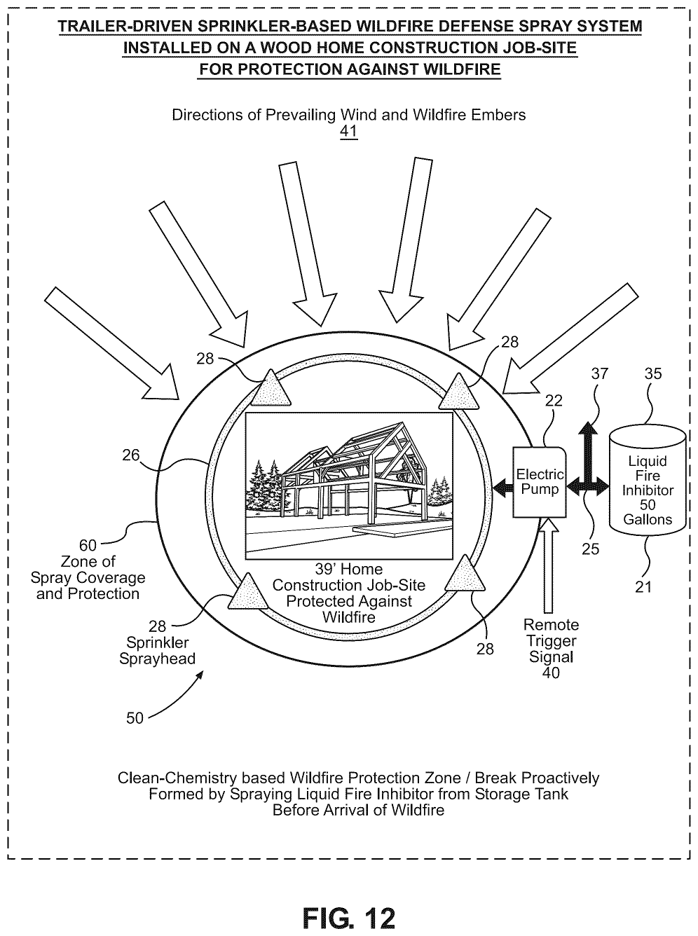

FIGS. 11C1 and 11C2 show the 4G GSM remote power control switch module 24 used, in conjunction with a smartphone and 4G GSM digital cellular communication network, to control 120V/30 A electrical power supplied to the electric pump system in the sprinkler-based wildfire defense property spraying system of the present invention 50 shown in FIG. 12.

FIGS. 11D1 and 11D2 show the 4G GSM GPS sensor 30 that is permanently factory-mounted to the fire inhibitor storage tank that is used in the sprinkler-based wildfire defense property spraying system of the present invention 50 shown in FIG. 12.

FIG. 11E shows a 360-degree (30′ range) sprinkler spray head device used in the sprinkler-based wildfire defense property spraying system of the present invention 50 shown in FIG. 11.

FIG. 11F shows a 360-degree (30′ range) sprinkler spray head device supported on a riser that is mounted in the ground and used in the sprinkler-based wildfire defense property spraying system of the present invention 50 shown in FIG. 12.

FIG. 11G is a perspective view of one 360-degree (30′ range) sprinkler spray head device supported at the top of a very tall pole structure mounted in the ground and supporting an American flag, and used in the sprinkler-based wildfire defense property spraying system of the present invention, when constructed from the kit of system components shown in FIG. 12.

FIG. 11H is a perspective view of the roll of PVC tubing for use in connecting the sprinkler heads, the electric pump system, the storage tank and 2-way valve assembly, and creating the fluid pumping circuit supporting the sprinkler-based wildfire defense property spraying system of the present invention, when constructed from the kit of system components shown in FIG. 12.

FIGS. 11I1 and 11I2 show the 4G GSM wireless remote wildfire ember and smoke detector module 27, associated with a greater wireless wildfire ember and smoke detection network. The function of the 4G GSM wireless remote wildfire ember and smoke detector module 27 and its associated wireless network is to automatically and remotely trigger the sprinkler-based wildfire defense property spraying system of the present invention 50 so that it automatically sprays its designated home construction job-site property with CITROTECH® MFB-31 liquid fire inhibitor 35 stored in the storage tank 21, to proactively protect the same with an ultra-thin potassium salt microcrystalline coating applied to all combustible surfaces prior to the actual arrival of a remotely-detected wildfire storm, moving in the direction of the wildfire protected home construction job-site and its surrounding property region.

As shown in FIGS. 11I1 and 11I2, each wireless 4G GSM GPS-tracked wildfire ember and smoke detection 27 is used as an active wildfire ember and smoke sensor in communication with the sprinkler-based wildfire defense spraying systems 50 deployed and commissioned on each home construction job-site. Each wireless GPS-tracked wildfire ember detection module 27 deployed on the 4G GSM digital cellular network 10 comprises: a fire-protective housing cover 27A; and various sensors and signal and data processing and storage components arranged and configured about a microprocessor and flash memory (i.e. control subsystem) include: one or more passive infra-red (PIR) thermal-imaging sensors connected together with suitable IR optics to project IR signal reception field of view (FOV) before the IR receiving array 27B; multiple pyrometric sensors 27C for detecting the spectral radiation of burning, organic substances such as wood, natural gas, gasoline and various plastics; a GPS antenna 27D; a GPS signal receiver; GSM antenna; GSM radio transceiver an Xbee antenna; an Xbee radio transceiver; a voltage regulator; an external power connector; a charge controller; a battery; thermistors; a power switch; external and internal temperature sensors; power and status indicator LEDs; programming ports; a digital/video camera 27G; other environment sensors adapted for collecting and assessing intelligence, in accordance with the spirit of the present invention; and mounting base 27E for mounting on a support bracket that can be affixed to a pole, tree, or building as the case may suggest or require. Alternatively, the wildfire detection module 27, and supporting wireless wildfire intelligence network, may be realized using the technical disclosure of U.S. Pat. No. 8,907,799, incorporated herein by reference. However, the present invention should not be limited by such prior art teachings.

Preferably, the optical bandwidth of the IR sensing arrays 27B used in the thermal sensors will be adequate to perform 360 degrees thermal-activity analysis operations, and automated detection of wildfire and wildfire embers. Specifically, thermal sensing in the range of the sensor can be like the array sensors installed in forward-looking infrared (FLIR) cameras, as well as those of other thermal imaging cameras, use detection of infrared radiation, typically emitted from a heat source (thermal radiation) such as fire, to create an image assembled for video output and other image processing operations to generate signals for use in early fire detection and elimination system of the present invention.

The pyroelectric detectors 27C detect the typical spectral radiation of burning, organic substances such as wood, natural gas, gasoline, and various plastics. To distinguish a flame from the sun or other intense light source such as light emissions from arc welding, and thus exclude a false alarm, the following independent criteria are considered: a typical flame has a flicker frequency of (1 . . . 5) Hz; a hydrocarbon flame produces the combustion gases carbon monoxide (CO) and carbon dioxide (CO₂); and in addition, burning produces water which can also be detected in the infrared range. Each pyroelectric detector 27C is an infrared sensitive optoelectronic component specifically used for detecting electromagnetic radiation in a wavelength range from (2 to 14) μm.

Each sprinkler-based wildfire defense system 50, deployed on and commissioned at a home construction job site, will use a GPS referencing system available in the USA and elsewhere, supporting transmission of GPS signals from a constellation of satellites to the Earth's surface. This way local GPS receivers within the GPS sensor 30 located on each Citrotech® containing storage tank 21, as well as each remote wildfire ember and smoke detector 27, will receive the GPS signals and compute locally GPS coordinates indicating the location of the networked device within the GPS referencing system. This GPS location information is then automatically transmitted to a central database server 12 using 4G GSM digital cellular communications, in the preferred embodiment. By managing the GPS location of storage tanks 21 aboard each wildfire defense system trailer 90, as well as the GPS location of the wildfire defense system trailer 90 itself, the manufacturer of Citrotech® liquid fire inhibitor can continuously track and map the location of its fire inhibiting chemical liquid around the globe, in relation to the current location of active wildfires and forecasted risk of wildfire, as part of its supply chain, inventory, and customer service management operations around the world.

Also, such GPS tracking of the wildfire defense system trailer 90 enables home construction builders and/or contractors to use a mobile phone system 11 as shown in FIG. 2A, to send an SMS signal to the fire inhibitor pumping system 22 aboard the wildfire defense system trailer 90 and automatically and remote initiate the pumping of CITROTECH® MFB-31 liquid fire inhibitor 35 in the storage tank 21 to all of the sprinkler spray heads 28 deployed all around the home construction job-site. Alternatively, the fire inhibitor pumping system 22 aboard the wildfire defense system trailer 90 can be configured to automatically pump and spray CITROTECH® liquid wildfire inhibitor 35 over the entire home construction job-site in minutes—in response to the automated (AI-based) detection of wildfire embers and/or smoke by an AI-driven remote wildfire ember and smoke detector 27 with the wireless network thereof, deployed and operating in vicinity of the home construction job-site. These options provide home construction builders, property owners, and home construction insurance policy underwriters flexibility and options needed to protect their property and investments in a sustainable manner.

When practicing the remote wildfire sensor of the present invention 27, any low power wireless networking protocol of sufficient bandwidth can be used. However, in the preferred embodiment, its 4G GSM digital cellular transceiver circuit will be used to send SMS-based triggering signals 40 directly to its linked wildfire defense spraying system of the present invention 20. Such SMS-based triggering signals 40 will activate its 4G GSM remote power control switch 24, energize the electric pump 22, and spray Citrotech® liquid fire inhibitor 35 all over the property 36 to provide the proactive protection it requires in the presence of a wildfire and its flying embers 41. Such 4G GSM signaling 40 can support SMS between the wireless ember and smoke detector 27, and the one or more linked wildfire defense spraying system(s) 20 that the automated ember detector 27 might be ordered to serve in any given application.

In the illustrative embodiment, the wildfire ember detection system 27 supports a computing platform, network-connectivity (i.e. IP Address), and is provided with native application software installed on the system as client application software, designed to communicate over the system network and cooperate with application server software running on the application servers of the system network, thereby fully enabling the functions and services supported by the system, as described above. In the illustrative embodiment, a wireless mess network may be implemented using conventional IEEE 802.15.4-based networking technologies to interconnect these wireless subsystems into subnetworks and connect these subnetworks to the internet infrastructure of the system of the present invention. However, such wireless 4G GSM wildfire ember and smoke sensor 27 can be used alone with at least one wildfire defense spraying system 50, in which case SMS messaging 40 transmitted to its host WFD spraying system 50 can automatically trigger the 4G GSM controlled spraying system 20 to spray all the Citrotech® liquid fire inhibitor 35 in its storage tank 21, all over the property 36 prior to wildfire arrival for proactive wildfire defense.

FIGS. 11J1 and 11J2 show lithium-battery electrical power storage system 23 being used in providing an un-interrupted electrical power supply (UPS) (from either trailer-mounted PV photo panel arrays 23B or a 120/220V electrical power service) to the electric pump system, and other electrical power consuming components used in the sprinkler-based wildfire defense property spraying system of the present invention, when constructed from the kit of system components shown in FIG. 11.

FIG. 11K shows a two-way flow valve assembly 25, mounted within the wildfire defense system trailer 90, and used to control (i) the flow of water from a water source 37 into the electric pump 22 when arranged in its first flow position during sprinkler sprayhead testing operations, and (ii) the flow of Citrotech® liquid fire inhibitor 35 from the storage tank 21 into the electric pump 22 when arranged in its second flow position, and the system is configured for fire inhibitor spraying operations on the property.

In some application environments, ambient temperatures on the property parcel being defended against wildfire may fall below freezing, and in such environments, it will be wise if not necessary to adapt the wildfire defense spraying system to prevent freezing of the liquid fire inhibitor in its storage tank. FIGS. 11L, and 11M1 and 11M2, illustrate two different options for controllably heating the liquid fire inhibitor in the storage tank and prevent freezing, and system malfunction, prior to spraying operations are completed on the parcel of property.

For example, FIG. 11L shows an electrically-powered temperature-controlled immersible heating system 33 for immersion in the chemical liquid stored in the storage tank of the wildfire defense spraying system 50, to heat CITROTECH® MFB-31 liquid fire inhibitor in the storage tank 35 as required to prevent freezing and malfunction of the system. The purpose of the heating system is to controllably heat the liquid fire inhibitor 35 in the storage tank 21 using temperature sensor integrated in heating element 33A and controller 33C, as required to prevent freezing and malfunction of the system. Power plug 34E can be directly plugged into a power supply socket 23A supported on the lithium battery power supply unit 23 when powered from 120V AC power service at the installation site (e.g. home).

Alternatively, FIGS. 11M and 11N show an electrically-powered temperature-controlled heating blanket 32 adapted for wrapping about the storage tank used in the sprinkler-based wildfire defense property spraying system 50, to heat the CITROTECH® MFB-31 liquid fire inhibitor in the storage tank 35 as required to prevent freezing and malfunction of the system.

FIG. 11O illustrates the primary components of a first environmentally-clean aqueous-based fire inhibiting liquid biochemical composition of the present invention consisting of major amounts of tripotassium citrate (TPC) and minor amounts of triethyl citrate (TEC) formulated with water functioning as a solvent, carrier, and dispersant, currently marketed under the trade mark and tradename designation-CITROTECH® MFB-31™ liquid fire inhibitor.

FIG. 12 shows a trailer-driven sprinkler-based wildfire defense spray system 50 installed on a wood home construction job-site 160 for protection against wildfire during the home-building construction project.

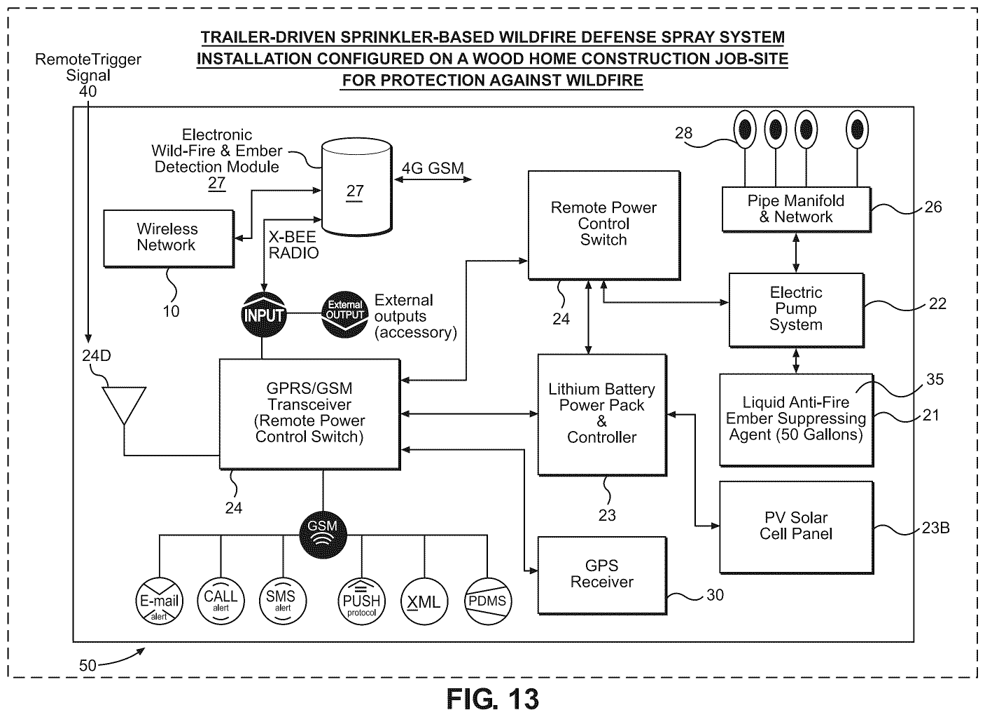

FIG. 13 shows the system level components comprising the trailer-driven sprinkler-based wildfire defense spray system 50 of the present invention installed at the wood home construction job-site. The primary purpose of the trailer-driven sprinkler-based wildfire defense spray system 50 is to provide reliable protection against wildfire during the home-building construction project. As shown in FIG. 13, the installed, deployed and commissioned system 50 comprises: (i) a wildfire ember detection module 27 for mounting on the top of a building or high tree to automatically detect the presence of a wildfire well before its arrival many miles away, and sensing a SMS-spray-triggering signal to the wireless remotely-activatable sprinkler-based wildfire defense fire inhibitor spraying system 50; (ii) Storage Tank (e.g. 50 or 100 Gallons) 21 capacity for storage of CITROTECH® MFB-31 liquid fire inhibitor formulation 35 pumped into the storage tank 21 during installation and setup; (iii) 4G GSM GPS Sensor 24 for mounting to the Storage Tank for monitoring the GPS location thereof; (iv) Electric Pump 22 connected to the Storage Tank 21 and a supply of pressurized water at installation location via a Valve assembly with first and second positions; (v) a Lithium-Battery Backup Power Supply System 23 with photovoltaic (PV) recharging panel 23B and 120 V line input from a local source of electrical power, for supplying electrical power to the electric pump; (vi) sprinkler spray heads, PVC piping 26 for forming the necessary fluid pumping circuits from the electric pump to the sprinkler spray heads 28 during spraying operations; and (vii) a 4G GSMGPRS Transceiver and the Remote Power Control Switch 24 for remotely controlling electrical power to the Electric Pump 22 via the 4G GSM remote control power switch 24.

### Specification of Trailer-Mounted Fire Extinguishing System for Use in Extinguishing Job-Site Wood-Frame Building Construction Fires During the Construction Phase of a Home Building Project in the Wildfire Urban Interface (WUI) Region

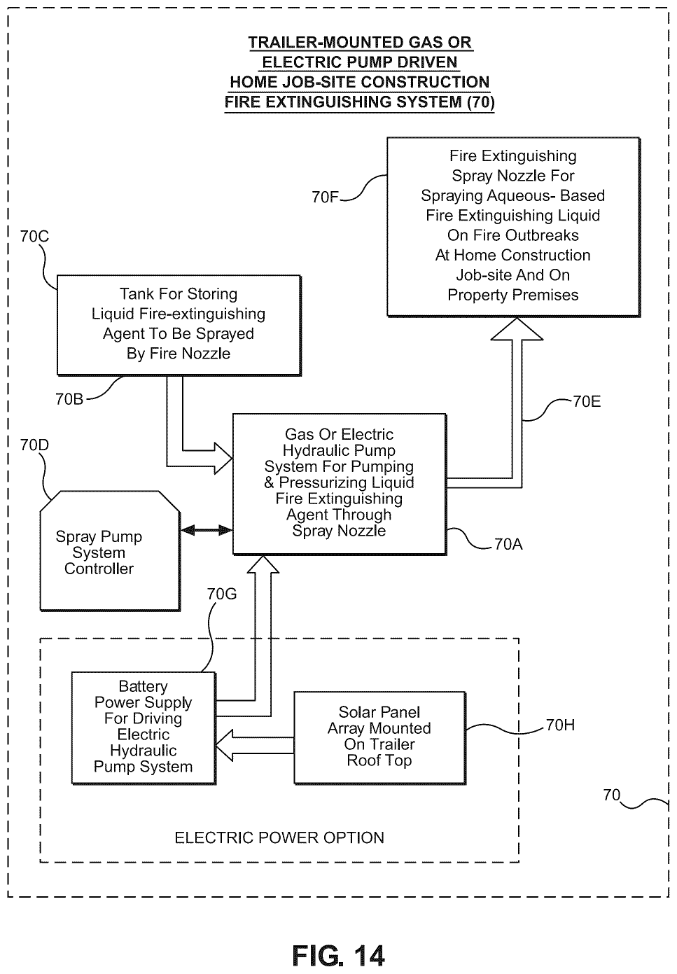

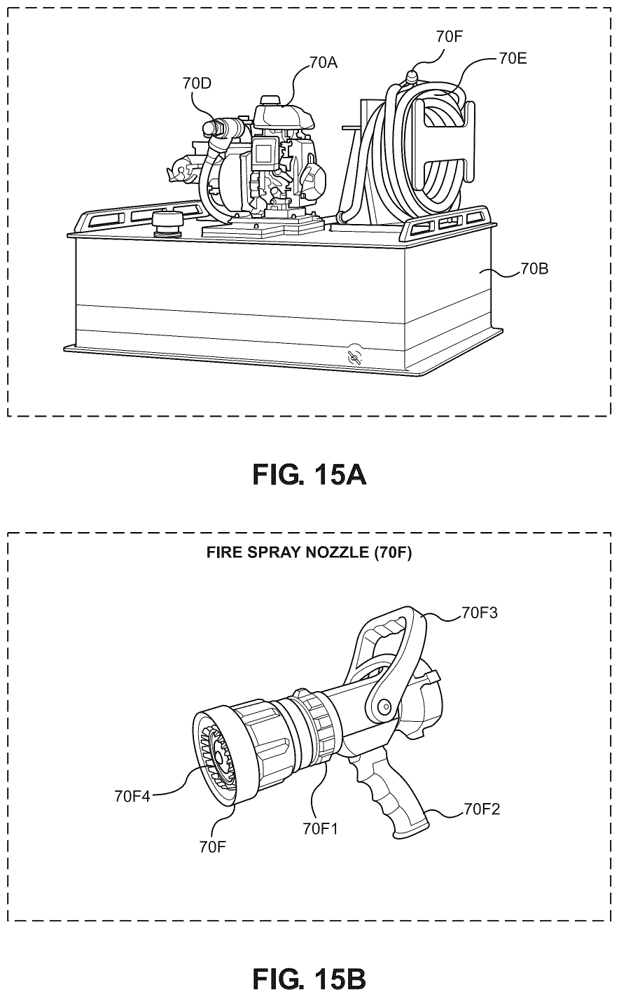

FIG. 14 shows a trailer-mounted (gas or electric pump driven) home job-site construction fire extinguishing system 70, for use by workers at a home construction job-site, to rapidly extinguish any wood-frame building construction fire that may break out during the construction phase of a home building project in the wildfire urban interface (WUI) region. As shown, the fire extinguishing system 70 comprises: a tank 70B storing a quantity of liquid fire extinguishing agent (i.e. CITROTECH® MFB-31 liquid fire inhibitor or other suitable formulation) 70; a gas or electric powered hydraulic pumping system 70 for pumping liquid fire extinguishing agent 70C from the tank 70B and through flexible house 70E storable on a take-up reel, and a hand-held spray gun 70 F with a spray nozzle 70F4 connected to a barrel with handle 70F2 operated by a hinged spray/flow actuator 70F3, as shown in FIG. 15B; a spray pump controller 70D for controller the pumping system 70A; and an electric battery power supply 70G for supplying electric power to an electric hydraulic pump system when employed, and a solar panel array 70H mounted to the wildfire defense system trailer 90 for recharging the battery power supply 70G whenever required.

FIGS. 15A and 15B shows the trailer-mounted home job-site construction fire extinguishing system 70 with a specific form factor, and adapted for mounting inside the wildfire defense system trailer 90. By design, the home job-site construction fire extinguishing system 70 should have a sufficiently long-read flexible hose 70E for reaching and rapidly extinguishing construction fire outbreaks anywhere on the job-site by spraying potassium salt enriched water streams from its high-pressure nozzle assembly 70F4 mounted at the end of the barrel of the hand-held spray gun 70.

Specification of Kit and System Components for Building, Installing and Commissioning a New and Independent Automated Sprinkler-Based Wildfire Defense System on the Constructed Home Building and Surrounding Property after the Construction Phase of the Home Building Project has been Completed

During the construction phase of a home building/construction project, the trailer-driven sprinkler-based wildfire defense system 50 is installed, deployed and commissioned for operation during the entire construction phase of the building project. The primary objective of this system 50 is to ensure that all wood home building surfaces and surrounding property areas on the home building construction job-site are automatically and completely sprayed with CITROTECH® MFB-31 liquid fire inhibitor before the arrival of an automatically detected remote wildfire storm. By doing so, an ultra-thin potassium salt microcrystalline coatings will be formed on all such surfaces and protect the underlying combustible material from fire ignition, flame spread and smoke development in the presence of a wildfire storm moving through and across the job-site and surrounding property.

FIG. 16 shows a kit of system components, like those described above, for use in installing, deploying and commissioning for operation, a second and wholly-independent automated sprinkler-based wildfire home defense system 80 that is located partially inside, around and about the fully constructed home building—after the construction phase of the home building project has been completed in the wildfire urban interface (WUI) region. While it is understood that any given automated sprinkler-based wildfire home defense system 80 will involve using system components for its design and installation, and depending on the house being constructed on the job-site, it is understood that these general components will be used in principle when installing, deploying and commissioning the second automated (home-driven) sprinkler-based wildfire home defense system 80. While the specifics of the system components used will vary from home building project to home building project, the general inventive concepts will remain essentially the same.

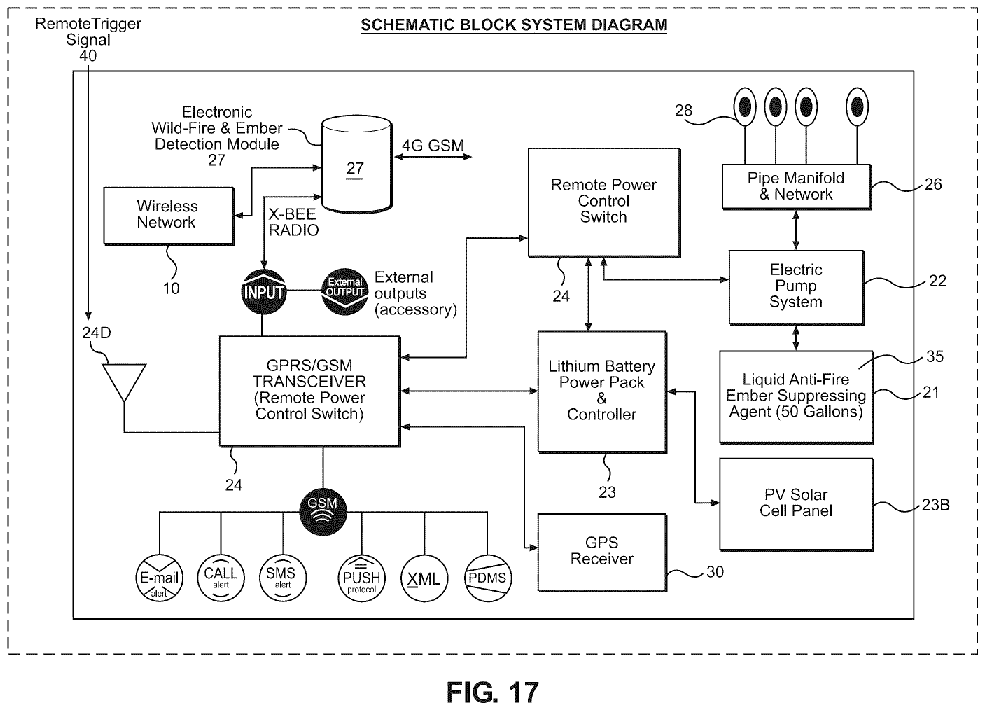

FIG. 17 provides a schematic representation illustrating the system architecture of the second fully-automated (home-based) sprinkler-based wildfire home defense system 80 constructed using the system components shows in FIG. 16, and commissioned for operation after first automated sprinkler-based wildfire home defense system 50 (operationally during the entire construction phase of the home construction project) has been decommissioned and ultimately dismantled and removed from the home construction site. Such decommissioning will also involve the removal of the wildfire defense system trailer 90 of the present invention, and other piping and sprinkler heads employed in the installation of the first sprinkler-based wildfire defense system 50.

Specification of the Construction Phase-Employing Trailer-Driven Wildfire Defense System and Method Deployed and Commissioned for Spraying Liquid Fire Inhibitor on Wood Home Building Surfaces and Surrounding Property During the Construction Phase of a Home Building Project in a Wildfire Urban Interface (WUI) Region

FIG. 18A shows the wildfire defense system 50 deployed and commissioned for operation on a first exemplary wood frame home construction job-site during the construction phase of a home building project, in accordance with the principles of the present invention. As shown, the wildfire defense system trailer 90 of the present invention is deployed on the job-site and used to drive and support the sprinkler-based wildfire defense system 50 engineered for proactively spraying potassium salt microcrystalline coatings over all combustible surfaces on the job-site and building under construction to provide Class A fire protection against the hot flying embers of a wildfire storm.

FIG. 18B shows the wildfire defense system 50 deployed and commissioned for operation on a second exemplary wood frame home construction job-site during the construction phase of a home building project, in accordance with the principles of the present invention. As shown, the wildfire defense system trailer 90 of the present invention is deployed on the job-site and used to drive and support the sprinkler-based wildfire defense system 50 engineered for proactively spraying potassium salt microcrystalline coatings over all combustible surfaces on the job-site and building under construction to provide Class A fire protection against the hot flying embers of a wildfire storm.

FIG. 18C shows the wildfire defense system deployed and commissioned for operation on a first exemplary mass-timber home construction job-site during the construction phase of a home building project, in accordance with the principles of the present invention. As shown, the wildfire defense system trailer 90 of the present invention is deployed on the job-site and used to drive and support the sprinkler-based wildfire defense system 50 engineered for proactively spraying potassium salt microcrystalline coatings over all combustible surfaces on the job-site and building under construction to provide Class A fire protection against the hot flying embers of a wildfire storm.

FIG. 18D shows the wildfire defense system deployed and commissioned for operation on a second exemplary mass-timber home construction job-site during the construction phase of a home building project, in accordance with the principles of the present invention. As shown, the wildfire defense system trailer 90 of the present invention is deployed on the job-site and used to drive and support the sprinkler-based wildfire defense system 50 engineered for proactively spraying potassium salt microcrystalline coatings over all combustible surfaces on the job-site and building under construction to provide Class A fire protection against the hot flying embers of a wildfire storm.

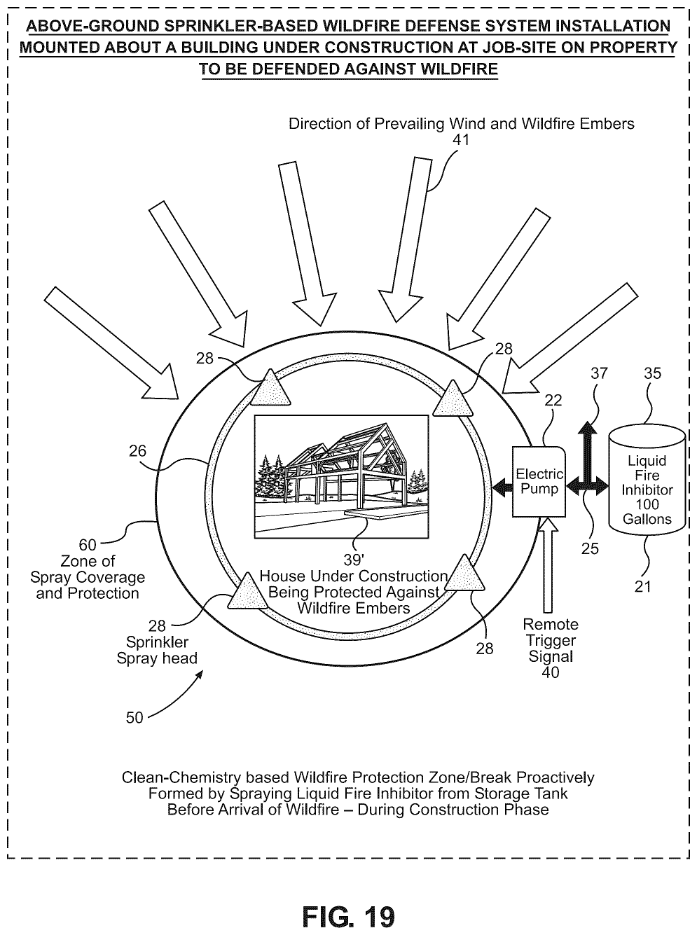

FIG. 19 illustrates an above-ground sprinkler-based wildfire defense system installation 50 deployed and commissioned around and about a building under construction at job-site property to be defended against wildfire. As shown, the direction of the prevailing winds on the job-site will be taken into consideration when designing, installing and commissioning the sprinkler-based wildfire defense system installation 50.

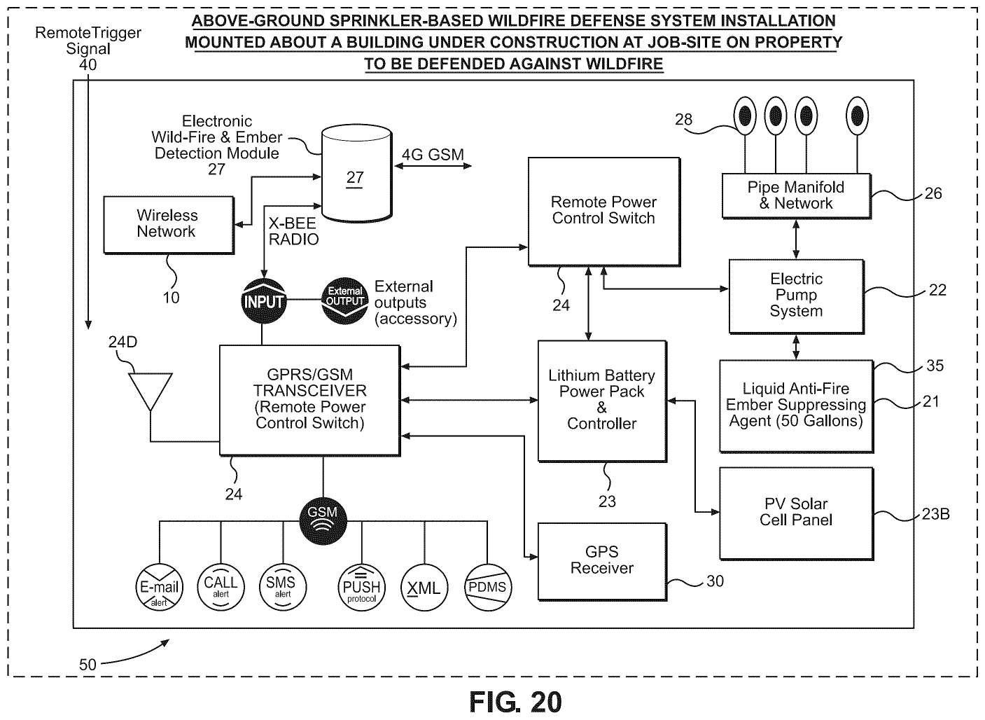

FIG. 20 illustrates the various system components that can be used to install and deploy the above-ground sprinkler-based firebreak spray system installation shown in FIG. 19, mounted about a building under construction at job-site property to be defended against wildfire.

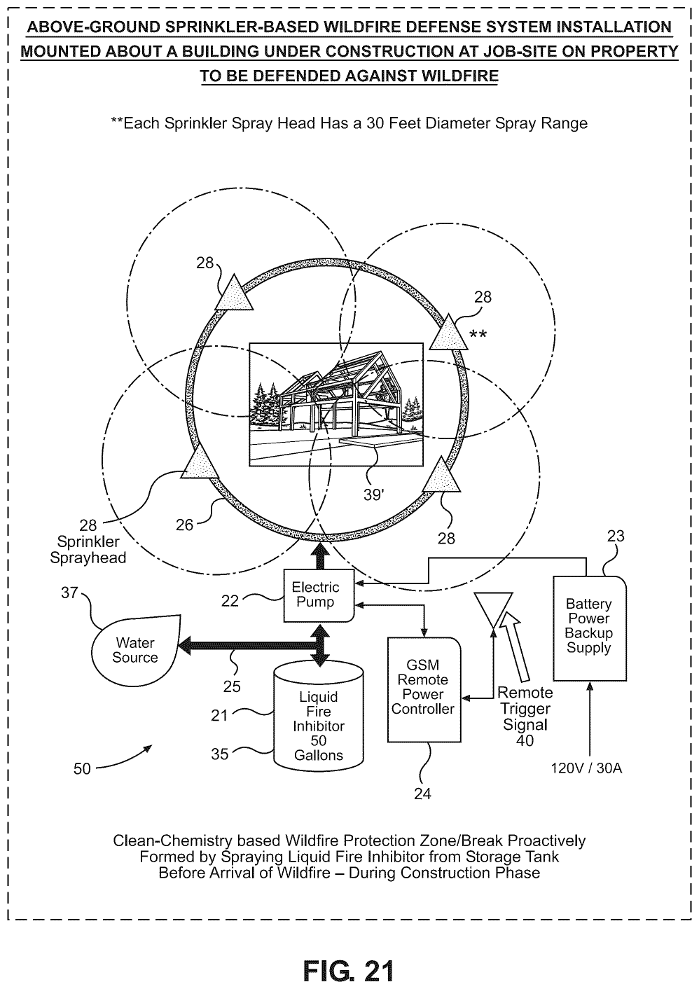

FIG. 21 illustrates the spray patterns of the exemplary sprinkler spray heads used in the above-ground sprinkler-based firebreak spray system installation shown in FIGS. 19 and 20, mounted about a building under construction at job-site on property to be defended against wildfire.

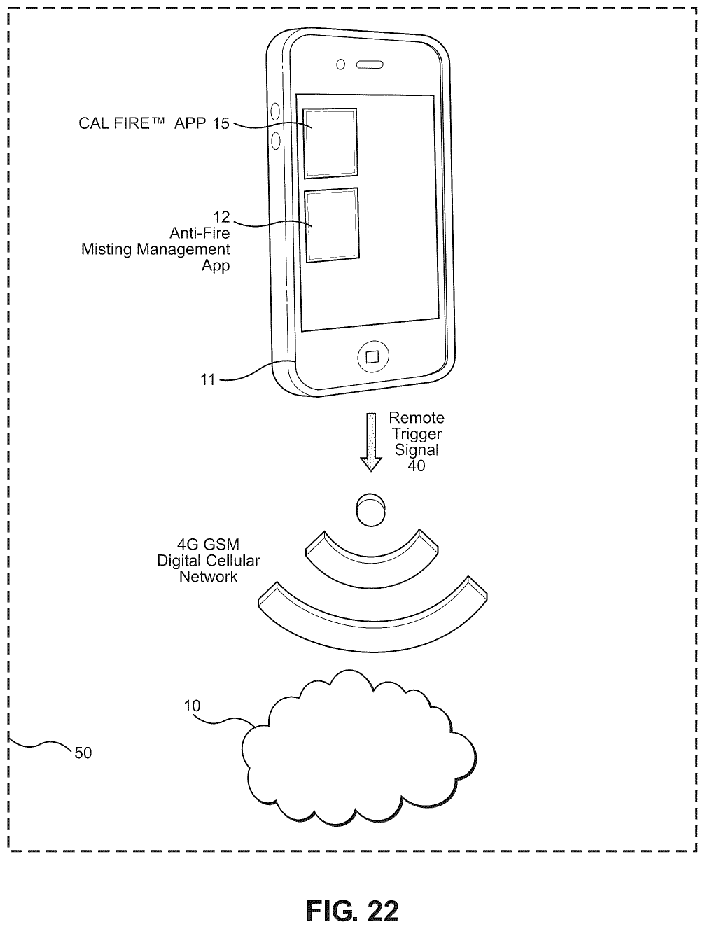

FIG. 22 shows a mobile smartphone 11 being used to remotely activate the spraying of fire inhibitor before the arrival of a wildfire on the home construction job-site. As shown, SMS signaling is used to support a 4G GSM digital cellular communication link between the smartphone 11 and the 4G GSM remote power control switch 24 employed in the home construction job-site wildfire defense system 50 and preferably mounted aboard the wildfire defense system trailer 90 shown in FIGS. 3A and 3B.

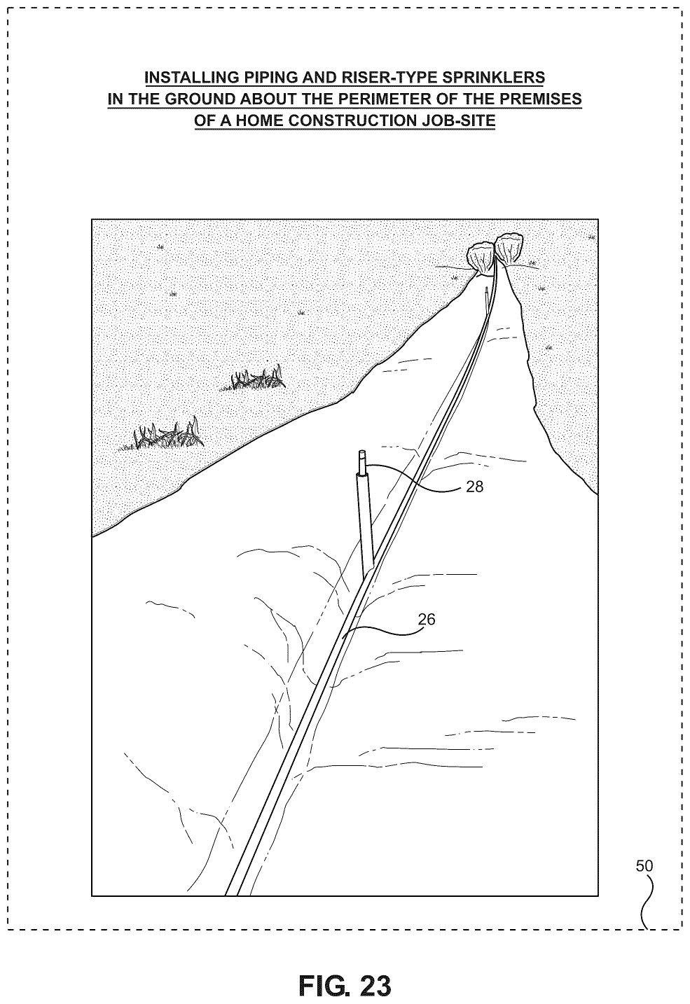

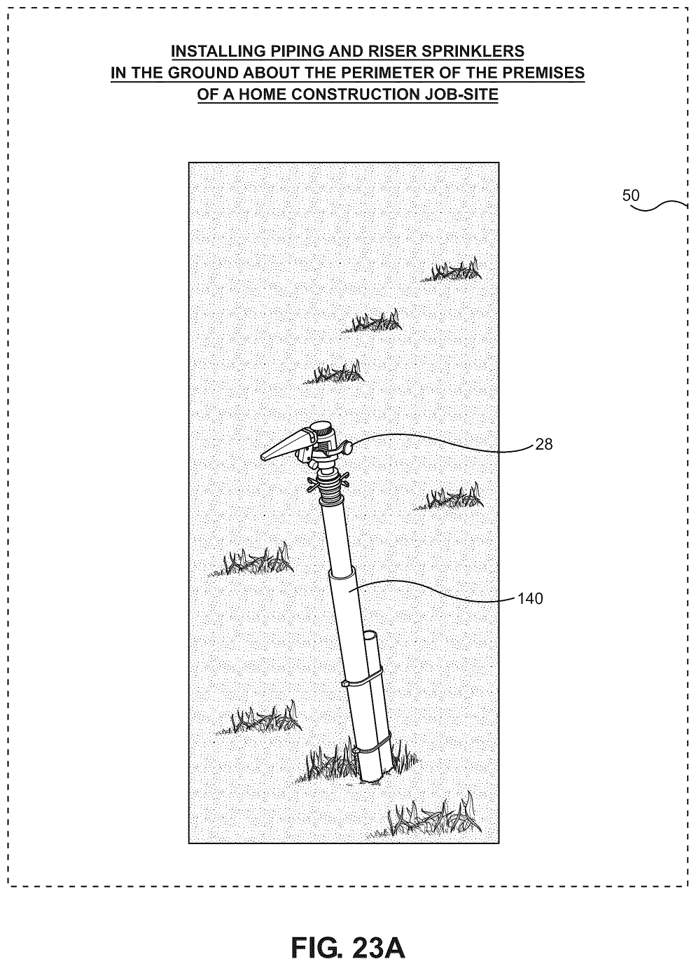

When installing the sprinkler spray heads 28 across the job-site and surrounding property, it will be necessary to install PVC piping 26 for interconnections between the spray heads 28 and the hydraulic pumping system 22, and often the piping will need to be buried in underground trenches in job-site ground surfaces as shown in FIGS. 23 and 23A, and sometimes the spread heads 28 will need to be mounted on high reaching poles 150 and risers 140 as shown in FIGS. 11G and 23A.

FIG. 23 shows a sprinkler piping 36 being installed in the ground along a part of the property parcel where a clean chemistry wildfire break is to be formed on the home construction job-site in the direction of prevailing winds.

FIG. 23A shows a ground mounted sprinkler riser 140, depicted in FIG. 23, installed along a part of the property parcel where a clean chemistry wildfire break is to be formed on the home construction job-site in the direction of prevailing winds.

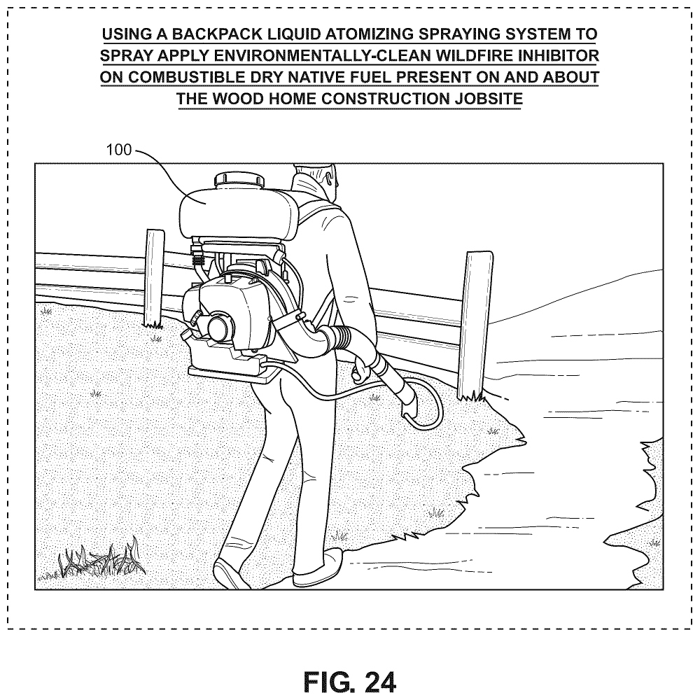

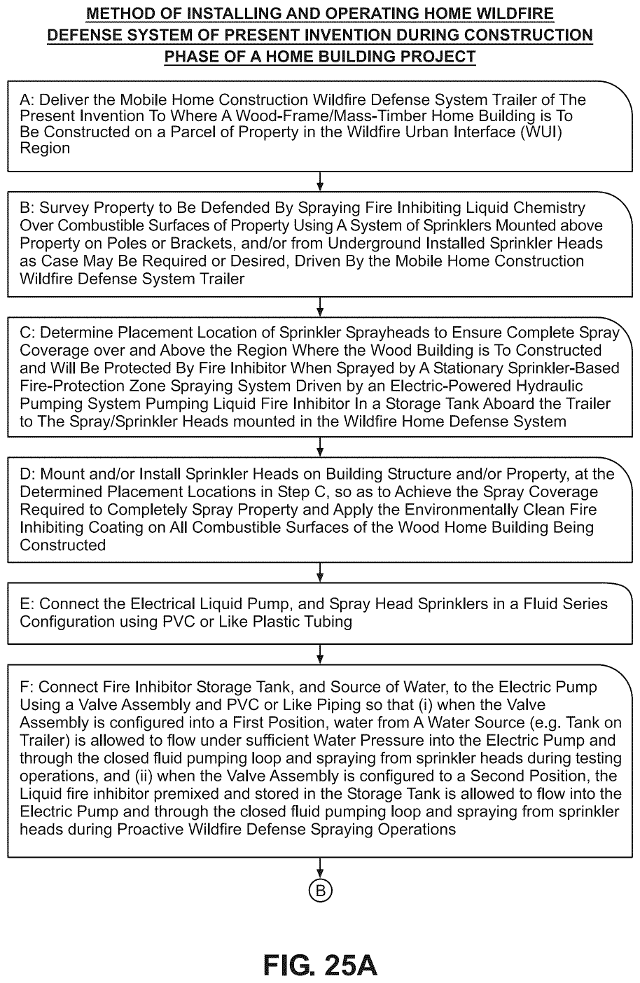

FIG. 24 shows the use of the backpack atomizing spraying system 100 depicted in FIG. 6 for spraying environmentally-clean liquid wildfire inhibitor 35 in tank 100A over combustible native fuel surfaces surrounding the home construction job-site, in accordance with the principles of the present invention.

### Specification of the Method of Installing and Commissioning for Operation the First Sprinkler-Based Wildfire Defense Fire Inhibitor Spraying System of the Present Invention

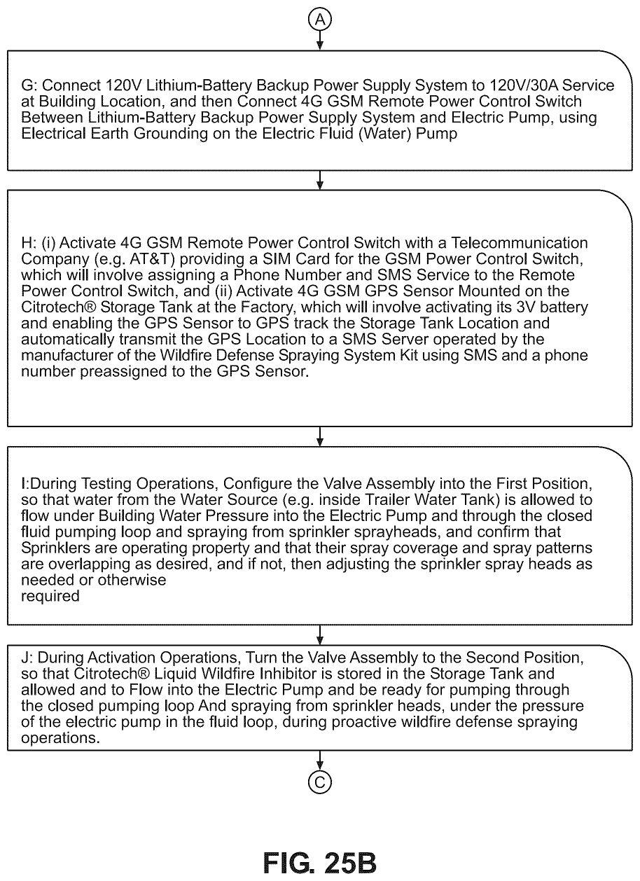

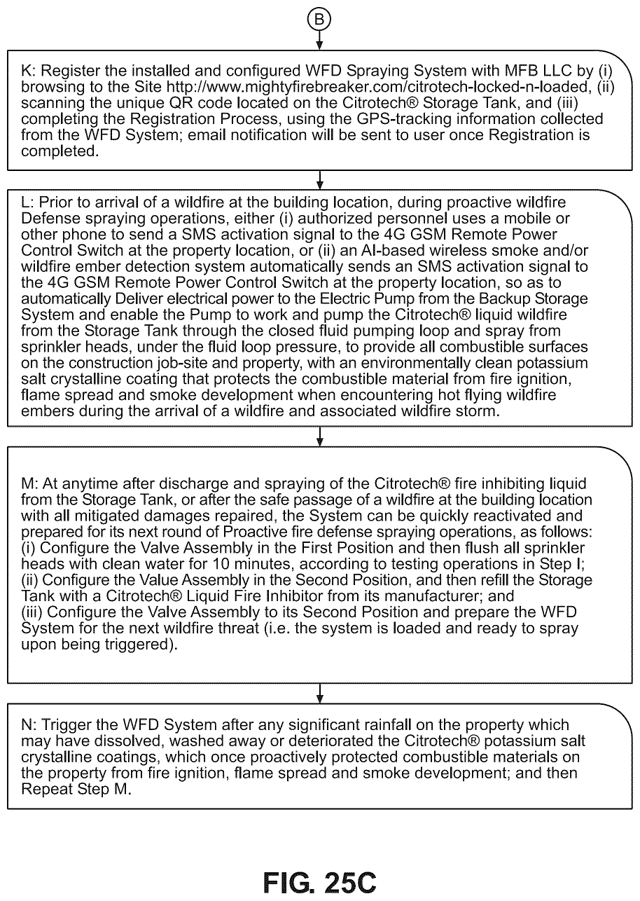

FIGS. 25A, 25B, and 25C describe the steps to be undertaken when practicing the preferred method of installing and commissioning for operation the sprinkler-based home construction wildfire defense system of present invention 50 during the construction phase of a home building project in a WUI region.

As indicated at Block A in FIG. 25A, the first step involves delivering the Mobile Home Construction Wildfire Defense System Trailer 90 of the present invention to a home construction job-site location where a wood-frame/mass-timber home building is to be constructed on a parcel of property in a Wildfire Urban Interface (WUI) region.

As indicated at Block B in FIG. 25A, the second step involves surveying the property 36 to be defended by spraying fire inhibiting liquid chemistry (e.g. CITROTECH® MFB-31 liquid fire inhibitor) over combustible surfaces of home building under construction and surrounding property using a system of sprinklers mounted to building, mounted above property on poles or brackets, and/or from underground installed sprinkler heads as case may be required or desired.

As indicated at Block C in FIG. 25A, the third step involves determining the physical placement location of sprinkler sprayheads 28 to ensure complete spray coverage over and about building structure to be protected by fire inhibitor when sprayed by the installed stationary sprinkler-based fire-protection spraying system 50, driven by an electric-powered hydraulic pumping system 22 pumping liquid fire inhibitor in a storage tank 21 aboard the trailer to the spray/sprinkler heads 28 mounted in the wildfire home defense system 50.

As indicated at Block D in FIG. 25A, the fourth step involves mount and/or install sprinkler heads on building structure and/or property, at the determined placement locations in Step C, to achieve the spray coverage required to completely spray property and apply the environmentally clean fire inhibiting coating (e.g. potassium salt microcrystalline coating) on all combustible surfaces of the wood home building being constructed.

As indicated at Block E in FIG. 25A, the fifth step involves connecting the electrical liquid pump 22, and spray head sprinklers 28 in a fluid series configuration using PVC or like plastic tubing 26.

As indicated at Block F in FIG. 25A, the sixth step involves connecting fire inhibitor storage tank 21, and source of water 37, to the electric pump 22 using a valve assembly 25 and PVC or like piping so that either (i) when the 2-way valve assembly 25 which when configured into a first position, water from the water source (e.g. garden hose) is allowed to flow under building water pressure into the electric pump 22 and through the closed fluid pumping loop and spraying from sprinkler heads 28 during testing operations, and (ii) when the valve assembly is configured to a second position, the liquid fire inhibitor 35 premixed and stored in the storage tank 21 is allowed to flow into the electric pump 22 and through the closed pumping loop and spraying from sprinkler heads 28 during proactive wildfire defense spraying operations.

As indicated at Block G in FIG. 25B, the seventh step involves connecting 120V lithium-battery backup power supply system to 120V/30 A service at building location, and then connect 4G GSM remote power control switch between lithium-battery backup power supply system and electric pump, using electrical earth-grounding on the electric fluid (water) pump.

As indicated at Block H in FIG. 25B, the eighth step involves activating (i) the 4G GSM remote power control switch 24 with telecommunication company (e.g. AT&T) providing SIM card for the GSM power control switch 24, which will involve: assigning a phone number and SMS service to the remote power control switch 24, and also (ii) assigning a phone number and SMS service to the 4G GSM GPS sensor 30 mounted on the Citrotech® storage tank 21 at the factory. This will involve activating its 3V battery and enabling the GPS sensor 30 to GPS track the storage tank 21 location and automatically transmit the GPS location data to a SMS server operated by the manufacturer of the wildfire defense spraying system, and support a GPS tracking and monitoring of each Citrotech® containing storage tank 21 deployed around the globe.

As indicated at Block I in FIG. 25B, the ninth step involves, during sprinkler spray pattern testing operations, configuring the valve assembly 25 into its first flow control position, so that water from a water source (e.g. garden hose or house facet) 37 is allowed to flow under building water pressure into the electric pump 22 and through the closed fluid circulation loop and spraying from sprinkler heads 28, and confirm that the sprinklers 28 are operating property and that their spray coverage and spray patterns are overlapping as desired, and if not, then adjusting the sprinkler heads as needed or otherwise required.

As indicated at Block J in FIG. 25C, the tenth step involves, during activation operations, turning the Valve Assembly 25 to the Second Position, so that Citrotech® liquid wildfire inhibitor 35 is stored in the storage tank 21 and allowed and to flow into the electric pump 22 and be ready for pumping through the closed pumping loop and spraying from sprinkler heads, under the pressure of the electric pump 22 in the fluid loop, during proactive wildfire defense spraying operations.

As indicated at Block K in FIG. 25C, the eleventh step involves registering the installed and configured WFD spraying system 50 with Mighty Fire Breaker, LLC by (i) browsing to the Site http://www.mightyfirebreaker.com/citrotech-locked-n-loaded, (ii) scanning the unique QR code (or RFID tag or other machine-readable code) 31 assigned to and located on the Citrotech® liquid chemical storage tank 21, and (iii) completing the Registration Process, using the GPS-tracking information collected from the WFD spraying system 50; an email notification will be sent to user once Registration Process is completed.

As indicated at Block L in FIG. 25C, the twelfth step involves, prior to arrival of a wildfire at the building location, and just prior to proactive wildfire defense spraying operations, the homeowner or authorized personnel using a mobile smartphone 11 or other phone device to send a SMS activation signal 40 over the digital cellular network to the 4G GSM remote power control switch 24 at the property location, so as that electrical power is automatically delivered to the electric pump 22 from the backup batter storage system 23 and enables the electric pump 22 to work and start pumping the Citrotech® MFB-31 liquid wildfire inhibitor 35 from the storage tank 21 through the closed pumping loop and spraying out from sprinkler heads 28, under the fluid loop pressure, to provide all combustible surfaces on the construction job-site and surrounding property with a Citrotech® environmentally-clean potassium salt crystalline coating—that protects the combustible material from fire ignition, flame spread and smoke development when encountering hot flying wildfire embers during a wildfire storm.

As indicated at Block M in FIG. 25C, the thirteenth step involves any time after discharge and spraying of the Citrotech® fire inhibiting liquid 35 from the storage tank 21, and/or after the safe passage of a wildfire at the home construction job-site location with all mitigated damages repaired, reactivating, and preparing the wildfire defense spraying system 50 for its next round of proactive fire defense spraying operations, as follows:

Configure the Valve Assembly 25 in the First Position and then flush all sprinkler heads with clean water for 10 minutes, according to testing operations in Step I;
(ii) Configure the Value Assembly 25 in the Second Position, and then refill the Storage Tank with Citrotech® Liquid Fire Inhibitor from its manufacturer; and
(iii) Configure the Valve Assembly 25 to its Second Position and prepare the WFD System for the next wildfire storm (i.e. the system is loaded and ready to spray upon being triggered).

As indicated at Block N in FIG. 25C, the fourteenth step involves triggering the WFD system after any significant rainfall on the property which may have dissolved, washed away, or deteriorated the Citrotech® potassium salt crystalline coatings, which once proactively protected combustible materials on the property from fire ignition, flame spread and smoke development.

At this juncture it will be appropriate to describe three topologically different kinds of clean-chemistry wildfire breaks and protection-zones that might be proactively formed about, before, or over targeted home construction job-sites and surrounding properties in a WUI region, using the wireless remotely activated wildfire defense spraying system 50, with respect to prevailing winds in the environment under consideration.

Post-Construction Phase: Wildfire Defense System Installation Deployed and Commissioned for Spraying Environmentally-Clean Liquid Fire Inhibitor on Wood Home Buildings and Surrounding Properties in a Wildfire Urban Interface (WUI) Region after Completion of the Home Construction Project

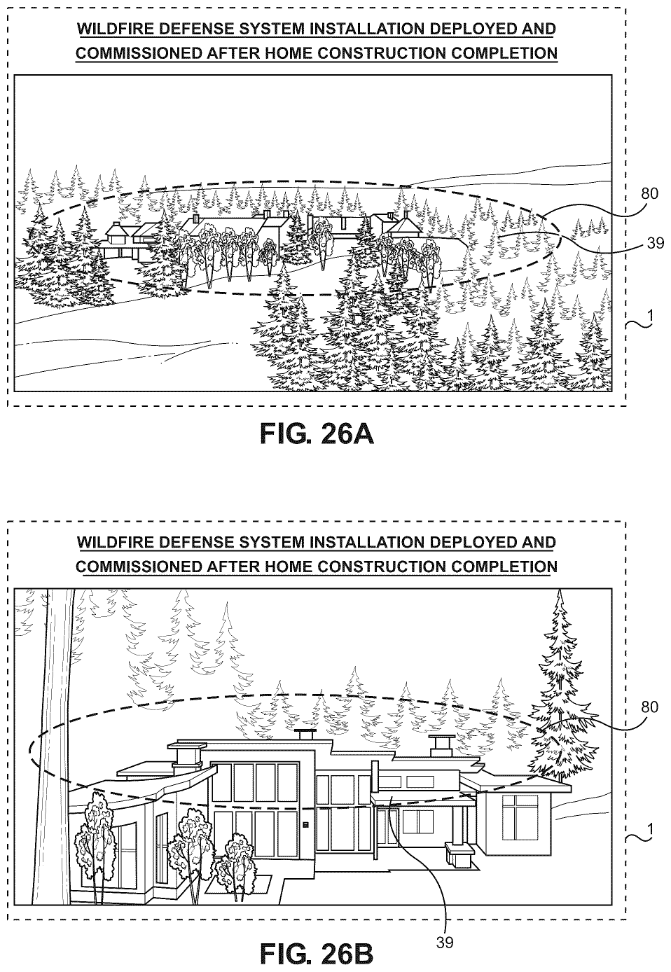

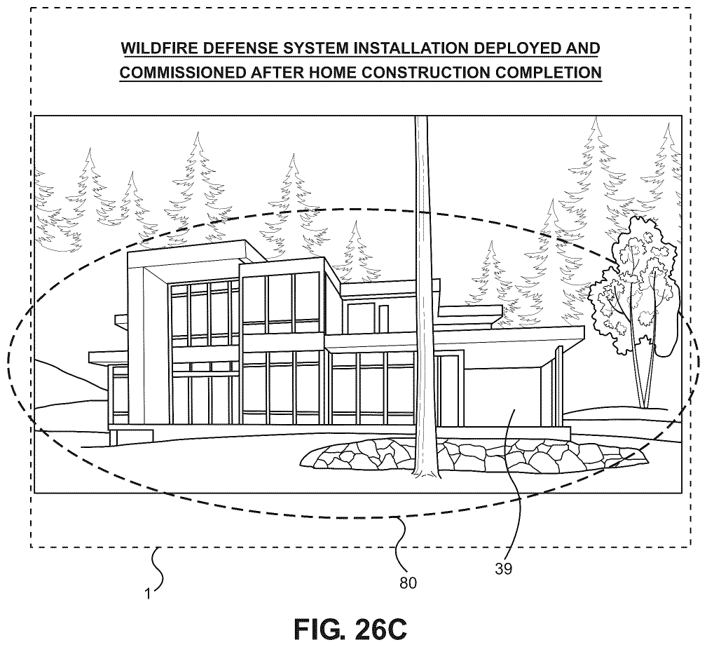

FIG. 26A shows the second sprinkler-based wildfire defense system 80 deployed and commissioned for operation on a first exemplary wood frame home (e.g. lodge) construction during the post-construction phase of a home building project, in accordance with the principles of the present invention. As shown, the wildfire defense system trailer 90 of the present invention has been removed from the job-site, and wherein a home-based hydraulic pumping system 22 and system controls and automation are installed within the completed home building to drive and support the second sprinkler-based wildfire defense system 80 that has been engineered for proactively spraying potassium salt microcrystalline coatings over all combustible surfaces on completed wood building and surrounding property, so as to provide Class A fire protection against the hot flying embers generated during a wildfire storm.

FIG. 26B shows the second sprinkler-based wildfire defense system 80 deployed and commissioned for operation on a second exemplary wood frame home construction (i.e. home cabin) during the post-construction phase of a home building project, in accordance with the principles of the present invention. As shown, during the post-construction phase of a home building project, the wildfire defense system trailer 90 of the present invention has been removed from the job-site, and wherein a home-based hydraulic pumping system 22 and system controls and automation are installed within the completed home building to drive and support the second sprinkler-based wildfire defense system 80 that has been engineered for proactively spraying potassium salt microcrystalline coatings over all combustible surfaces on completed wood building and surrounding property, so as to provide Class A fire protection against the hot flying embers generated during a wildfire storm.

FIG. 26C the second sprinkler-based wildfire defense system 80 deployed and commissioned for operation on a third exemplary wood frame home construction (i.e. home cabin) during the post-construction phase of a home building project, in accordance with the principles of the present invention. As shown, the wildfire defense system trailer 90 of the present invention has been removed from the job-site, and wherein a home-based hydraulic pumping system 22 and system controls and automation are installed within the completed home building to drive and support the second sprinkler-based wildfire defense system 80 that has been engineered for proactively spraying potassium salt microcrystalline coatings over all combustible surfaces on completed wood building and surrounding property, so as to provide Class A fire protection against the hot flying embers generated during a wildfire storm.

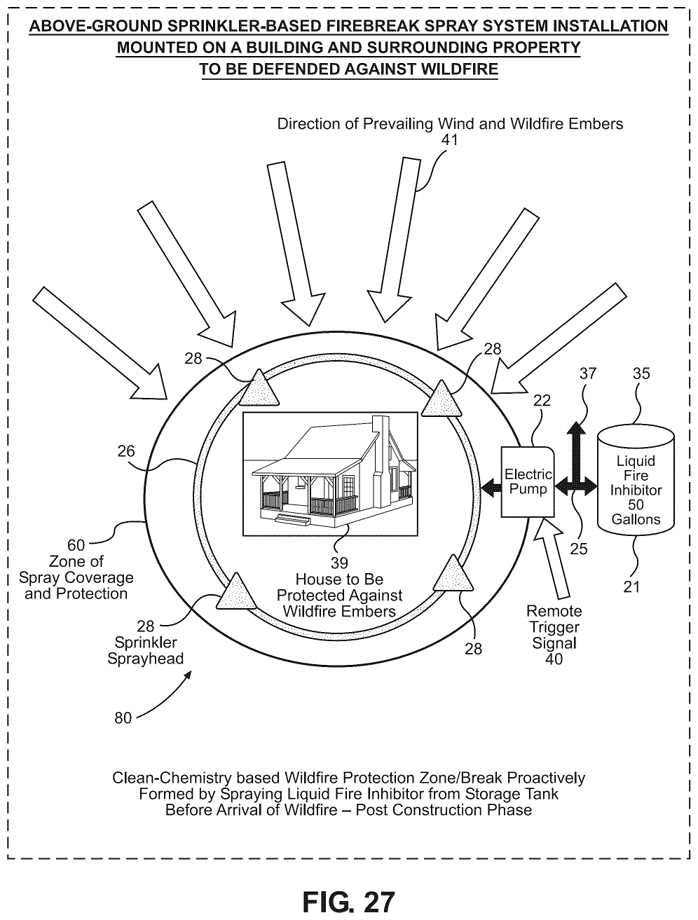

FIG. 27 illustrates the above-ground (second) sprinkler-based wildfire defense system installations 80 that are mounted around and about a completed home building to be defended against wildfire, as shown in FIGS. 26A, 26B and 26C.

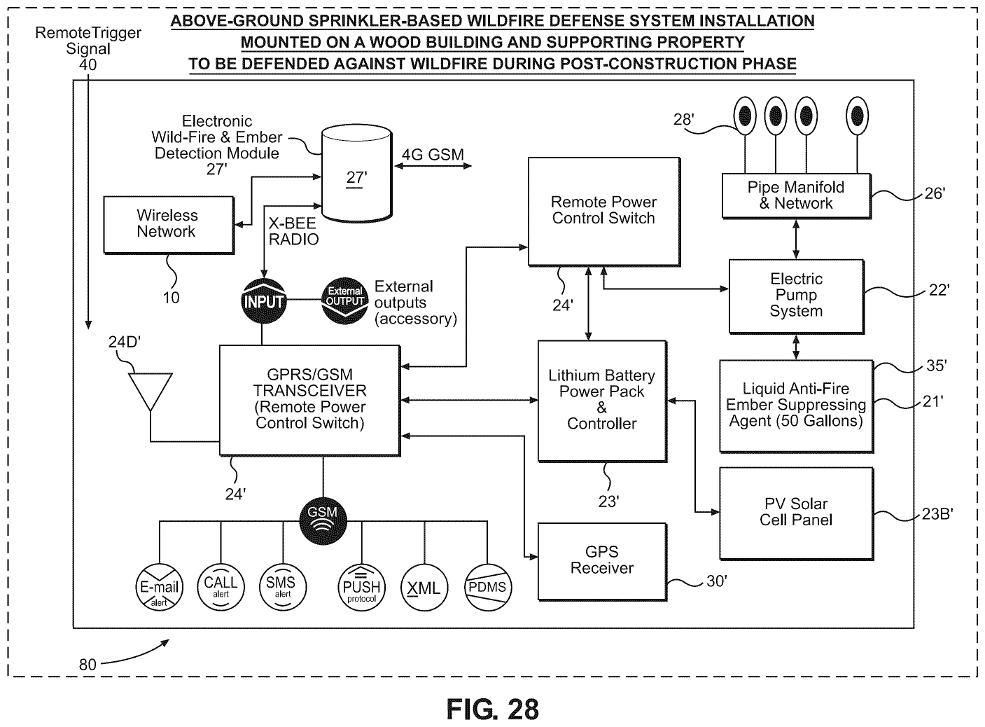

FIG. 28 shows the various system components used and configured together to build and deploy the above-ground sprinkler-based firebreak spray system installation 80 shown in FIG. 27, and mounted on and about a completed home building to be defended against wildfire.

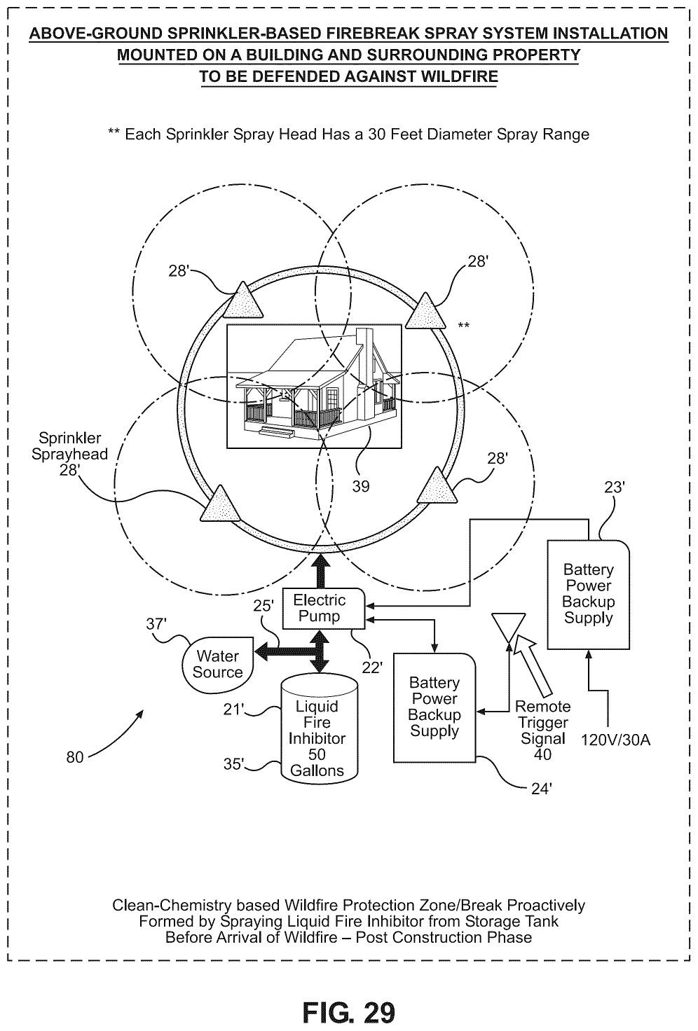

FIG. 29 shows the overlapping spraying patterns generated by the sprinkler spray heads used in the sprinkler-based wildfire defense system installation 90 mounted about a building under construction at job-site on property to be defended against wildfire, shown in FIGS. 26A, 26B and 26C.

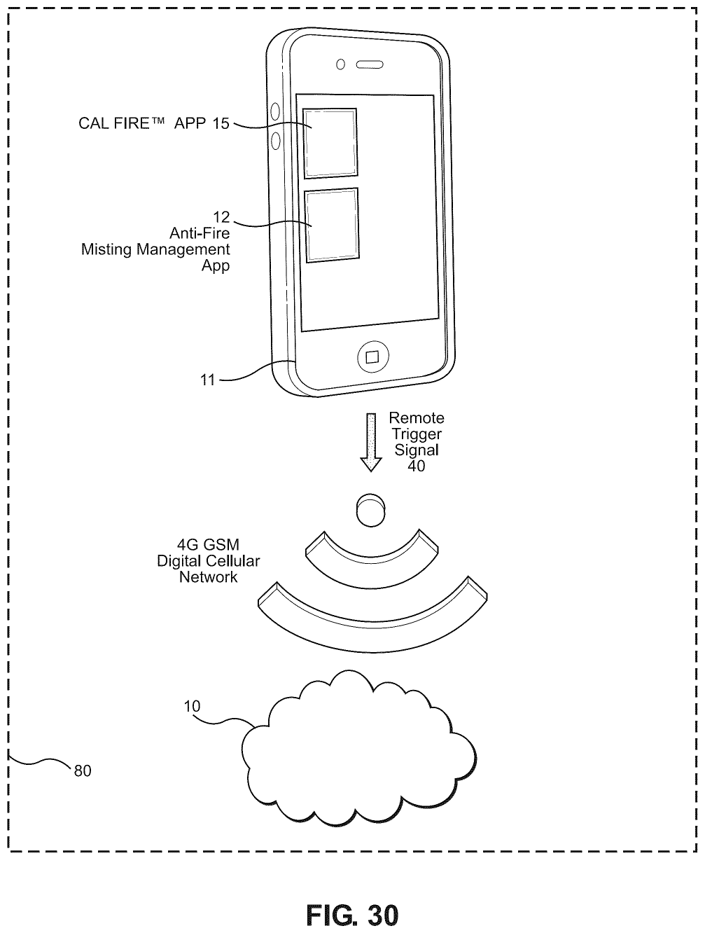

FIG. 30 shows a mobile smartphone 11 being used to remotely activate the spraying of liquid fire inhibitor from the system 90 in FIGS. 26A, 26B and 26C before the arrival of a wildfire on the home construction job-site. Such signal employs the use of SMS supported by a 4G GSM digital cellular communication link established between the smartphone device 11 and the 4G GSM remote power control switch 24 employed in the wildfire defense system 90 installed in the constructed home.

### Specification of the Method of Assembling, Installing and Commissioning for Operation the Second Sprinkler-Based Wildfire Defense Fire Inhibitor Spraying System of the Present Invention

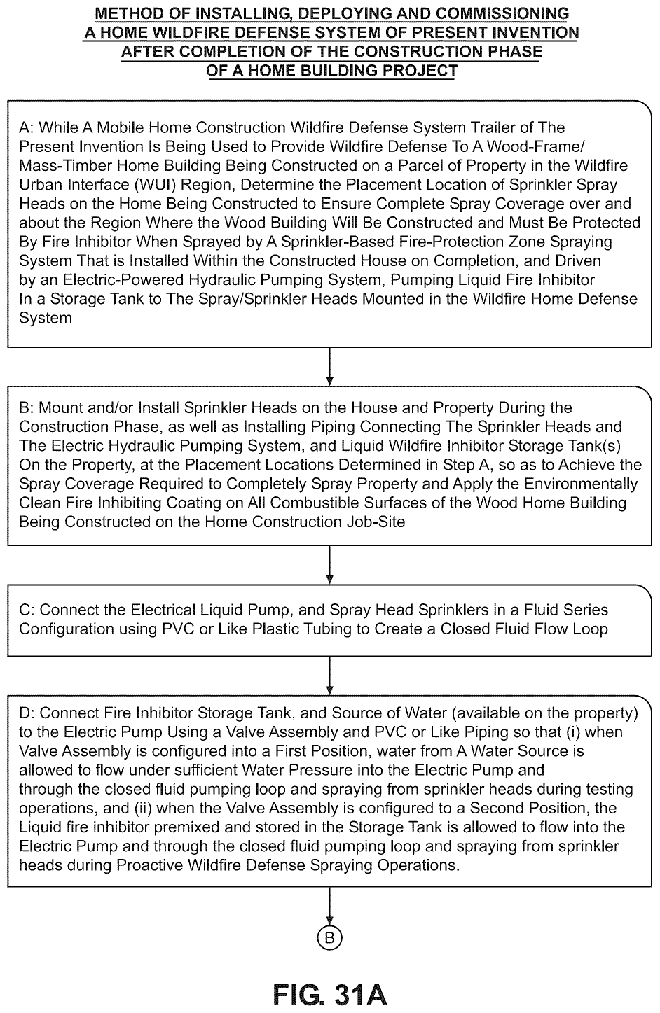

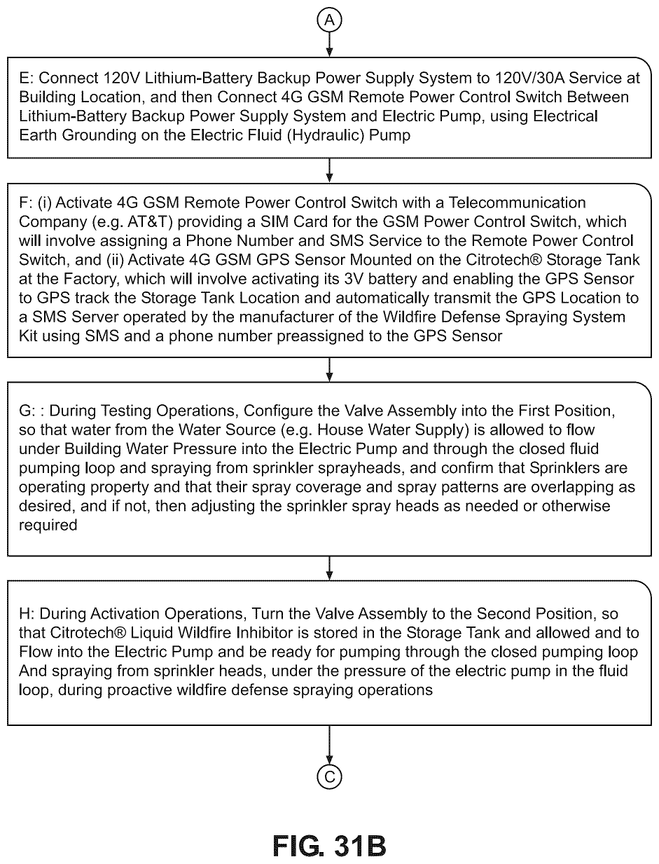

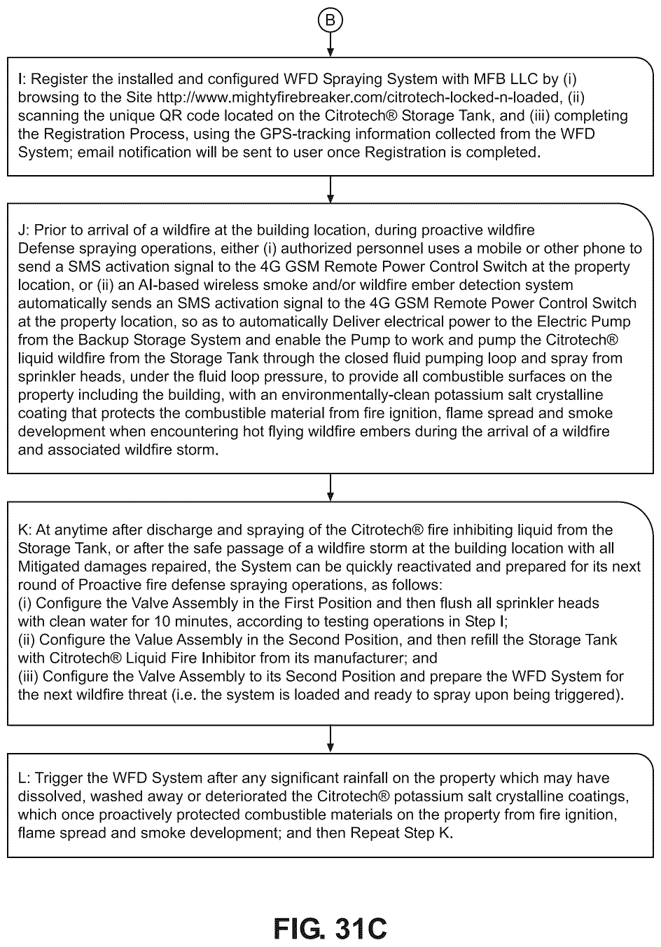

FIGS. 31A, 31B, and 31C describe the steps to be undertaken when practicing the preferred method of installing and commissioning the operation of the home wildfire defense system of present invention, during the post-construction phase of a completed home building project.

As indicated at Block A in FIG. 31A, the first step involves, while a mobile home construction wildfire defense system trailer 90 is being used to provide wildfire defense to a wood-frame/mass-timber home building being constructed on a parcel of property in a wildfire urban interface (WUI) region, determining the placement location of sprinkler spray heads 28′ on the home being constructed to ensure complete spray coverage over and about the region where the wood building will be constructed and must be protected by liquid fire inhibitor when sprayed by a (second) sprinkler-based wildfire defense system 80 that is installed within the constructed house on completion, and driven by an electric-powered hydraulic pumping system 22′, pumping liquid fire inhibitor 35 in a storage tank 21′ to the spray/sprinkler heads 28′ mounted in the wildfire home defense system 90.

As indicated at Block B in FIG. 31A, the second step involves mounting and/or installing sprinkler heads 28′ on the constructed house and surrounding property during the construction phase, as well as installing piping 26′ connecting the sprinkler heads 28′ and the electric hydraulic pumping system 22′, and liquid wildfire inhibitor storage tank(s) 21′ on the property, at the placement locations determined in Step A, so as to achieve the spray coverage required to completely spray property and apply the environmentally clean fire inhibiting coating on all combustible surfaces of the wood home building being constructed on the home construction job-site.

As indicated at Block C in FIG. 31A, the third step involves connecting the electrical liquid pump 22′, and spray head sprinklers 28′ in a fluid series configuration using PVC or like plastic tubing 26′ to create a closed fluid flow loop.

As indicated at Block D in FIG. 31A, the fourth step involves connecting fire inhibitor storage tank 21′, and source of water (available on the property) to the electric pump 22′ using a valve assembly 25 and PVC or like piping 26′ so that (i) when valve assembly is configured into a first position, water from a water source is allowed to flow under sufficient water pressure into the electric pump and through the closed fluid pumping loop and spraying from sprinkler heads during testing operations, and (ii) when the valve assembly is configured to a second position, the liquid fire inhibitor premixed and stored in the storage tank 21′ is allowed to flow into the electric pump 22 and through the closed fluid pumping loop and spraying from sprinkler heads 28′ during proactive wildfire defense spraying operations.

As indicated at Block E in FIG. 31B, the fifth step involves connecting 120V lithium-battery backup power supply system to either a 120V/30 A service at the job-site location and/or PV solar charging array panels 23B′, and then connect 4G GSM remote power control switch 24′ between lithium-battery backup power supply system 23′ and electric pump 22′, using electrical earth grounding on the electric fluid (hydraulic) pump 22′.

As indicated at Block F in FIG. 31B, the sixth step involves (i) activating 4G GSM remote power control switch 24′ with a telecommunication company (e.g. AT&T) providing a SIM card for the GSM power control switch, which will involve assigning a phone number and SMS service to the remote power control switch 24′, and (ii) activating 4 gG GSM GPS sensor 30′ mounted on the Citrotech® storage tank 21 at the factory, which will involve activating its 3V battery and enabling the GPS sensor 30′ to GPS track the storage tank location and automatically transmit the GPS location to a SMS server operated by the manufacturer of the wildfire defense spraying system 80 using SMS and a phone number preassigned to the GPS sensor 30′.

As indicated at Block G in FIG. 31B, the seventh step involves, during testing operations, configuring the valve assembly 25 into the first position, so that water from the water source (e.g. water supply in constructed home/building) is allowed to flow under building water pressure into the electric pump 22′ and through the closed fluid pumping loop and spraying from sprinkler sprayheads 28′, and confirm that sprinklers are operating property and that their spray coverage and spray patterns are overlapping as desired, and if not, then adjusting the sprinkler spray heads 28′ as needed or otherwise required.

As indicated at Block H in FIG. 31B, the eighth step involves, during activation operations, turning the valve assembly 25 to the second position, so that Citrotech® liquid wildfire inhibitor 35′ is stored in the storage tank 21′ and allowed and to flow into the electric pump 22′ and be ready for pumping through the closed pumping loop 26′ and spraying from sprinkler heads 28′, under the pressure of the electric pump 22′ in the fluid loop, during proactive wildfire defense spraying operations.

As indicated at Block I in FIG. 31C, the ninth step involves registering the installed and commissioned wildfire defense system 80 with Mighty Fire Breaker LLC by (i) browsing to the Site http://www.mightyfirebreaker.com/citrotech-locked-n-loaded, (ii) scanning the unique QR code located on the Citrotech® Storage Tank 21′, and (iii) completing the Registration Process, using the GPS-tracking information collected from the wildfire defense system 80; email notification will be sent to user once registration is completed.

As indicated at Block J in FIG. 31C, the tenth step involves, prior to arrival of a wildfire storm at the home building location, during proactive wildfire defense spraying operations, either (i) authorized personnel using a mobile or other phone 11 to send a SMS activation signal to the 4G GSM remote power control switch 24′ at the home property location, or (ii) an AI-based wireless smoke and/or wildfire ember detection system 27′ automatically sends an SMS activation signal to the 4G GSM remote power control switch 24′ at the property location, so as to automatically deliver electrical power to the electric pump 22′ from the backup storage system 23′ and enable the pump 22′ to work and pump the Citrotech® liquid wildfire inhibitor 35′ from the storage tank 21′ through the closed fluid pumping loop, and spray the liquid from sprinkler heads 28′, under the fluid loop pressure, to provide all combustible surfaces on the home property including the building, with an environmentally-clean potassium salt crystalline coating that protects the combustible material from fire ignition, flame spread and smoke development when encountering hot flying wildfire embers during the arrival of a wildfire storm in the WUI region.

As indicated at Block K in FIG. 31C, the eleventh step involves, at any time after discharge and spraying of the Citrotech® fire inhibiting liquid from the storage tank, or after the safe passage of a wildfire storm at the building location with all mitigated damages repaired, the system can be quickly reactivated and prepared for its next round of proactive fire defense spraying operations, as follows: (i) configure the valve assembly in the first position and then flush all sprinkler heads with clean water for 10 minutes, according to testing operations in Step I; (ii) configure the value assembly in the second position, and then refill the storage tank 21′ with Citrotech® liquid fire inhibitor 35′ from its manufacturer; and (iii) configure the valve assembly to its second position and prepare the wildfire defense system 80 for the next wildfire threat (i.e. the system is loaded and ready to spray upon being triggered).

As indicated at Block L in FIG. 25C, the twelfth step involves triggering the wildfire defense system 80 to perform Citrotech® liquid spraying operations on the constructed building after any significant rainfall on the property which may have dissolved, washed away or deteriorated the Citrotech® potassium salt crystalline coatings; and then repeating Step K as needed to prepare the wildfire defense system 80 with a supply of liquid fire inhibitor to apply another coating of liquid wildfire inhibitor on the constructed home building and its surrounding property in the WUI region.

Specification of a Second Configuration for a Liquid Fire Inhibitor Spraying-Based System for Home Wildfire Defense Deployed and Commissioned after Completion of the Home Construction Project in the Wildfire Urban Interface (WUI) Region

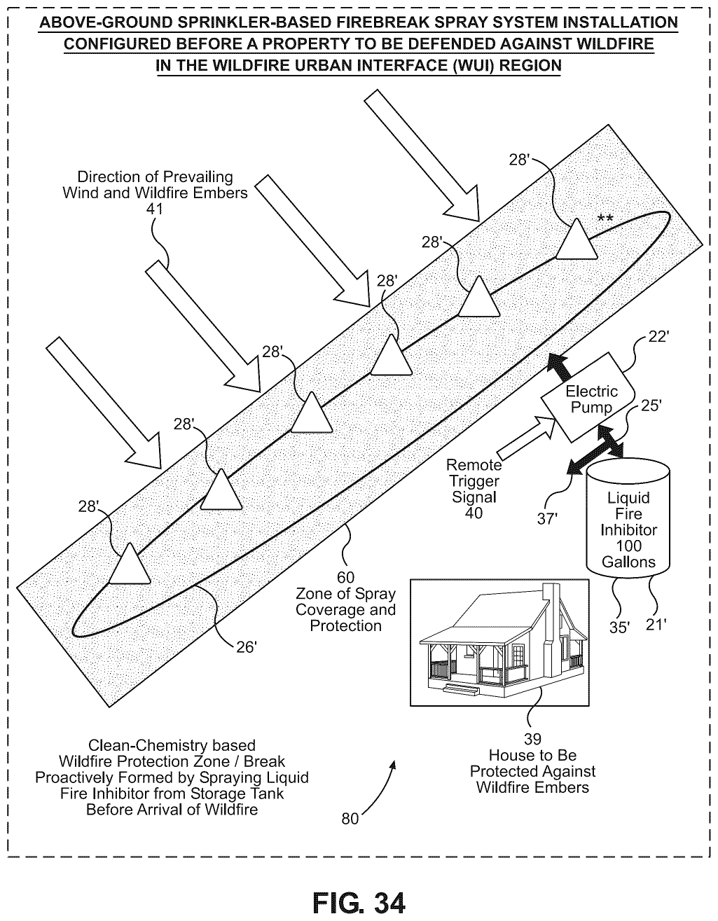

While the “post-construction stage” sprinkler-based wildfire defense system 80 has been illustrated as encircling the constructed home and commissioned only when post-construction (i.e. building occupancy) stage has begun (i.e. and after the construction phase has been completed), there are alternative wildfire defense system topologies, in terms of sprinkler head position and spray pattern formations, that can be designed, installed and commissioned into operation for completed home constructions, and provide the line of wildfire defense required in view of the prevailing winds and environmental conditions surrounding a constructed home and its property in a WUI region. Several possible alternative spray pattern formations are described in FIGS. 34-37 and 38-42.

FIG. 34 shows an above-ground sprinkler-based wildfire defense system installation 80 of the present invention designed, installed and commissioned to automatically spray a linear zone of fire inhibiting chemistry that inhibits fire ignition and flame spread by hot flying wildfire embers 41 created during a wildfire storm and moving in the direction of the prevailing wind 41. During operation, and in response to automated detection of wildfire embers and/or smoke using AI-driven sensors 27′, the wildfire defense system 80 is automatically triggered to proactively spray Citrotech® MFB-31 liquid fire inhibitor from its sprinkler spray heads 28′ and form a clean-chemistry based wildfire protection zone/break 60 between the wildfire storm direction and the constructed home, along and about the property to be protected/defended, by spraying liquid fire inhibitor 35 from storage tank 21 before arrival of a wildfire storm.

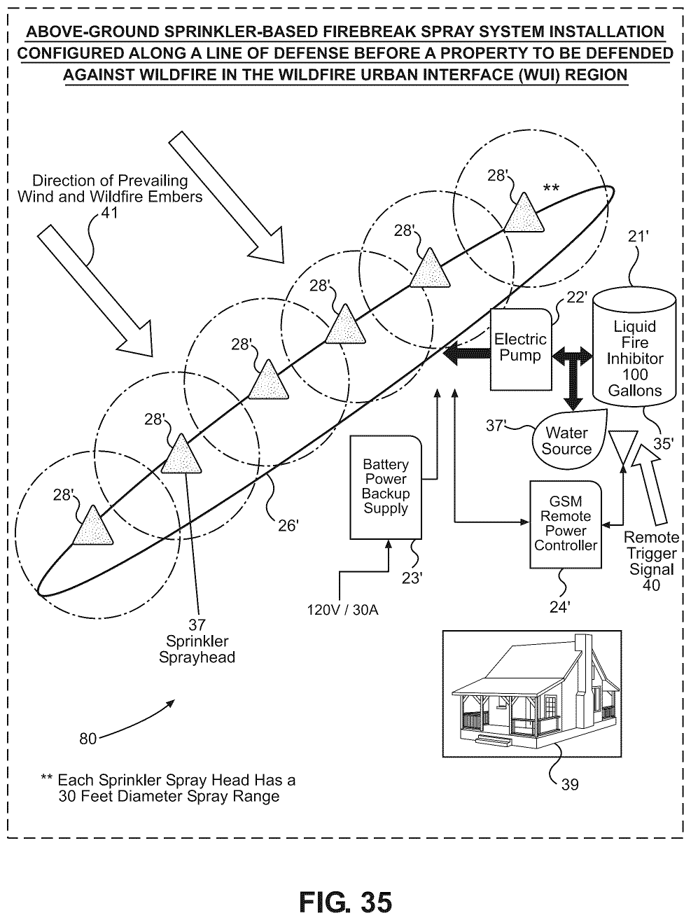

FIG. 35 shows the resulting linear spray pattern generated by the sprinkler sprayheads 28′ mounted above the ground before the property to be protected and driven by the wildfire defense fire inhibiting spraying system of this illustrative embodiment of the present invention.

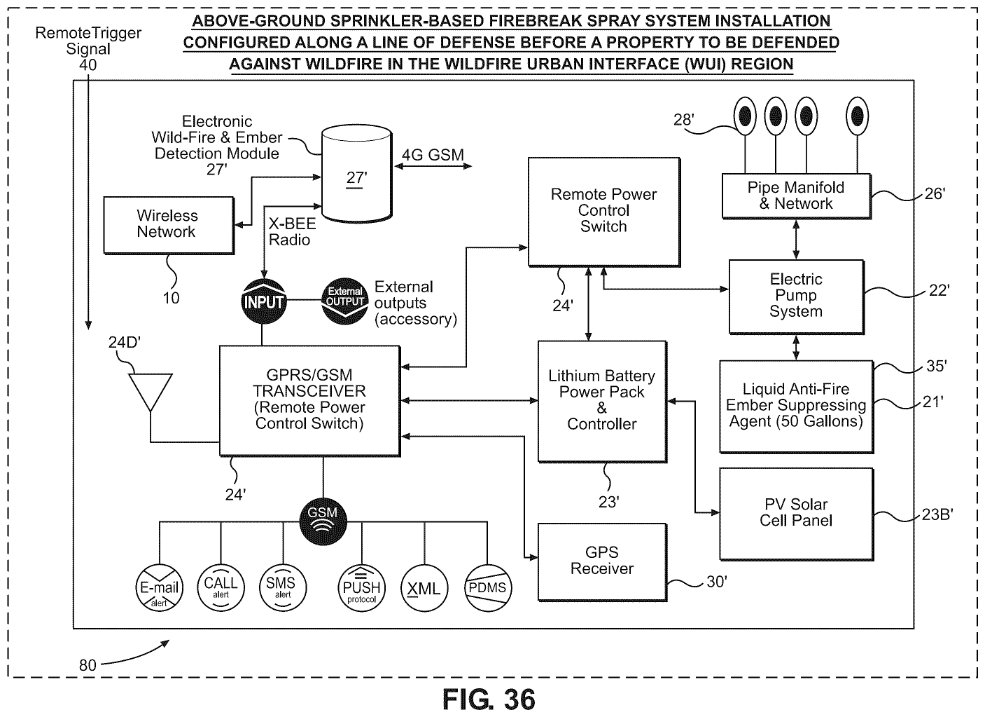

FIG. 36 shows the system components that can be used to install and commission the wireless remotely-activatable sprinkler-based wildfire defense fire inhibitor spraying system 80 depicted in FIGS. 34 and 35.

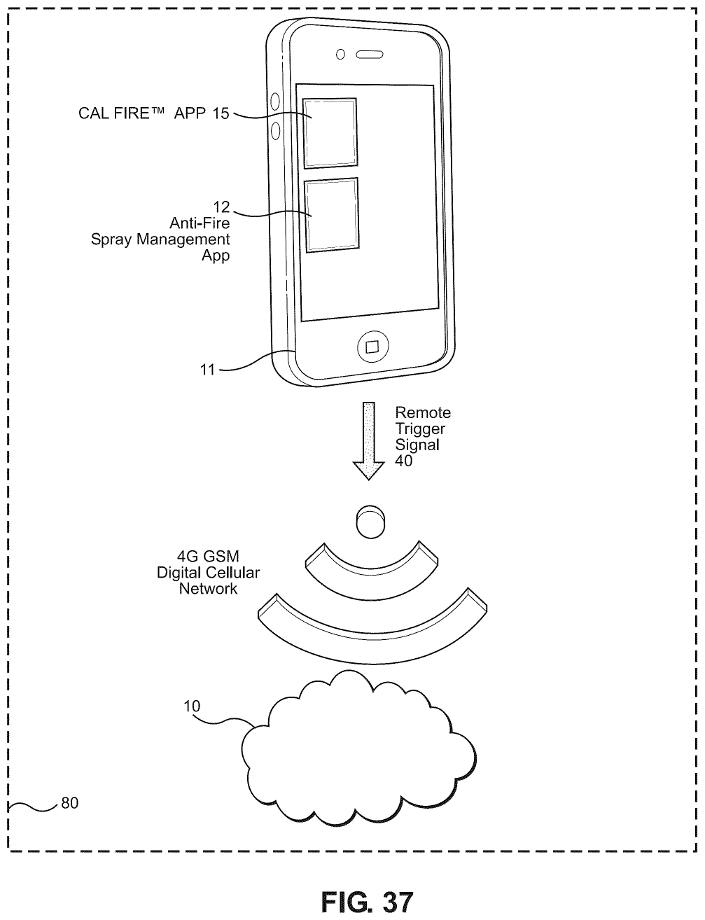

FIG. 37 illustrates a mobile smartphone 11 being used to remotely activate the spraying of fire inhibitor from the system 80 well before the arrival of a wildfire on the property, using SMS supported by a 4G GSM digital cellular communication link between the smartphone 11 and the 4G GSM remote power control switch 24′ employed at the spraying system installation. Specifically, the homeowner sends a text message 40′ via SMS over 4G GSM digital cellular network to automatically activate electric pump 22′ via the 4G GSM remote power control switch 24′ used in the wildfire defense spraying system. When the pump 21′ completes pumping and spraying all the fire inhibitor 35′ in the storage tank 21′, the electric pump will automatically shut off, and water molecules in the liquid fire inhibitor will begin to immediately evaporate forming fire-inhibiting potassium salt crystalline coatings on sprayed property.

Specification of a Third Configuration for a Liquid Fire Inhibitor Spraying-Based System for Home Wildfire Defense Deployed and Commissioned after Completion of the Home Construction Project in the Wildfire Urban Interface (WUI) Region

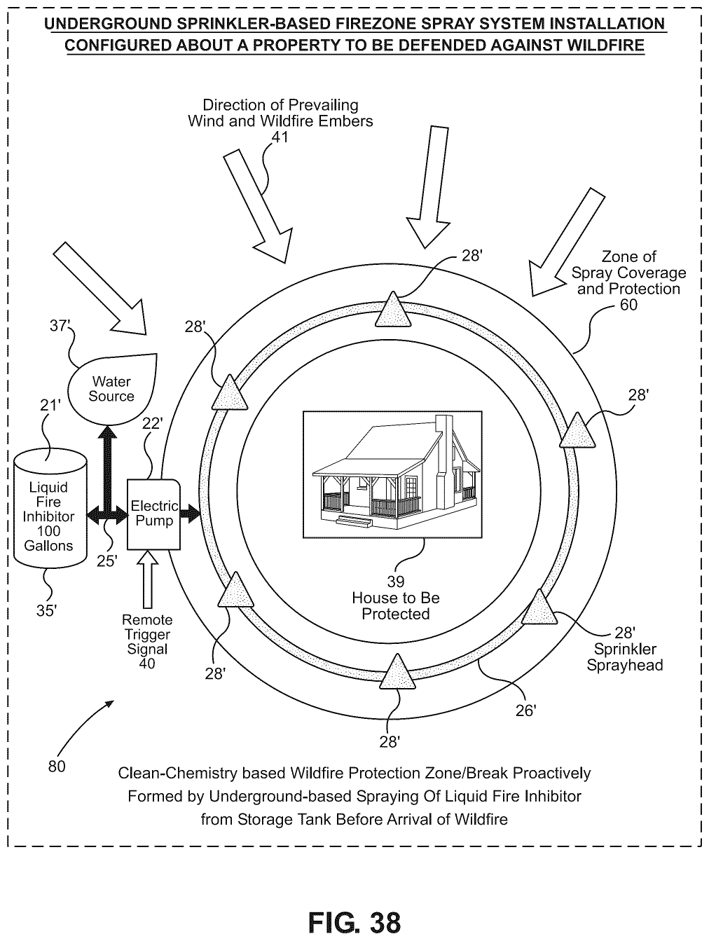

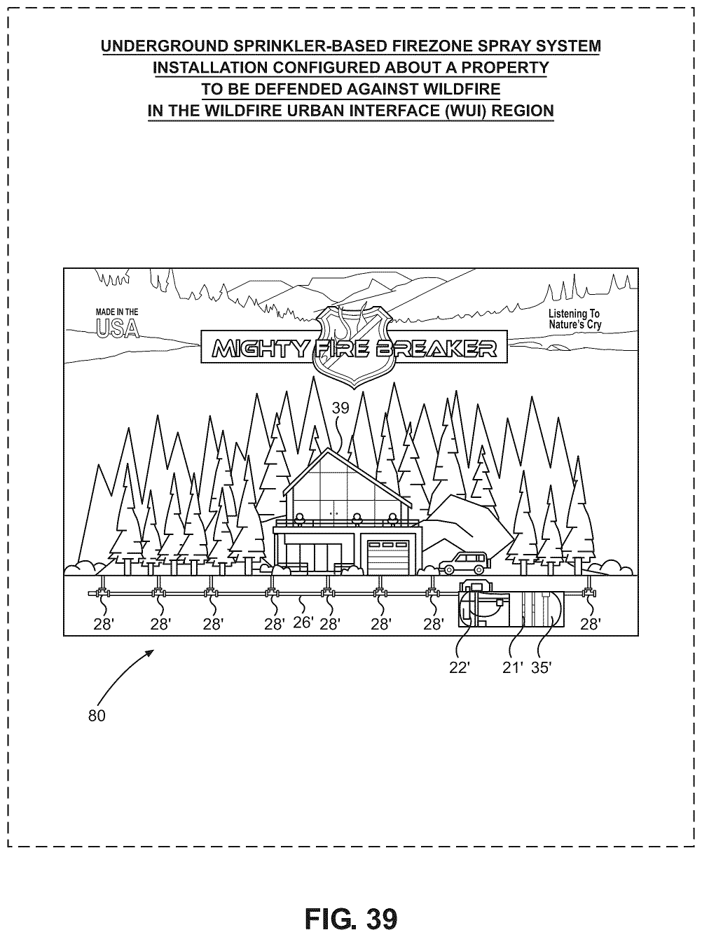

FIGS. 38 and 39 show under-ground sprinkler-based firebreak spraying system installation of the present invention 80 configured about a property to be defended against wildfire by spraying a zone of fire inhibiting chemistry that inhibits fire ignition and flame spread by hot flying wildfire embers created during a wildfire storm. During operation, the system proactively forms a clean-chemistry based wildfire protection zone/break over and about a house/property to be protected/defended by spraying liquid fire inhibitor 35 from storage tank 21′ before arrival of wildfire.

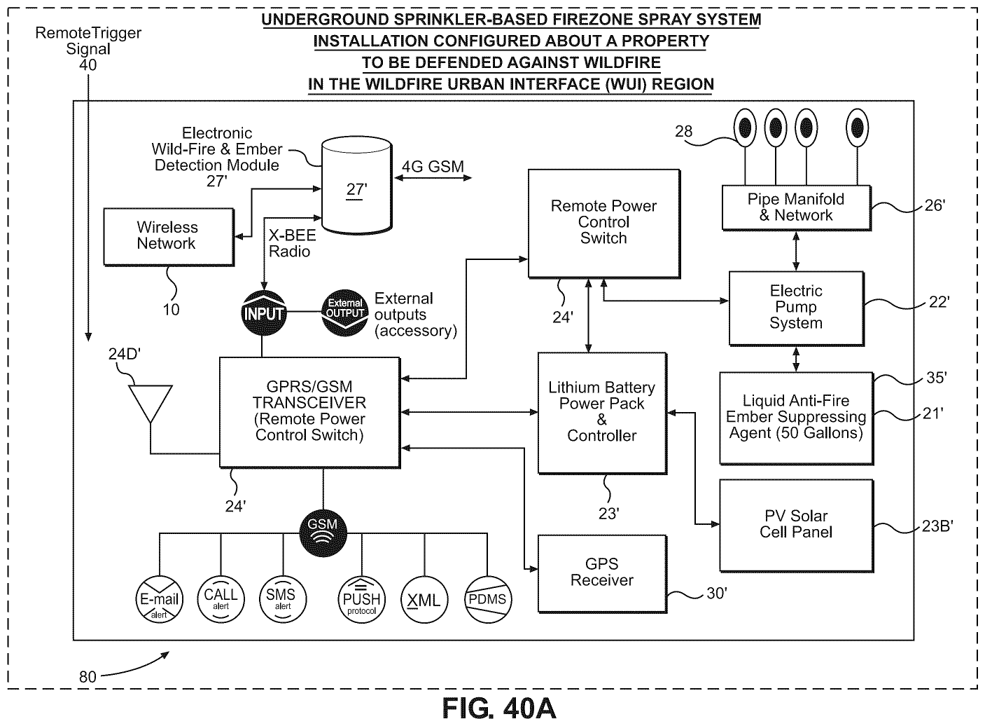

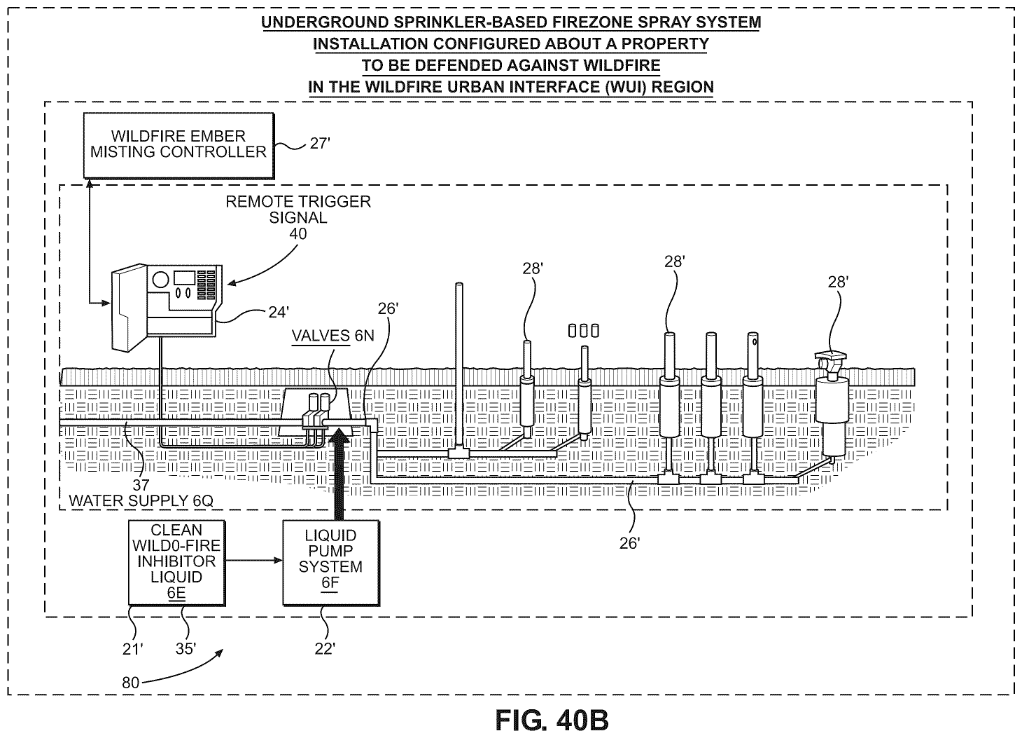

FIGS. 40A and 40B showing the system components used to install the wildfire defense system shown in FIGS. 38 and 39, providing an inground spraying solution around the property, wherein spreadheads 28′, chemical storage tank 21′ and electric pump 22′ and components are mounted underground, and configured for automatically spraying preconfigured patterns of environmentally-clean fire inhibitor on ground surfaces requiring proactive protection against wildfires.

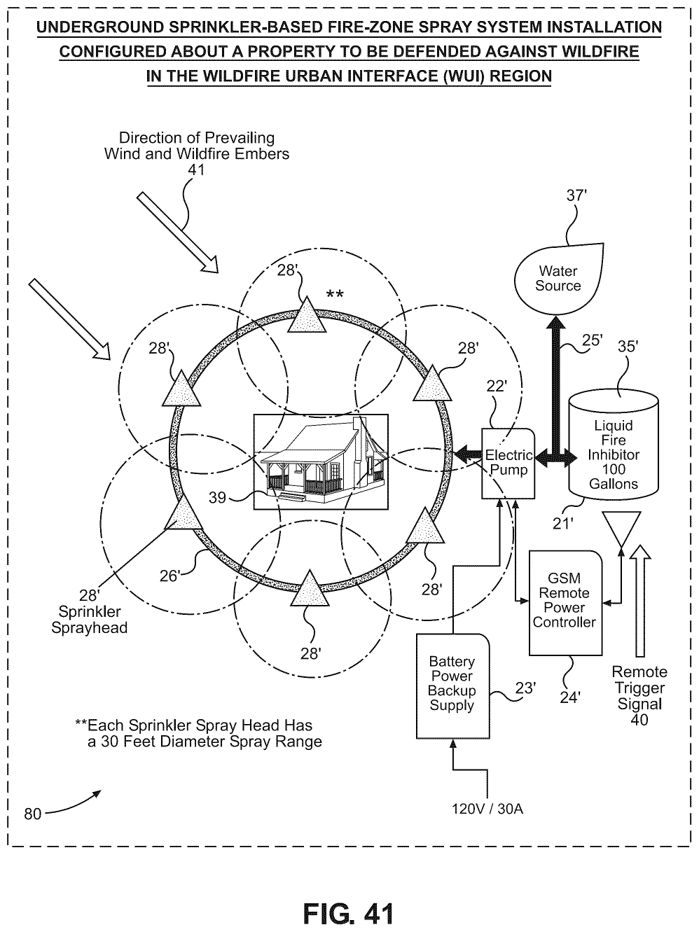

FIG. 41 illustrates the resulting linear spray pattern generated by the sprinkler sprayheads 28′ mounted underground before and/or about the property to be protected, and driven by the wildfire defense fire inhibiting spraying system of this illustrative embodiment of the present invention.

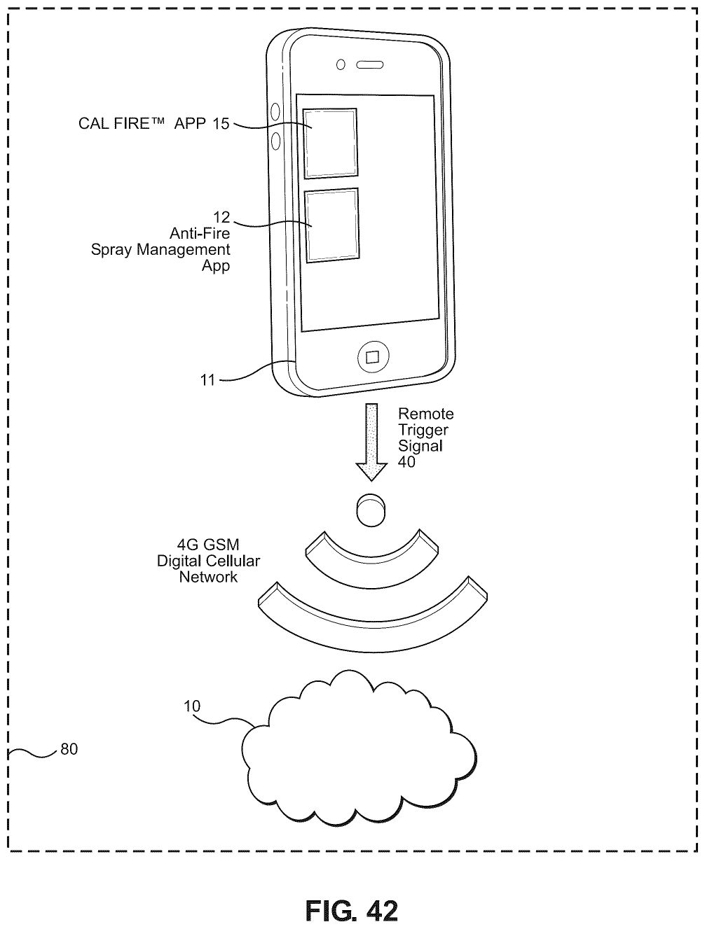

FIG. 42 shows a mobile smartphone 11 being used to remotely activate the spraying of fire inhibitor before the arrival of a wildfire on the property of the system installation of FIGS. 40A, 40B and 41, using SMS supported by a 4G GSM digital cellular communication link between the smartphone 11 and the 4G GSM remote power control switch 24′ employed at the spraying system installation. Specifically, the homeowner sends a text message 40 via SMS over 4G GSM digital cellular network to automatically activate electric pump 22′ via the 4G GSM remote power control switch 24′ used in the wildfire defense spraying system 50. When the pump 21′ completes pumping and spraying all the fire inhibitor 35″ in the storage tank 21′, the electric pump will automatically shut off, and water molecules in the liquid fire inhibitor will begin to immediately evaporate forming fire-inhibiting potassium salt crystalline coatings on sprayed property.

### Method of Operating the Wildfire Defense Spraying System of the Present Invention

In the preferred embodiments described above, a building/home owner or manager can manually activate and operate the spraying system from anywhere to protect either the building and/or ground surfaces around the building, as desired or required, based on intelligence in the possession of the human operator or manager.

Alternatively, the automated wildfire ember controller 27 when activated, in cooperation with the local electronic wildfire and ember detection module 27 and associated 4G GSM cellular network, automatically activates and operates the electric pump of the spraying system to protect both the building and/or ground surfaces around the building, as required, based on intelligence automatically collected by ember/smoke detector deployed on the wireless network and linked to the homeowner's wildfire defense spraying system.

Preferably, each wildfire defense spraying system 50 will include automated mechanisms for remotely monitoring and reporting the amount of Citrotech® fire inhibitor chemical liquid available and remaining for use in supporting spraying operations. Such monitoring will help to ensure that adequate reserves of fire inhibiting chemical liquid are stored in GPS-tracked storage tanks 21 on each property before any given wildfire strike to support wildfire ember suppression spraying operations.

Typically, the locked and loaded home wildfire defense system will be manually triggered by the owners several hours and just before the owners are required to evacuate their homes and property for safety reasons, by authorities such as the local fire chief and deputies. Alternatively, the wildfire home defense system can also be remotely triggered using a mobile smartphone 11, if required, with the property owners not home to manually triggering the spraying defense mode of the system.

The system will be remotely controllable by the building manger/home-owner using a mobile computing system 11 running the mobile application. Suitable graphical user interfaces (GUIs) can be supported on the mobile application to enable the user to monitor and control the system locally, or from a remote location, in real-time, provided the wireless communication infrastructure is not disrupted by a wildfire. In the case of active wildfires, a wildfire detection and notification network can be provided for continuously collecting, recording and monitor intelligence about specific regions of land and any wildfires detected in such regions, and advise any specific home/building owner of the status of any specific building before, during and after a wildfire.

Modifications to the Present Invention which Readily Come to Mind

The illustrative kits and spray system embodiments disclose using environmentally clean fire inhibiting biochemical compositions of matter developed by Applicant and covered under U.S. Pat. Nos. 11,865,390 and 11,865,394, incorporated herein by reference in their entirety. However, it is understood that alternative clean fire inhibiting chemical compositions may be used to practice the wild fire defense methods according to the principles of the present invention.

In the illustrative embodiment of the wildfire home defense spraying system of the present invention, 4G GSM digital cellular communications is provided between the electrical pump components of the system and the homeowner's smartphone, enabling the remote triggering of automated fire inhibitor spraying operations on the property in response to a single SMS text message sent over the network from the homeowner's smartphone. This is a very reliable method of remote triggering because electrical power and internet service failure at homes during an active wildfire is more likely than loss of digital cellular service, all things considered.

However, it is understood that a web-based remote-control method for triggering the spraying system can be practiced as well by using a mobile application running a native mobile application or web browser application, and an Internet-based remote electrical power controller installed aboard the wildfire defense spraying system. Notably, in such a web-based alternative embodiment of the present invention, Internet service (and WIFI Service) will be required at the home-based property being protected, in order to enable remote-triggering of spraying operations executed using the homeowner's mobile smartphone running the native mobile application or web browser application, as the case may be.

All things considered, the 4G GSM remote control method would appear more reliable in most applications. However, in some applications, the web-based application might seem preferred. Also, in yet other environments and applications, use of both 4G GSM and web-based methods might be preferred to provide the homeowners two options of remote-control triggering of fire inhibitor spraying operations on a particular GPS-specified parcel of property.

While several modifications to the illustrative embodiments have been described above, it is understood that various other modifications to the illustrative embodiment of the present invention will readily occur to persons with ordinary skill in the art. All such modifications and variations are deemed to be within the scope and spirit of the present invention as defined by the accompanying Claims to Invention.

1. A method of installing and commissioning the operation of a home automated sprinkler-based wildfire defense system during the post-construction phase of a completed home building project, said method comprising the steps of:
(a) using a mobile home construction wildfire defense system trailer to provide wildfire defense to a wood-frame/mass-timber home building being constructed on a parcel of property in a wildfire urban interface (WUI) region;
(b) determining the placement location of sprinkler spray heads on the home being constructed to ensure complete spray coverage over and about the region where the wood building will be constructed and must be protected by liquid fire inhibitor when sprayed by said home sprinkler-based wildfire defense system that is installed within the constructed house on completion, and driven by an electric-powered hydraulic pumping system, pumping liquid fire inhibitor in a storage tank to the sprinkler sprayheads mounted in said home sprinkler-based wildfire defense system; and
(c) mounting and/or installing sprinkler heads on the constructed house and surrounding property during the construction phase, as well as installing piping connecting the sprinkler heads and said electric-powered hydraulic pumping system, and said storage tank on the property, at the placement locations determined in step (b), so as to achieve the spray coverage required to completely spray property and apply the environmentally clean fire inhibiting coating on all combustible surfaces of the wood home building being constructed on the home construction job-site.

2. The method of claim 1, which further comprises:
(d) connecting the electrical liquid pump, and sprinkler sprayheads in a fluid series configuration using tubing to create a closed fluid flow loop; and
(e) connecting fire inhibitor storage tank, and source of water to the electric-powered hydraulic pumping system using a valve assembly piping so that (i) when valve assembly is configured into a first position, water from a water source is allowed to flow under sufficient water pressure into the electric-powered hydraulic pumping system and through the closed fluid pumping loop and spraying from sprinkler sprayheads during testing operations, and (ii) when the valve assembly is configured to a second position, the liquid fire inhibitor premixed and stored in the storage tank is allowed to flow into the electric-powered hydraulic pumping system and through the closed fluid pumping loop and spraying from sprinkler heads during proactive wildfire defense spraying operations.

3. The method of claim 2, which further comprises:
connecting a battery backup power supply system to the job-site location and/or solar charging array panels, and then connecting a remote power control switch between said backup power supply system and said electric-powered hydraulic pumping system, using electrical earth grounding on the electric-powered hydraulic pumping system; and
activating the remote power control switch with a telecommunication service provider, by assigning a phone number and SMS service to the remote power control switch, and (ii) activating a GPS sensor mounted on the storage tank at time/place of manufacture, which will involve activating its 3V battery and enabling the GPS sensor to GPS track the storage tank location and automatically transmit the GPS location to a SMS server operated by the manufacturer of said sprinkler-based wildfire defense system using SMS and a phone number preassigned to the GPS sensor.

4. The method of claim 2, which further comprises:
during testing operations, configuring said valve assembly into the first position, so that water from the water source is allowed to flow under building water pressure into the electric-powered hydraulic pumping system and through the closed fluid pumping loop and spraying from sprinkler sprayheads, and confirm that sprinkler sprayheads are operating property and their spray coverage and spray patterns are overlapping as desired, and if not, then adjusting the sprinkler sprayheads as required; and
during activation operations, turning said valve assembly to the second position, so that liquid wildfire inhibitor is stored in said storage tank and allowed and to flow into the electric-powered hydraulic pumping system and be ready for pumping through the closed pumping loop and spraying from sprinkler heads, under the pressure of the said electric-powered hydraulic pumping system in the fluid loop, during proactive wildfire defense spraying operations.

5. The method of claim 2, which further comprises:
registering the installed and commissioned sprinkler-based wildfire defense system with a source of authority by (i) browsing to a website, (ii) scanning a unique QR code located on the storage tank, and (iii) completing the registration process using GPS-tracking information collected from said sprinkler-based wildfire defense system; and sending an email notification to the user once the registration process is completed.

6. The method of claim 2, which further comprises:
prior to arrival of a wildfire storm at the home building location, during proactive wildfire defense spraying operations, either (i) authorized personnel using a mobile or other phone to send a SMS activation signal to the 4G GSM remote power control switch at the home property location, or (ii) an AI-based wireless smoke and/or wildfire ember detection system automatically sending a SMS activation signal to the 4G GSM remote power control switch at the property location, so as to automatically deliver electrical power to the electric pump from the backup storage system and enable the pump to work and pump the liquid wildfire inhibitor from the storage tank through the closed fluid pumping loop, and spray the liquid from sprinkler heads, under the fluid loop pressure, to provide all combustible surfaces on the home property including the building, with an environmentally-clean potassium salt crystalline coating that protects the combustible material from fire ignition, flame spread and smoke development when encountering hot flying wildfire embers during the arrival of a wildfire storm in the WUI region.

7. The method of claim 2, which further comprises:
at any time after discharge and spraying of the fire inhibiting liquid from the storage tank, or after the safe passage of a wildfire storm at the building location with all mitigated damages repaired, said sprinkler-based wildfire defense system is reactivated and prepared for its next round of proactive fire defense spraying operations, by the following: (i) configuring the valve assembly in the first position and then flush all sprinkler heads with clean water for 10 minutes, according to testing operations; (ii) configuring the value assembly in the second position, and then refill the storage tank with liquid fire inhibitor from its manufacturer; and (iii) configuring the valve assembly to its second position and prepare the sprinkler-based wildfire defense system for the next wildfire threat;
triggering said sprinkler-based wildfire defense system to perform liquid spraying operations on the constructed building after any significant rainfall on the property which may have dissolved, washed away or deteriorated the potassium salt crystalline coatings; and
repeating the above steps as needed to prepare the sprinkler-based wildfire defense system with a supply of liquid fire inhibitor to apply another coating of liquid wildfire inhibitor on the constructed home building and its surrounding property in the WUI region.
